(19) United States
(12) Patent Application Publication
(10) Pub. No.: US 2005/0039724 A1
(43) Pub. Date: Feb. 24, 2005

(54) Fuel injection device and diesel engine having the same, and fuel injection device controlling method

(76) Inventors: Hiroyuki Ishida, Nagasaki-shi (JP); Toshikazu Hayashi, Nagasaki-shi (JP); Takeshi Arai, Yokohama-shi (JP); Shoji Namekawa, Yokohama-shi (JP); Hiroshi Yoshizumi, Yokohama-shi (JP); Noriaki Ida, Yokohama-shi (JP); Etsuo Kunimoto, Nagasaki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/492,517

(22) PCT Filed: Oct. 16, 2002
(86) PCT No.: PCT/JP02/10759

(30) Foreign Application Priority Data
Oct. 16, 2001 (JP) 2001-318027
Dec. 21, 2001 (JP) 2001-389734
Feb. 8, 2002 (JP) 2002-32863
Jun. 20, 2002 (JP) 2002-180026

(51) Int. Cl. F02M 1/00

(52) U.S. Cl. 123/447

(57) ABSTRACT

The present invention takes as its objective to provide a fuel injection device, and a diesel engine equipped therewith, which can reduce the amount of NOx in the exhaust gas while maintaining the rate of fuel consumption satisfactory. This fuel injection device includes a pressure accumulator which accumulates fuel whose pressure has been elevated, a fuel injection valve which opens by the supply of the fuel from the pressure accumulator and injects the fuel, a supply conduit which supplies fuel from the pressure accumulator to the fuel injection valve, and two valve apparatuses which are connected in the supply conduit in parallel and each of which interrupts fuel supply to the fuel injection valve. And the fuel flow amount when one of the electromagnetic valves is open is set to be smaller than the fuel flow amount when the other electromagnetic valve is open; and, during fuel supply to the fuel injection valve, an electromagnetic valve opens first, and next an electromagnetic valve opens.

### BACKGROUND OF THE INVENTION

1. Field of the Invention

The present invention relates to a fuel injection device and to a diesel engine which is equipped therewith, and to a control method for a fuel injection device.

2. Description of the Prior Art

FIG. 31 is an overall structural view of a prior art fuel injection device which is fitted to a diesel engine. In this figure, the reference symbol 101 denotes a fuel tank, 102 denotes a fuel pump which pressurizes and supplies fuel, 103 denotes a pressure accumulator which accumulates fuel which has been pressurized and supplied from the fuel pump 102 at a predetermined pressure or at a pressure above it, 104 denotes a fuel injection valve which, by being supplied with pressurized fuel from the pressure accumulator 103, releases and injects this fuel, and 105 denotes a supply conduit which supplies fuel to the fuel injection valve 104 from the pressure accumulator 103.

An electromagnetic valve 106 which interrupts the fuel supply to the fuel injection valve 104 is connected in the supply conduit 105. For the electromagnetic valve 106, there is used a three way valve which can select a position which supplies fuel from the pressure accumulator 103 to the fuel injection valve 104, and a position which interrupts the fuel supply to the fuel injection valve 104 and relieves to the outside of the system the leftover pressure which remains in the supply conduit 105 upon the fuel injection valve 104 side.

Furthermore, a drain conduit 108 which vents fuel which remains in the fuel injection valve 104 side when the position which interrupts the fuel supply to the fuel injection valve 104 has been selected and in which leftover pressure has been engendered is connected to the electromagnetic valve 106, and a drain pan 109 which receives the surplus fuel is provided at its end.

The stroke of the operation of a fuel injection device structured as described above, when a diesel engine which comprises the fuel injection device is driven, will now be explained.

In the pressure accumulator 103 there is normally accumulated fuel which is pressurized by the action of the fuel pump 102. When the diesel engine enters upon its fuel injection stroke, the electromagnetic valve 106 opens, and the fuel which has been accumulated in the pressure accumulator 103 is supplied to the fuel injection valve 104. When the fuel injection stroke terminates, the electromagnetic valve 106 closes, and the fuel which has engendered the leftover pressure which remains in the supply conduit 105 upon the fuel injection valve 104 side is vented via the drain conduit which is provided to the electromagnetic valve 106, and is collected in the drain pan 109.

As described above, with a prior art fuel injection device, as shown in FIG. 32, the fuel injection is performed at an almost constant injection rate over the entire fuel injection period. With this type of fuel injection method, the rate of fuel consumption is excellent, but it is known that the NOx in the exhaust gas becomes high, and there is a possibility that a problem may be caused from the point of view of the environment due to increase of atmospheric pollution or the like. Because of this, some kind of countermeasure aimed at reducing NOx is desirable. Furthermore if an extremely low load is imposed, as for example during idling, since the fuel injection is not stable, the operating state of the diesel engine itself becomes unstable.

The present invention has been conceived in the circumstances described above, and its objective is to provide a fuel injection device and a diesel engine equipped therewith, which are able to reduce the NOx in the exhaust gas while maintaining a desirable rate of fuel consumption, and which moreover are able to implement stabilized operation.

### SUMMARY OF THE INVENTION

As a means for solving the above described problems, there are adopted a fuel injection device and a diesel engine equipped therewith of the following construction. That is, the fuel injection device of the first invention according to the present invention is particularly distinguished by including a pressure accumulator which accumulates fuel whose pressure has been elevated, a fuel injection valve which opens by the supply of the fuel from the pressure accumulator and injects the fuel, a supply conduit which supplies fuel from the pressure accumulator to the fuel injection valve, and two valve apparatuses which are connected in the supply conduit in parallel and each of which interrupts fuel supply to the fuel injection valve; wherein, in fuel supply to the fuel injection valve, among the two valve apparatuses, a one valve apparatus opens first, and next the other of the valve apparatuses opens.

With this invention, when the one valve apparatus opens first, fuel which has been expelled from the pressure accumulator is supplied to the fuel injection valve via the one valve apparatus, and next, when the other valve apparatus opens, fuel is supplied to the fuel injection valve via the two valve apparatuses in parallel. By doing this, the fuel injection rate in the first half of the period over which fuel is injected is kept low, while the fuel injection rate in the second half is increased.

With this invention, it is also possible to set the fuel injection rates in the first half/second half as desired, by making the fuel flow amount of the one valve apparatus be not less than the fuel flow amount of the other valve apparatus, but equal. Accordingly, by setting a suitable fuel injection rate, the rate of fuel consumption can be maintained as desired, and it is possible to anticipate reduction of the NOx in the exhaust gas.

The second invention according to the present invention is the fuel injection device of the first invention, particularly distinguished in that, for the one valve apparatus, there is used a three way valve which can select a position in which it supplies fuel from the pressure accumulator to the fuel injection valve, and a position in which it interrupts the supply of fuel to the fuel injection valve and relieves the leftover pressure which remains on the side of the fuel injection valve.

With this invention, since, in the state in which the one valve apparatus has been selected to the position which cuts off the fuel supply to the fuel injection valve, the leftover pressure which has remained on the fuel injection valve side is released to the outside, therefore the pressure of the fuel drops quickly, and combustion is desirably performed with low pressure injection after the combustion period being avoided. Since as a result a good state of so called injection cutoff is obtained, not only can the rate of fuel consumption be maintained as desired, but the NOx in the exhaust gas can be reduced.

The third invention according to the present invention is the fuel injection device of the first invention, particularly distinguished in that, for the other valve apparatus, there is used a three way valve which can select a position in which it supplies fuel from the pressure accumulator to the fuel injection valve, and a position in which it interrupts the supply of fuel to the fuel injection valve and relieves the leftover pressure which remains on the side of the fuel injection valve; and in which a constriction is provided in the path which releases the fuel in which the leftover pressure has been engendered, which keeps the flow amount of the fuel small.

With this invention, since, in the state in which the other valve apparatus has been selected to the position which cuts off the fuel supply to the fuel injection valve, the leftover pressure which has remained on the fuel injection valve side is released to the outside, therefore the pressure of the fuel drops quickly, and combustion is desirably performed with low pressure injection in the period after combustion being avoided. By doing this as well, a good state of so called injection cutoff is obtained.

It should be understood that, in the state in which only the one valve apparatus is opened, the fuel whose pressure has been elevated may be supposed to flow back to the other valve apparatus, but, since the constriction is provided in the conduit through which the fuel in which leftover pressure has been engendered is released, the fuel which is being vented through the conduit is kept to a small amount, and exerts almost no influence upon the supply amount to the fuel injection valve.

The fuel injection device of the fourth invention according to the present invention is particularly distinguished by including a pressure accumulator which accumulates fuel whose pressure has been elevated, a fuel injection valve which opens by the supply of the fuel from the pressure accumulator and injects the fuel, a supply conduit which supplies fuel from the pressure accumulator to the fuel injection valve, and two valve apparatuses which are connected in the supply conduit in series and each of which interrupts fuel supply to the fuel injection valve; in which: to the supply conduit there is provided a bypass conduit which conducts fuel to bypass the one of the valve apparatuses among the two valve apparatuses which is disposed towards the pressure accumulator; a constriction is provided in the bypass conduit which keeps the flow amount of the fuel low; and, in fuel supply to the fuel injection valve, the other one of the valve apparatuses among the two valve apparatuses which is disposed towards the fuel injection valve opens first, and next the one valve apparatus opens.

With this invention, when the other valve apparatus is opened first, fuel which has been expelled from the pressure accumulator is supplied to the fuel injection valve via the other valve apparatus, bypassing the one valve apparatus. At this time, by the fuel passing through the constriction and thus constricting the supply amount, the fuel injection rate in the first half of the period over which fuel is injected is kept low. Next, when the one valve apparatus opens, fuel is supplied to the fuel injection valve via the other valve apparatus and via the one valve apparatus without experiencing the action of any constriction. By doing this, while the fuel injection rate in the second half is increased.

The fifth invention according to the present invention is the fuel injection device of the fourth invention, particularly distinguished in that, for the other valve apparatus, there is used a three way valve which can select a position in which it supplies fuel from the pressure accumulator to the fuel injection valve, and a position in which it interrupts the supply of fuel to the fuel injection valve and relieves the leftover pressure which remains on the side of the fuel injection valve.

With this invention, since, in the state in which the other valve apparatus has been selected to the position which cuts off the fuel supply to the fuel injection valve, the leftover pressure which has remained on the fuel injection valve side is released to the outside, therefore the pressure of the fuel drops quickly, and combustion is desirably performed with low pressure injection in the period after combustion being avoided. By doing this as well, a good state of injection cutoff is obtained. Furthermore, since useless pressure does not act upon the fuel injection valve or upon the supply conduit, the introduction and cutting off of pressure by the opening and closing of the valve apparatus comes to be performed in a stable manner, and the operation of the fuel injection device and the operating state of the diesel engine are stabilized.

The fuel injection device of the sixth invention according to the present invention is particularly distinguished by including a pressure accumulator which accumulates fuel whose pressure has been elevated, a fuel injection valve which opens by the supply of the fuel from the pressure accumulator and injects the fuel, a supply conduit which supplies fuel from the pressure accumulator to the fuel injection valve, and two valve apparatuses which are connected in the supply conduit in series and each of which interrupts fuel supply to the fuel injection valve; and wherein: to the supply conduit there is provided a bypass conduit which conducts fuel to bypass the one of the valve apparatuses among the two valve apparatuses which is disposed towards the fuel injection valve; a constriction is provided in the bypass conduit which keeps the flow amount of the fuel low; and, in fuel supply to the fuel injection valve, the other one of the valve apparatuses among the two valve apparatuses which is disposed towards the pressure accumulator opens first, and next the one valve apparatus opens.

With this invention, when the other valve apparatus is opened first, fuel which has been expelled from the pressure accumulator is supplied to the fuel injection valve via the other valve apparatus, later bypassing the one valve apparatus. At this time, by the fuel passing through the constriction and thus constricting the supply amount, the fuel injection rate in the first half of the period over which fuel is injected is kept low. Next, when the one valve apparatus opens, fuel is supplied to the fuel injection valve via the other valve apparatus and via the one valve apparatus without experiencing the action of any constriction. By doing this, while the fuel injection rate in the second half is increased.

The seventh invention according to the present invention is the fuel injection device of the sixth invention, particularly distinguished in that, for the other valve apparatus, there is used a three way valve which can select a position in which it supplies fuel from the pressure accumulator to the fuel injection valve, and a position in which it interrupts the supply of fuel to the fuel injection valve and relieves the leftover pressure which remains on the side of the fuel injection valve.

With this invention, since, in the state in which the other valve apparatus has been selected to the position which cuts off the fuel supply to the fuel injection valve, the leftover pressure which has remained on the fuel injection valve side is released to the outside, therefore the pressure of the fuel drops quickly, and combustion is desirably performed with low pressure injection in the period after combustion being avoided. By doing this as well, a good state of injection cutoff is obtained.

The eighth invention according to the present invention is the fuel injection device of the sixth invention, particularly distinguished in that, for the one valve apparatus, there is used a three way valve which can select a position in which it supplies fuel from the pressure accumulator to the fuel injection valve, and a position in which it interrupts the supply of fuel to the fuel injection valve and relieves the leftover pressure which remains on the side of the fuel injection valve; and a second constriction is provided in the conduit which relieves the fuel in which leftover pressure has been engendered, which keeps the flow amount of the fuel low.

With this invention, since, in the state in which the one valve apparatus has been selected to the position which cuts off the fuel supply to the fuel injection valve, the leftover pressure which has remained on the fuel injection valve side is released to the outside, therefore the pressure of the fuel drops quickly, and combustion is desirably performed with low pressure injection in the period after combustion being avoided. By doing this as well, a good state of injection cutoff is obtained. Furthermore, when only the other valve apparatus is opened in the path in which the fuel in which leftover pressure has been engendered is released, although the fuel which must be supplied to the fuel injection valve does come to be vented to the outside as it flow in, this escaping flow of fuel is kept low due to the second constriction which is provided in this path.

The fuel injection device of the ninth invention according to the present invention is particularly distinguished by including a one pressure accumulator which accumulates fuel whose pressure has been elevated, an other pressure accumulator which accumulates fuel at a higher pressure than the one pressure accumulator, a fuel injection valve which opens by the supply of the fuel from at least one of the one pressure accumulator and the other pressure accumulator and injects the fuel, a one supply conduit which supplies fuel from the one pressure accumulator to the fuel injection valve, a one valve apparatus which is connected in the one supply conduit and which interrupts fuel supply to the fuel injection valve, an other supply conduit which supplies fuel from the other pressure accumulator to the fuel injection valve, and an other valve apparatus which is connected in the other supply conduit and which interrupts fuel supply to the fuel injection valve; and wherein: by the difference in the fuel supply pressures, the fuel flow amount of the one valve apparatus is set to be smaller than the fuel flow amount of the other valve apparatus; and, in fuel supply to the fuel injection valve, the one valve apparatus opens first, and next the other valve apparatus opens.

With this invention, when the one valve apparatus whose fuel flow amount when it is open is the lower is opened first, fuel which has been expelled from the pressure accumulator is supplied to the fuel injection valve via the one valve apparatus. At this time, the fuel injection rate in the first half of the period over which fuel is injected is kept low. Next, when the other valve apparatus whose fuel flow amount when it is open is the greater opens, fuel is supplied to the fuel injection valve via the two valve apparatuses in parallel. By doing this, the fuel injection rate in the second half is increased.

The tenth invention according to the present invention is the fuel injection device of the ninth invention, particularly distinguished in that, for the one valve apparatus, there is used a three way valve which can select a position in which it supplies fuel from the pressure accumulator to the fuel injection valve, and a position in which it interrupts the supply of fuel to the fuel injection valve and relieves the leftover pressure which remains on the side of the fuel injection valve.

With this invention, since, in the state in which the one valve apparatus has been selected to the position which cuts off the fuel supply to the fuel injection valve, the leftover pressure which has remained on the fuel injection valve side is released to the outside, therefore the pressure of the fuel drops quickly, and combustion is desirably performed with low pressure injection in the period after combustion being avoided, so that, in other words, a good state of injection cutoff is obtained.

The fuel injection device of the eleventh invention according to the present invention is particularly distinguished by including a one pressure accumulator which accumulates fuel whose pressure has been elevated, an other pressure accumulator which accumulates fuel at a higher pressure than the one pressure accumulator, a fuel injection valve which opens by the supply of the fuel from at least one of the one pressure accumulator and the other pressure accumulator and injects the fuel, a one supply conduit which supplies fuel from the one pressure accumulator to the fuel injection valve, a one valve apparatus which is connected in the one supply conduit and which interrupts fuel supply to the fuel injection valve, an other supply conduit which is connected to the one supply conduit towards the side of the one pressure accumulator from the one valve apparatus and which supplies fuel from the other pressure accumulator to the fuel injection valve, and an other valve apparatus which is connected in the other supply conduit and which interrupts fuel supply to the fuel injection valve; and wherein: by the difference in the fuel supply pressures, the fuel flow amount of the one valve apparatus is set to be smaller than the fuel flow amount of the other valve apparatus; and, in fuel supply to the fuel injection valve, the one valve apparatus opens first, and next the other valve apparatus opens.

With this invention, when the one valve apparatus is opened first, fuel which has been expelled from the one pressure accumulator is supplied to the fuel injection valve via the one valve apparatus. At this time, the fuel injection rate in the first half of the period over which fuel is injected is kept low. Next, when the one valve apparatus opens, fuel which has been expelled from the other pressure accumulator is supplied to the fuel injection valve via the other valve apparatus and the one valve apparatus. By doing this, the fuel injection rate in the second half is increased.

The twelfth invention according to the present invention is the fuel injection device of the eleventh invention, particularly distinguished in that, for the one valve apparatus, there is used a three way valve which can select a position in which it supplies fuel from the pressure accumulator to the fuel injection valve, and a position in which it interrupts the supply of fuel to the fuel injection valve and relieves the leftover pressure which remains on the side of the fuel injection valve.

With this invention, since, in the state in which the one valve apparatus has been selected to the position which cuts off the fuel supply to the fuel injection valve, the leftover pressure which has remained on the fuel injection valve side is released to the outside, therefore the pressure of the fuel drops quickly, and combustion is desirably performed with low pressure injection after the combustion period being avoided; in other words, a good state of injection cutoff is obtained.

The thirteenth invention according to the present invention is a diesel engine, particularly distinguished by being equipped with the fuel injection device of any one of the first through the twelfth inventions.

With this invention, since as described above the fuel injection rate in the first half of the period over which fuel is injected is kept low, while next the fuel injection rate in the second half is increased, therefore, not only can the rate of fuel consumption be maintained as desired, but the NOx in the exhaust gas can be reduced.

The fourteenth invention according to the present invention is the diesel engine of the thirteenth invention, particularly distinguished in that the pressure accumulator and the two valve apparatuses are provided separately from an engine cylinder to which the fuel injection valve is provided.

With this invention, by separating the pressure accumulator and the two valve apparatuses from the engine cylinder, maintenance and procedures such as the changing of components and the like can be performed simply. Furthermore, the freedom of design for the diesel engine is increased, and it is possible to anticipate a reduction in the size and a lightening of the weight of the engine cylinder and of the diesel engine.

The fifteenth invention according to the present invention is a control method for a fuel injection device which includes two valve apparatuses, which interrupt fuel supply to a fuel injection valve, and with which the fuel injection amount per unit time which is injected from the fuel injection valve when a one valve apparatus among the two valve apparatuses is opened is set to be smaller than the fuel injection amount per unit time which is injected from the fuel injection valve when the other valve apparatus is opened, particularly distinguished in that: in fuel supply to the fuel injection valve, the one valve apparatus among the two valve apparatuses opens first, and next the other valve apparatus opens.

The sixteenth invention according to the present invention is a control method for a fuel injection device which includes two valve apparatuses, which interrupt fuel supply to a fuel injection valve, and with which the fuel injection amount per unit time which is injected from the fuel injection valve when a one valve apparatus among the two valve apparatuses is opened is set to be smaller than the fuel injection amount per unit time which is injected from the fuel injection valve when the other valve apparatus is opened, and is particularly distinguished in that: in fuel supply to the fuel injection valve, the two valve apparatuses open and close at the same times.

The seventeenth invention according to the present invention is a control method for a fuel injection device which includes two valve apparatuses, which interrupt fuel supply to a fuel injection valve, and with which the fuel injection amount per unit time which is injected from the fuel injection valve when a one valve apparatus among the two valve apparatuses is opened is set to be smaller than the fuel injection amount per unit time which is injected from the fuel injection valve when the other valve apparatus is opened, and is particularly distinguished in that: in fuel supply to the fuel injection valve, only one or the other among the two valve apparatuses opens and closes.

The eighteenth invention according to the present invention is a fuel injection device including a pressure accumulator which accumulates fuel whose pressure has been elevated, a fuel injection valve which opens by the supply of the fuel from the pressure accumulator and injects the fuel, a supply conduit which supplies fuel from the pressure accumulator to the fuel injection valve, and two valve apparatuses which are connected in the supply conduit in parallel and each of which interrupts fuel supply to the fuel injection valve, in which the fuel flow amount when a one valve apparatus among the two valve apparatuses is opened is set to be smaller than the fuel flow amount when the other valve apparatus is opened; and is particularly distinguished in that, in fuel supply to the fuel injection valve, the two valve apparatuses open and close at the same times.

The nineteenth invention according to the present invention is a fuel injection device including a pressure accumulator which accumulates fuel whose pressure has been elevated, a fuel injection valve which opens by the supply of the fuel from the pressure accumulator and injects the fuel, a supply conduit which supplies fuel from the pressure accumulator to the fuel injection valve, and two valve apparatuses which are connected in the supply conduit in parallel and each of which interrupts fuel supply to the fuel injection valve, in which the fuel flow amount when a one valve apparatus among the two valve apparatuses is opened is set to be smaller than the fuel flow amount when the other valve apparatus is opened; and is particularly distinguished in that, in fuel supply to the fuel injection valve, only one or the other among the two valve apparatuses opens and closes.

The twentieth invention according to the present invention is the fuel injection device of the eighteenth or the nineteenth invention, particularly distinguished in that, for the one valve apparatus, there is used a three way valve which can select a position in which it supplies fuel from the pressure accumulator to the fuel injection valve, and a position in which it interrupts the supply of fuel to the fuel injection valve and relieves the leftover pressure which remains on the side of the fuel injection valve.

The twenty-first invention according to the present invention is the fuel injection device of the eighteenth or the nineteenth invention, particularly distinguished in that, for the other valve apparatus, there is used a three way valve which can select a position in which it supplies fuel from the pressure accumulator to the fuel injection valve, and a position in which it interrupts the supply of fuel to the fuel injection valve and relieves the leftover pressure which remains on the side of the fuel injection valve; and in that a constriction is provided in the path which releases the fuel in which the leftover pressure has been engendered, which keeps the flow amount of the fuel small.

The twenty-second invention according to the present invention is a fuel injection device including a pressure accumulator which accumulates fuel whose pressure has been elevated, a fuel injection valve which opens by the supply of the fuel from the pressure accumulator and injects the fuel, a supply conduit which supplies fuel from the pressure accumulator to the fuel injection valve, and two valve apparatuses which are connected in the supply conduit in series and each of which interrupts fuel supply to the fuel injection valve; and wherein to the supply conduit there is provided a bypass conduit which conducts fuel to bypass the one of the valve apparatuses among the two valve apparatuses which is disposed towards the pressure accumulator; and is particularly distinguished in that, in fuel supply to the fuel injection valve, the two valve apparatuses open and close at the same times.

The twenty-third invention according to the present invention is a fuel injection device including a pressure accumulator which accumulates fuel whose pressure has been elevated, a fuel injection valve which opens by the supply of the fuel from the pressure accumulator and injects the fuel, a supply conduit which supplies fuel from the pressure accumulator to the fuel injection valve, and two valve apparatuses which are connected in the supply conduit in series and each of which interrupts fuel supply to the fuel injection valve; and wherein to the supply conduit there is provided a bypass conduit which conducts fuel to bypass the one of the valve apparatuses among the two valve apparatuses which is disposed towards the pressure accumulator; and is particularly distinguished in that, in fuel supply to the fuel injection valve, only one or the other among the two valve apparatuses opens and closes.

The twenty-fourth invention according to the present invention is the fuel injection device of the twenty-second or the twenty-third invention, particularly distinguished in that, for the other valve apparatus, there is used a three way valve which can select a position in which it supplies fuel from the pressure accumulator to the fuel injection valve, and a position in which it interrupts the supply of fuel to the fuel injection valve and relieves the leftover pressure which remains on the side of the fuel injection valve.

The twenty-fifth invention according to the present invention is a fuel injection device including a pressure accumulator which accumulates fuel whose pressure has been elevated, a fuel injection valve which opens by the supply of the fuel from the pressure accumulator and injects the fuel, a supply conduit which supplies fuel from the pressure accumulator to the fuel injection valve, and two valve apparatuses which are connected in the supply conduit in series and each of which interrupts fuel supply to the fuel injection valve; and wherein: to the supply conduit there is provided a bypass conduit which conducts fuel to bypass the one of the valve apparatuses among the two valve apparatuses which is disposed towards the fuel injection valve, and a constriction is provided in the bypass conduit which keeps the flow amount of the fuel low; and is particularly distinguished in that, in fuel supply to the fuel injection valve, the two valve apparatuses open and close at the same times.

The twenty-sixth invention according to the present invention is a fuel injection device including a pressure accumulator which accumulates fuel whose pressure has been elevated, a fuel injection valve which opens by the supply of the fuel from the pressure accumulator and injects the fuel, a supply conduit which supplies fuel from the pressure accumulator to the fuel injection valve, and two valve apparatuses which are connected in the supply conduit in series and each of which interrupts fuel supply to the fuel injection valve; and wherein: to the supply conduit there is provided a bypass conduit which conducts fuel to bypass the one of the valve apparatuses among the two valve apparatuses which is disposed towards the fuel injection valve, and a constriction is provided in the bypass conduit which keeps the flow amount of the fuel low; and is particularly distinguished in that, in fuel supply to the fuel injection valve, only one or the other among the two valve apparatuses opens and closes.

The twenty-seventh invention according to the present invention is the fuel injection device of the twenty-fifth or the twenty-sixth invention, particularly distinguished in that, for the other valve apparatus, there is used a three way valve which can select a position in which it supplies fuel from the pressure accumulator to the fuel injection valve, and a position in which it interrupts the supply of fuel to the fuel injection valve and relieves the leftover pressure which remains on the side of the fuel injection valve.

The twenty-eighth invention according to the present invention is a fuel injection device including a one pressure accumulator which accumulates fuel whose pressure has been elevated, an other pressure accumulator which accumulates fuel at a higher pressure than the one pressure accumulator, a fuel injection valve which opens by the supply of the fuel from at least one of the one pressure accumulator and the other pressure accumulator and injects the fuel, a one supply conduit which supplies fuel from the one pressure accumulator to the fuel injection valve, a one valve apparatus which is connected in the one supply conduit and which interrupts fuel supply to the fuel injection valve, an other supply conduit which supplies fuel from the other pressure accumulator to the fuel injection valve, and an other valve apparatus which is connected in the other supply conduit and which interrupts fuel supply to the fuel injection valve; and wherein, by the difference in the fuel supply pressures, the fuel flow amount of the one valve apparatus is set to be smaller than the fuel flow amount of the other valve apparatus; and is particularly distinguished in that, in fuel supply to the fuel injection valve, the two valve apparatuses open and close at the same times.

The twenty-ninth invention according to the present invention is a fuel injection device including a one pressure accumulator which accumulates fuel whose pressure has been elevated, an other pressure accumulator which accumulates fuel at a higher pressure than the one pressure accumulator, a fuel injection valve which opens by the supply of the fuel from at least one of the one pressure accumulator and the other pressure accumulator and injects the fuel, a one supply conduit which supplies fuel from the one pressure accumulator to the fuel injection valve, a one valve apparatus which is connected in the one supply conduit and which interrupts fuel supply to the fuel injection valve, an other supply conduit which supplies fuel from the other pressure accumulator to the fuel injection valve, and an other valve apparatus which is connected in the other supply conduit and which interrupts fuel supply to the fuel injection valve; and wherein, by the difference in the fuel supply pressures, the fuel flow amount of the one valve apparatus is set to be smaller than the fuel flow amount of the other valve apparatus; and is particularly distinguished in that, in fuel supply to the fuel injection valve, only one or the other among the two valve apparatuses opens and closes.

The thirtieth invention according to the present invention is the fuel injection device of the twenty-eighth or the twenty-ninth invention, particularly distinguished in that, for the one valve apparatus, there is used a three way valve which can select a position in which it supplies fuel from the one pressure accumulator to the fuel injection valve, and a position in which it interrupts the supply of fuel to the fuel injection valve and relieves the leftover pressure which remains on the side of the fuel injection valve.

The thirty-first invention according to the present invention is a fuel injection device including a one pressure accumulator which accumulates fuel whose pressure has been elevated, an other pressure accumulator which accumulates fuel at a higher pressure than the one pressure accumulator, a fuel injection valve which opens by the supply of the fuel from at least one of the one pressure accumulator and the other pressure accumulator and injects the fuel, a one supply conduit which supplies fuel from the one pressure accumulator to the fuel injection valve, a one valve apparatus which is connected in the one supply conduit and which interrupts fuel supply to the fuel injection valve, an other supply conduit which is connected to the one supply conduit towards the side of the one pressure accumulator from the one valve apparatus and which supplies fuel from the other pressure accumulator to the fuel injection valve, and an other valve apparatus which is connected in the other supply conduit and which interrupts fuel supply to the fuel injection valve; and wherein, by the difference in the fuel supply pressures, the fuel flow amount of the one valve apparatus is set to be smaller than the fuel flow amount of the other valve apparatus; and is particularly distinguished in that, in fuel supply to the fuel injection valve, the two valve apparatuses open and close at the same times.

The thirty-second invention according to the present invention is a fuel injection device including a one pressure accumulator which accumulates fuel whose pressure has been elevated, an other pressure accumulator which accumulates fuel at a higher pressure than the one pressure accumulator, a fuel injection valve which opens by the supply of the fuel from at least one of the one pressure accumulator and the other pressure accumulator and injects the fuel, a one supply conduit which supplies fuel from the one pressure accumulator to the fuel injection valve, a one valve apparatus which is connected in the one supply conduit and which interrupts fuel supply to the fuel injection valve, an other supply conduit which is connected to the one supply conduit towards the side of the one pressure accumulator from the one valve apparatus and which supplies fuel from the other pressure accumulator to the fuel injection valve, and an other valve apparatus which is connected in the other supply conduit and which interrupts fuel supply to the fuel injection valve; and wherein, by the difference in the fuel supply pressures, the fuel flow amount of the one valve apparatus is set to be smaller than the fuel flow amount of the other valve apparatus; and is particularly distinguished in that, in fuel supply to the fuel injection valve, only one or the other among the two valve apparatuses opens and closes.

The thirty-third invention according to the present invention is the fuel injection device of the thirty-first or the thirty-second invention, particularly distinguished in that, for the one valve apparatus, there is used a three way valve which can select a position in which it supplies fuel from the one pressure accumulator to the fuel injection valve, and a position in which it interrupts the supply of fuel to the fuel injection valve and relieves the leftover pressure which remains on the side of the fuel injection valve.

The diesel engine of the thirty-fourth invention according to the present invention is particularly distinguished by being equipped with the fuel injection device of any one of the eighteenth through the thirty-third inventions.

With this invention, if for example a high load is imposed upon the diesel engine, in the fuel supply to the fuel injection valve, the one valve apparatus among the two valve apparatuses whose fuel injection amount per unit time is small is opened first, and next the other valve apparatus whose fuel injection amount per unit time is great is opened, so that the fuel injection rate in the first half of the injection stroke is kept low and the generation of NOx in the combustion period is restrained, while the fuel injection rate in the second half of the injection stroke is increased and high output power is obtained.

Furthermore, with this invention, if for example a medium or low load is imposed upon the diesel engine, in the fuel supply to the fuel injection valve, by the two valve apparatuses opening and closing at the same times, the fuel injection rate is kept high and constant from the beginning to the end. By opening and closing the two valve apparatuses at the same times as described above during medium and low load in which the amount of generation of NOx is reduced due to the combustion temperature being lower, desirable combustion with a low amount of smoke emission is implemented.

Yet further, with this invention, if for example an extremely low load is imposed upon the diesel engine, in the fuel supply to the fuel injection valve, by only the one valve apparatus whose fuel injection amount per unit time is low among the two valve apparatuses opening and closing, the fuel injection rate is kept low and constant from the beginning to the end. When implementing a low fuel injection rate with a valve apparatus with which the fuel flow amount is set to be large as in the prior art, the responsiveness is limited, and it is not possible to perform stabilized fuel injection, but, by opening and closing only the one valve apparatus whose fuel injection amount per unit time is low, a low fuel injection rate is implemented and stabilized combustion is implemented. It should be understood that, if the load which is imposed is not so low as to be considered an extremely low load, it would also be possible to open and close only the other valve apparatus whose fuel injection amount per unit time is larger.

In addition, even if the one or the other of the two valve apparatuses has suffered breakdown and has ceased to operate, it is still possible to continue the operation of the diesel engine without stopping, by only the other valve apparatus operating to open and close during fuel supply to the fuel injection valve.

The thirty-fifth invention according to the present invention is a fuel injection device including a pressure accumulator which accumulates fuel whose pressure has been elevated, a fuel injection valve which opens by the supply of the fuel from the pressure accumulator and injects the fuel, a fuel supply conduit which supplies fuel from the pressure accumulator to the fuel injection valve, a main valve which is connected in the fuel supply conduit and which interrupts fuel supply to the fuel injection valve, and a main valve drive mechanism which drives the main valve; and is particularly distinguished in that the main valve drive mechanism moves the main valve to at least two positions whose opening amounts are different.

With this fuel injection device, the main valve can be opened to at least two positions whose opening amounts are different. Accordingly, if the opening amount of the main valve is small, a large pressure loss is caused in its fluid conduit, and the injection pressure which is injected from the fuel injection valve is kept to be low. On the other hand, if the opening amount of the main valve is large, the pressure loss in its fluid conduit becomes small, and the injection pressure which is injected from the fuel injection valve comes to be elevated. As a result, not only can the rate of fuel consumption be maintained as desired, but it becomes possible to reduce the NOx in the exhaust gas.

The thirty-sixth invention according to the present invention is the fuel injection device of the thirty-fifth invention, particularly distinguished in that: the main valve drive mechanism is provided at one end of the main valve, and includes a biasing member which biases the main valve to the closed position, and a drive section which applies fluid to the other end portion of the main valve to open the main valve; the drive section includes a fluid supply conduit which supplies fluid from a fluid supply source to the other end portion, two valve apparatuses which are connected in the fluid supply conduit and which interrupt fluid supply to the other end portion, a bypass conduit which supplies the fluid to the other end portion by bypassing a valve apparatus among these two valve apparatuses which is positioned in a one direction, and a constriction which is provided in the bypass conduit; and, in fluid supply to the other end portion, the valve apparatus among the two valve apparatuses which is positioned in the other direction opens first, and next the valve apparatus which is positioned in the one direction opens.

With this fuel injection device, by opening the other valve apparatus before the one valve apparatus, the fluid flow through the bypass conduit and the constriction acts upon the other end portion of the main valve to open the main valve, and next by the one valve apparatus opening the fluid flow through the fluid supply conduit acts upon the other end portion of the main valve and comes to open the main valve. In other words, initially a fluid mass at low pressure acts upon the other end portion of the main valve, and next a fluid mass at high pressure comes to act upon the other end portion of the main valve. Due to this, the main valve first opens to a small opening amount, and thereafter comes to open to a large amount. Accordingly, the fuel injection rate during the first half of the fuel injection period is kept low, while the fuel injection rate during the second half of the fuel injection period is increased.

The thirty-seventh invention according to the present invention is the fuel injection device of the thirty-sixth invention, particularly distinguished in that, at the other end portion of the main valve, there is provided at least one connecting conduit which communicates together a return conduit which returns fluid which acts upon the other end portion to the fluid supply source, and the other end portion upon which the fluid acts; and moreover the at least one connecting conduit is made so that its fluid conduit resistance diminishes according as the fluid pressure which acts upon the other end portion increases.

With this fuel injection device, it is arranged for the flow resistance of the connecting conduit to become large, if the pressure of the fluid which acts upon the other end portion is low. Accordingly, the pressure of the fluid which acts upon the other end portion and tries to open the main valve and the biasing force of the biasing member which tries to close the main valve instantaneously become in equilibrium. As a result, it is possible to change the fuel injection rate in a stepwise manner.

The thirty-eighth invention according to the present invention is the fuel injection device of the thirty-seventh invention, particularly distinguished in that the at least one connecting conduit is a slit which is formed in the outer surface of the other end portion.

With this fuel injection device, since the connecting conduit is formed in slit form upon the outer surface of the other end portion, the fluid which acts upon the other end portion flows in the return conduit along this slit. Since the slit is easy to form, it is possible to offer a low cost device.

The thirty-ninth invention according to the present invention is a diesel engine which is particularly distinguished by being equipped with the fuel injection device of any one of the thirty-fifth through the thirty-eighth inventions, and with a cylinder head to which the fuel injection valve is fitted.

With this diesel engine, since it is possible to control the fuel injection rate during the period of fuel injection, not only can the rate of fuel consumption be maintained as desired, but it becomes possible to reduce the NOx in the exhaust gas.

The fortieth invention according to the present invention is the diesel engine of the thirty-ninth invention, particularly distinguished in that the pressure accumulator, the main valve, and the main valve drive mechanism are provided as separated from the cylinder head.

With this diesel engine, by providing the pressure accumulator, the main valve, and the main valve drive mechanism as separated from the cylinder head, maintenance and the task of changing components and the like can be performed simply. Furthermore, the freedom in the design of the diesel engine is enhanced, and it is possible to anticipate that the cylinder head will be more compact and light in weight.

### BRIEF DESCRIPTION OF THE DRAWINGS

FIG. 1 is a figure which shows the overall structure of a first embodiment of the fuel injection device according to the present invention.

FIG. 2 is a figure which shows the overall structure of a diesel engine which is equipped with the fuel injection device of FIG. 1.

FIG. 3 is a figure which shows the change of fuel injection rate per one injection stroke which is implemented by the fuel injection device of FIG. 1.

FIG. 4 is a figure which shows the overall structure of a fuel injection device in which the electromagnetic valves of FIG. 1 have each been replaced by a hydraulic pressure operated valve.

FIG. 5 is a figure which shows the overall structure of a second embodiment of the fuel injection device according to the present invention.

FIG. 6 is a figure which shows the overall structure of a fuel injection device in which the electromagnetic valves of FIG. 5 have each been replaced by a hydraulic pressure operated valve.

FIG. 7 is a figure which shows the overall structure of a third embodiment of the fuel injection device according to the present invention.

FIG. 8 is a figure which shows the overall structure of a fuel injection device in which the electromagnetic valves of FIG. 7 have each been replaced by a hydraulic pressure operated valve.

FIG. 9 is a figure which shows the overall structure of a fourth embodiment of the fuel injection device according to the present invention.

FIG. 10 is a figure which shows the overall structure of a fuel injection device in which the electromagnetic valves of FIG. 9 have each been replaced by a hydraulic pressure operated valve.

FIG. 11 is a figure which shows the overall structure of a fifth embodiment of the fuel injection device according to the present invention.

FIG. 12 is a figure which shows the overall structure of a fuel injection device in which the electromagnetic valves of FIG. 11 have each been replaced by a hydraulic pressure operated valve.

FIG. 13 is a figure which shows the overall structure of a sixth embodiment of the fuel injection device according to the present invention.

FIG. 14 is a figure which shows the overall structure of a fuel injection device in which the electromagnetic valves of FIG. 13 have each been replaced by a hydraulic pressure operated valve.

FIG. 15 is a figure which shows the overall structure of a seventh embodiment of the fuel injection device according to the present invention.

FIG. 16 is a figure which shows the overall structure of a fuel injection device in which the electromagnetic valves of FIG. 15 have each been replaced by a hydraulic pressure operated valve.

FIG. 17 is a figure which shows the overall structure of an eighth embodiment of the fuel injection device according to the present invention.

FIG. 18 is a figure which shows the overall structure of a diesel engine which is equipped with the fuel injection device of FIG. 17.

FIG. 19A is a figure which shows the change of fuel injection rate per one injection stroke which is implemented during high load by the fuel injection device of FIG. 17.

FIG. 19B is a figure which shows the change of fuel injection rate per one injection stroke which is implemented during medium and low load by the fuel injection device of FIG. 17.

FIG. 19C is a figure which shows the change of fuel injection rate per one injection stroke which is implemented during extremely low load by the fuel injection device of FIG. 17.

FIG. 19D is a figure which shows the change of fuel injection rate per one injection stroke which is implemented by the fuel injection device of FIG. 17, during failure of an electromagnetic valve which is designated by the reference symbol 206 in FIG. 17.

FIG. 19E is a figure which shows the change of fuel injection rate per one injection stroke which is implemented by the fuel injection device of FIG. 17, during failure of an electromagnetic valve which is designated by the reference symbol 207 in FIG. 17.

FIG. 20 is a figure which shows the overall structure of a ninth embodiment of the fuel injection device according to the present invention.

FIG. 21 is a figure which shows the overall structure of a tenth embodiment of the fuel injection device according to the present invention.

FIG. 22 is a figure which shows the overall structure of an eleventh embodiment of the fuel injection device according to the present invention.

FIG. 23 is a figure which shows the overall structure of a twelfth embodiment of the fuel injection device according to the present invention.

FIG. 24 is a figure which shows the overall structure of a thirteenth embodiment of the fuel injection device according to the present invention.

FIG. 25 is a figure which shows the overall structure of a fourteenth embodiment of the fuel injection device according to the present invention.

FIG. 26 is a figure which shows the overall structure of a diesel engine which is equipped with the fuel injection device of FIG. 25.

FIG. 27 is a figure for explanation of the operational state of the fuel injection device shown in FIG. 25, and is a figure which shows the change of fuel injection rate per one admission stroke, and the opening and closing states of the various valves.

FIG. 28 is a figure which shows the overall structure of a fifteenth embodiment of the fuel injection device according to the present invention.

FIG. 29 is a figure for explanation of the operational state of the fuel injection device shown in FIG. 28, and is a figure which shows the change of fuel injection rate per one admission stroke, and the opening and closing states of the various valves.

FIG. 30A is a figure which shows a first variant embodiment of a slit (a connecting conduit) shown in FIG. 28.

FIG. 30B is a figure which shows a second variant embodiment of a slit (a connecting conduit) shown in FIG. 28.

FIG. 30C is a figure which shows a third variant embodiment of a slit (a connecting conduit) shown in FIG. 28.

FIG. 31 is a figure which shows the overall structure of a prior art fuel injection device.

FIG. 32 is a figure for explanation of the operational state of the fuel injection device shown in FIG. 7, and is a figure which shows the change of fuel injection rate per one admission stroke, and the opening and closing states of the various valves.

### THE PREFERRED EMBODIMENTS

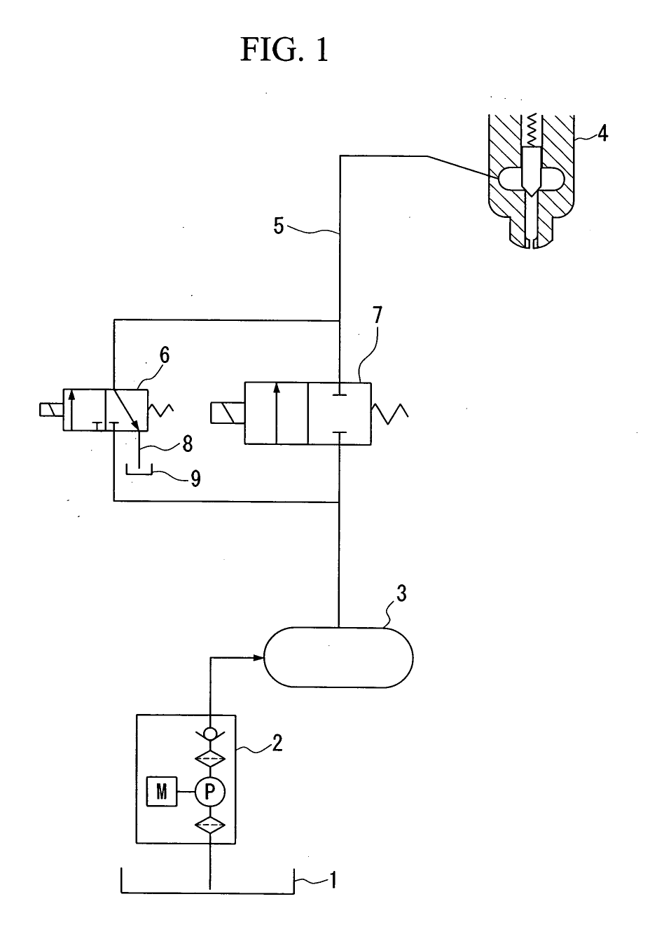

The first embodiment of the fuel injection device according to the present invention and of a diesel engine equipped therewith shown in FIGS. 1 through 4 will now be explained.

FIG. 1 is a figure which shows the overall structure of a first embodiment of the fuel injection device according to the present invention. In the figure, the reference symbol 1 denotes a fuel tank, 2 denotes a fuel pump which pressurizes and supplies fuel, 3 denotes a pressure accumulator which accumulates fuel which has been pressurized and supplied from the fuel pump 2 at a predetermined pressure or at a pressure above it, 4 denotes a fuel injection valve which, by being supplied with pressurized fuel from the pressure accumulator 3, releases and injects this fuel, and 5 denotes a supply conduit which supplies fuel to the fuel injection valve 4 from the pressure accumulator 3.

Two electromagnetic valves 6 and 7 are connected in parallel in the supply conduit 5, as a valve construction which interrupts the fuel supply to the fuel injection valve 4. As the one 6 of the electromagnetic valves, there is used a component for which the fuel flow amount when open is less than that of the other electromagnetic valve 7.

For the electromagnetic valve 6, there is used a three way valve which can select a position which supplies fuel from the pressure accumulator 3 to the fuel injection valve 4, and a position which interrupts the fuel supply to the fuel injection valve 4 and relieves to the outside of the system the leftover pressure which remains at the fuel injection valve 4 side. For the electromagnetic valve 7, there is used a two way valve which can select a position which supplies fuel from the pressure accumulator 3 to the fuel injection valve 4, and a position which interrupts the fuel supply to the fuel injection valve 4.

Furthermore, a drain conduit 8 which vents fuel which remains in the supply conduit 5 on the fuel injection valve 4 side when the position which interrupts the fuel supply to the fuel injection valve 4 has been selected and in which leftover pressure has been engendered is connected to the electromagnetic valve 6, and a drain pan 9 which receives the surplus fuel is provided at its end.

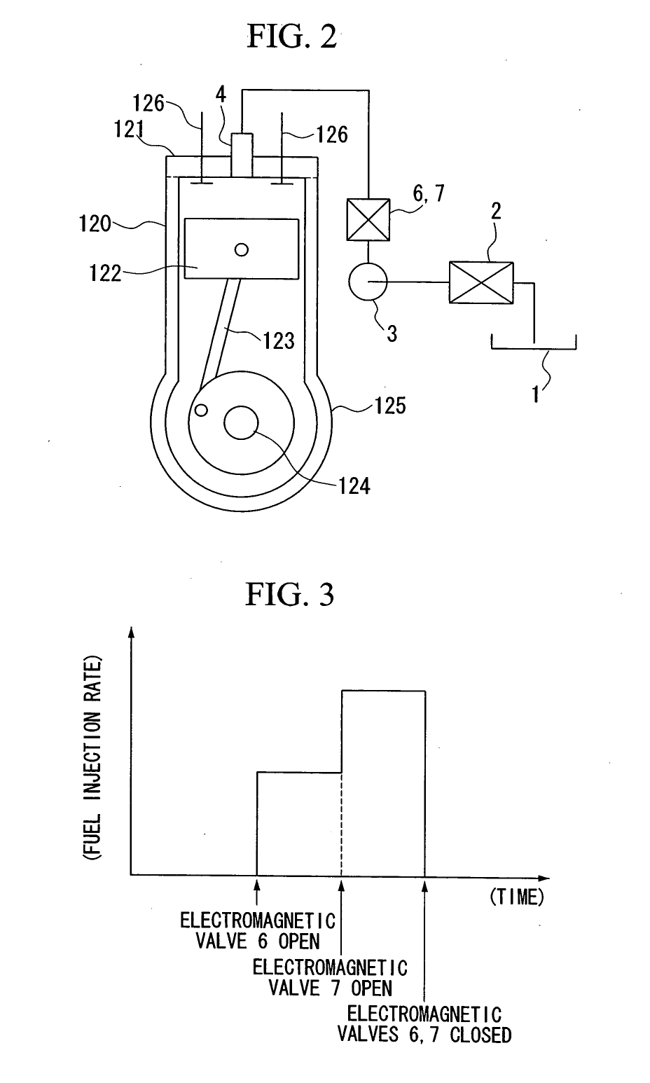

FIG. 2 is a figure which shows the overall structure of a diesel engine of the reciprocating type which is equipped with this fuel injection device. In the figure, the reference symbol 120 denotes a cylinder, 121 denotes a cylinder head, 122 denotes a piston, 123 denotes a piston rod, 124 denotes a crankshaft, 125 denotes a crankcase, and 126 denotes valves. It should be understood that, in this embodiment, the combination of the cylinder 120 and the cylinder head 121 constitutes an engine cylinder.

With the fuel injection device, the fuel injection valve 4 is positioned almost in the middle of the cylinder head 121, but the pressure accumulator 3 and the electromagnetic valves 6 and 7 are positioned separately at a side portion of the cylinder 120, and both are connected by a conduit which constitutes the supply conduit 5.

The operational stroke of the fuel injection device constructed as described above, when the diesel engine equipped therewith is operated, will now be explained.

Fuel which has been pressurized by the operation of the fuel pump 2 is normally accumulated in the pressure accumulator 3. The fuel which has been accumulated in this pressure accumulator 3 is injected intermittently from the fuel injection valve 4 by the following type of opening and closing operation of the electromagnetic valves 6 and 7.

When the diesel engine enters its fuel injection stroke, from both the electromagnetic valves 6 and 7 being in the closed state, the electromagnetic valve 6 opens first, and the fuel which has been accumulated in the pressure accumulator 3 is supplied to the fuel injection valve 4 via the electromagnetic valve 6. Next, the electromagnetic valve 7 opens after a predetermined time period from the opening of the electromagnetic valve 6, and the fuel which has been accumulated in the pressure accumulator 3 is supplied to the fuel injection valve 4 via the electromagnetic valves 6 and 7 in parallel. When the fuel injection stroke terminates, the electromagnetic valves 6 and 7 close at the same time. When the electromagnetic valves 6 and 7 close, the fuel which remains in the supply conduit 5 on the fuel injection valve 4 side in which leftover pressure has been engendered is vented through the drain conduit 8 which is provided to the electromagnetic valve 6, and is collected in the drain pan 9.

When in this manner the electromagnetic valve 6 whose fuel flow amount when open is the smaller is opened first, the fuel injection rate in the first half of the period of fuel injection per one injection stroke is kept low, while, when the electromagnetic valve 7 whose fuel flow amount when open is the higher is opened after a delay, the fuel injection rate in the second half is increased (the change of fuel injection rate in one injection stroke is as shown in FIG. 3).

Accordingly, with the diesel engine of this embodiment, in the fuel injection period, the fuel injection rate in the first half is kept low, while next in the second half the fuel injection rate is increased. As a result, it is possible to reduce the NOx in the exhaust gas while maintaining a desirable rate of fuel consumption.

Furthermore, by structuring the pressure accumulator 3 and the electromagnetic valves 6 and 7 separately from the fuel injection valve 4, and by providing them as separated from the engine cylinder which consists of the cylinder 120 and the cylinder head 121, it is possible simply to perform maintenance and the operation of replacement of parts. Furthermore, the degree of freedom in designing the diesel engine is increased, and it is possible to implement reduction in size and weight of the engine cylinder and of the diesel engine.

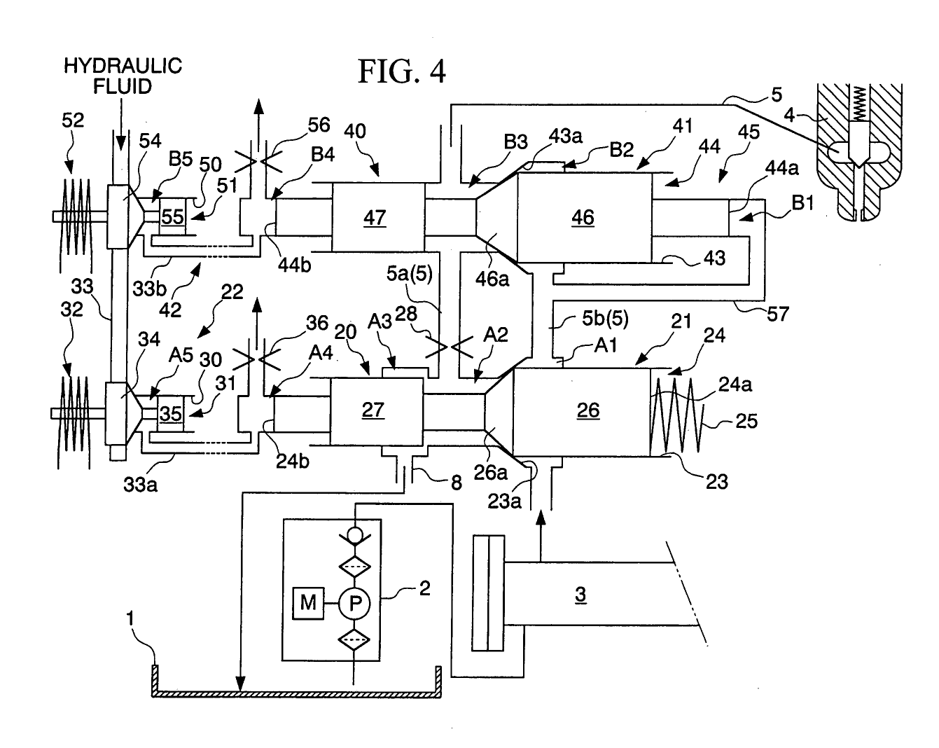

Moreover, although with this embodiment the electromagnetic valves 6 and 7 were used as the valve apparatus, according to the present invention, the same results can be obtained even if these are replaced by hydraulic pressure operated valves. FIG. 4 shows the structure of a fuel injection device in which the electromagnetic valves 6 and 7 have been replaced by hydraulic pressure operated valves 20 and 40, respectively.

The hydraulic pressure operated valve 20 comprises a main valve 21 which functions as a three way valve, and a pilot valve 22 which interrupts the supply of hydraulic fluid which must operate the main valve 21.

The main valve 21 is made up from a cylinder portion 23 which is supplied with fuel from the pressure accumulator 3 via the supply conduit 5, a control piston 24 which is disposed so as to be capable of reciprocating action within the cylinder portion 23, and a return spring 25 which acts against one end face 24a of the control piston 24 so as to bias the control piston 24 in one direction.

In the cylinder portion 23 there are provided in sequence a space A1 which communicates to the pressure accumulator 3, a space A2 which communicates to a parallel supply conduit 5a which communicates to the fuel injection valve 4, a space A3 which communicates to the drain conduit 8, and a space A4 which communicates to the pilot valve 22 and is supplied with hydraulic fluid.

To the control piston 24 there are provided, as separated along the longitudinal direction of the control piston 24, a first valve body 26 which is disposed in the spaces A1 and A2 and which communicates/intercepts these spaces to interrupt the supply conduit 5, and a second valve body 27 which is disposed between the spaces A2 and A3 and which communicates/intercepts both spaces to open and close the drain conduit 8. The other end face of the control piston 24 must receive the pressure of the hydraulic fluid which is supplied from the pilot valve 22, and is disposed in the space A4.

The cross section of the cylinder portion 23 perpendicular to its longitudinal direction is a circle at any portion thereof, and is formed to be larger diameter in the space A1 than in the space A2, and smaller diameter in the space A2 than in the space A3. In the inner wall surface of the cylinder portion 23 which is between the spaces A1 and A2, there is formed a squeezed diameter portion 23a whose diameter is squeezed down in a funnel shape. Furthermore, in the first valve body 26, there is formed a seat portion 26a of a taper shape which divides the spaces A1 and A2 by contacting the squeezed diameter portion 23a. In the state in which the seat portion 26a comes to contact, with respect to the squeezed diameter portion 23a, against the edge portion of its outermost peripheral portion (this will be termed “outer contact”) so that the first valve body 26 is in the state of having closed between the spaces A1 and A2, the pressure of the fuel which has been supplied to the space A1 does not to act upon the seat portion 26a.

In the supply conduit 5a on the side downstream of the main valve 21, there is provided a constriction 28 whose fuel flow amount is less than that of the hydraulic pressure operated valve 20 when it is open. Due to this, the fuel flow amount of the hydraulic pressure operated valve 20 when it is open is set to be less than that of the hydraulic pressure operated valve 40. Furthermore, the vent end of the drain conduit 8 is communicated to the fuel tank 1, rather than to any separately provided drain pan, so as to be able to take advantage of the fuel which has leftover pressure without any waste.

The pilot valve 22 is provided partway along an hydraulic fluid supply conduit 33 which supplies hydraulic fluid from an hydraulic fluid supply source to the space A4 on the main valve 21 side. Furthermore, the pilot valve 22 is made up from a cylinder portion 30 which is supplied with hydraulic fluid from the hydraulic fluid supply source not shown in the figures, a control piston 31 which has been disposed within the cylinder portion 30 so as to be capable of reciprocating action therein, and an electromagnetic drive section 32 which drives the control piston 31 to and fro and is controlled by a control section not shown in the figures.

The space A5 within the cylinder portion 30 is communicated to the hydraulic fluid supply conduit 33 on the one hand, while on the other hand it is communicated to the space A4 of the main valve 21 via the hydraulic fluid supply conduit 33a which extends from the space A5.

In the control piston 31 there are provided, separated from one another in the longitudinal direction of the control piston 31, a third valve body 34 which is disposed between the hydraulic fluid supply conduit 33 and the space A5 and which intercepts between these spaces to interrupt the hydraulic fluid supply conduit 33, and a fourth valve body 35 which defines a surface of the space A5.

In the hydraulic fluid vent passage on the downstream side of the pilot valve 22 there is provided a constriction 36 which constricts the flow amount of hydraulic fluid therein.

The hydraulic pressure operated valve 40 is made in basically the same construction as the hydraulic pressure operated valve 20, and it comprises a main valve 41 which operates as a two way valve, and a pilot valve 42 which interrupts the supply of hydraulic fluid which must operate the main valve 41.

The main valve 41 is made up from a cylinder portion 43 which is supplied with fuel from the pressure accumulator 3 via a supply conduit 5b, a control piston 44 which is disposed so as to be capable of reciprocating action within the cylinder portion 43, and a return mechanism 45 which acts against one end face 44a of the control piston 44 so as to bias the control piston 44 in one direction.

In the cylinder portion 43 there are provided in sequence a space B1 which constitutes one portion of the return mechanism 45, a space B2 which communicates to the pressure accumulator 3 via the supply conduit 5, a space B3 which communicates to the supply conduit 5 which communicates to the fuel injection valve 4, and a space B4 which communicates to the pilot valve 42 and is supplied with hydraulic fluid.

To the control piston 44 there are provided, as separated along the longitudinal direction of the control piston 44, a first valve body 46 which is disposed in the spaces B2 and B3 and which communicates/intercepts these spaces to interrupt the supply conduit 5, and a second valve body 47 which defines one surface of the space B3. The other end face of the control piston 44 must receive the pressure of the hydraulic fluid which is supplied from the pilot valve 42, and is disposed in the space B4. The one end face 44a of the control piston 44 is disposed in the space B1 which must receive the pressure of the fuel which is supplied from the pressure accumulator 3, while the other end face 44b of the control piston 44 is disposed within the space B4 which must receive the pressure of the fuel which is supplied from the pilot valve 42.

The cross section of the cylinder portion 43 as seen perpendicular to its longitudinal direction is a circle at any portion thereof, and is formed to be larger diameter in the space B2 than in the space B3. In the inner wall surface of the cylinder portion 43 which is between the spaces B1 and B2, there is formed a squeezed diameter portion 43a whose diameter is squeezed down in a funnel shape. Furthermore, in the first valve body 46, there is formed a seat portion 46a of a taper shape which divides the spaces B2 and B3 by contacting the squeezed diameter portion 43a. In the state in which the sloping surface of the taper shape of the seat portion 46a comes to contact against the smallest diameter edge portion of the squeezed diameter portion 43a (this will be termed “inner contact”) so that the first valve body 46 has closed between the spaces B2 and B3, the pressure of the fuel which has been supplied to the space B2 comes to act upon the seat portion 46a which is more peripherally outwards than the portion which is contacted against the squeezed diameter portion 43a.

It should be understood that the supply conduit 5b communicates to the main valve 21 and to the main valve 41 in parallel, and fuel is arranged to be supplied to the main valve 41, without any relationship to whether or not the first valve body 26 is opened or closed.

The pilot valve 42 is made up from a cylinder portion 50 which is supplied with hydraulic fluid from the hydraulic fluid supply source not shown in the figures, a control piston 51 which has been disposed within the cylinder portion 50 so as to be capable of reciprocating action therein, and an electromagnetic drive section 52 which drives the control piston 51 to and fro and is controlled by a control section not shown in the figures, and it is provided partway along the hydraulic fluid supply conduit 33 which supplies hydraulic fluid from the hydraulic fluid supply source to the space B4 on the main valve 41 side.

The space B5 within the cylinder portion 50 is communicated on the one hand to the hydraulic fluid supply conduit 33, while on the other hand it is communicated via the hydraulic fluid supply conduit 33b to the space B4 of the main valve 41.

In the control piston 51 there are provided a third valve body 54 which is disposed between the hydraulic fluid supply conduit 33 and the space B5 and which intercepts between these spaces to interrupt the hydraulic fluid supply conduit 33, and a fourth valve body 55 which defines a surface of the space A5, and these are separated from one another in the longitudinal direction.

In the hydraulic fluid vent passage on the downstream side from the pilot valve 42 there is provided a constriction 56 which restricts the flow amount of hydraulic fluid.

It should be understood that the hydraulic fluid supply conduit 33 is communicated to the pilot valves 22 and 42 in parallel, and it is arranged for the hydraulic fluid to be supplied without any relationship as to whether the third valve body 54 is opened or closed.

In the return mechanism 45, along with there being included a pressure introduction conduit 57 which branches off from the parallel supply conduit 5b and which supplies fuel from the pressure accumulator 3 to the space B1, the area of the one end face 44a of the control piston 44 and the area of the seat portion 46a are set so that the pressure of the fuel which acts upon the one end face of the control piston 44 and which biases the control piston 44 in one direction (the leftwards direction as facing the drawing paper) becomes greater than the pressure of the fuel which acts upon the seat portion 46a and which biases the control piston 44 in the other direction (the rightwards direction as facing the drawing paper), (in concrete terms, ) the area of the one end face 44a of the control piston 44 is made to be greater than the area of the seat portion 46a projected in the axial direction of the control piston 44). By doing this, an imbalance is set up in the pressures which act forwards and backwards upon the first valve body 46, and thereby a force comes to act so as to bias the control piston 44 in the one direction, the same as the return spring 25.

The stroke of the operation of the fuel injection device constituted as described above will now be explained.

When the diesel engine enters upon its fuel injection stroke, the hydraulic pressure operated valves 20 and 40 together start operation from their closed states, with the hydraulic pressure operated valve 20 starting its operation first. First, the electromagnetic drive section 32 operates and the control piston 31 shifts in the one direction (the leftwards direction as seen looking at the drawing paper), and the third valve body 34 opens and the hydraulic fluid flows into the space A5, and furthermore flows into the space A4 via the hydraulic fluid conduit 33a. When the hydraulic fluid flows into the space A4, the control piston 24 which experiences the pressure of the hydraulic fluid shifts in the other direction (the rightward direction as seen looking at the drawing paper), and, along with the first valve body 26 opening, the second valve body 27 closes the drain conduit 8, so that fuel is supplied from the pressure accumulator 3 via the spaces A1 and A2, the supply conduit 5a, and the space B3 to the fuel injection valve 4. It should be understood that the fuel injection rate at this time is kept low by the operation of the constriction 28.

Next, the hydraulic pressure operated valve 40 starts its operation. First, the electromagnetic drive section 52 operates and the control piston 51 shifts in the one direction, so that the third valve body 54 opens and the hydraulic fluid flows in to the space B5, and furthermore flows in to the space B4 via the hydraulic fluid supply conduit 33b. When the hydraulic fluid flows in to the space B4, the control piston 44 which experiences the pressure of the hydraulic fluid shifts in the other direction and the first valve body 46 opens, so that fuel is supplied from the pressure accumulator 3 via the space A1, the supply conduit 5b, and the spaces B2 and B3 to the fuel injection valve 4. Since at this time the fuel injection rate does not suffer the operation of the constriction 28, it is higher than in the first half stroke.

When the fuel injection stroke is terminated, the hydraulic pressure operated valves 20 and 40 close at the same time. In other words, the operation of the electromagnetic drive sections 32 and 52 is cancelled at the same time, and, in the hydraulic pressure operated valve 20, the control piston 31 shifts in the other direction, so that the third valve body 34 closes and the supply of hydraulic fluid to the space A5 and also to the space A4 is cut off. When the supply of hydraulic fluid to the space A4 is cut off, the hydraulic fluid is vented from the space A4 via the constriction 36, and the biasing force upon the control piston 24 due to the hydraulic fluid is cancelled. When the biasing force due to the hydraulic fluid is cancelled, the control piston 24 receives the biasing force of the return spring 25 and shifts in the one direction, so that, along with the first valve body 26 closing, the second valve body 27 opens the drain conduit 8, and the fuel supply via the supply conduit 5a is cut off.

At the same time, in the hydraulic pressure operated valve 40, the control piston 51 shifts in the other direction, so that the third valve body 54 closes and the supply of hydraulic fluid to the space B5 and also to the space B4 is cut off. When the supply of hydraulic fluid to the space B4 is cut off, the hydraulic fluid is vented from the space B4 via the constriction 56, and the biasing force upon the control piston 44 due to the hydraulic fluid is cancelled. When the biasing force due to the hydraulic fluid is cancelled, the control piston 44 receives the biasing force of the return mechanism 45 and shifts in the one direction, so that the first valve body 46 closes and the fuel supply to the fuel injection valve 4 is completely cut off.

When the hydraulic pressure operated valves 20 and 40 close, the fuel remaining in the supply conduit 5 on the fuel injection valve 4 side in which leftover pressure has been engendered is vented via the supply conduit 5a, the spaces A2 and A3, and the drain conduit 8, and is collected in the fuel tank 1.

In this manner, with the fuel injection device of FIG. 4 in which the hydraulic pressure operated valves 20 and 40 have been used instead of electromagnetic valves as well, in the period of fuel injection per one injection stroke, the fuel injection rate in the first half is kept low, while the fuel injection rate in the second half is increased.

Furthermore, with the fuel injection device of FIG. 4, when the operation of the electromagnetic drive section 52 is cancelled, stabilized operation is implemented, since the control piston 44 carries out its return in the one direction due to the operation of the return mechanism 45 without any delay. Yet further, since the diameter of the end face of the second valve body 47 which delimits the space B3 and the seat diameter of the seat portion 46a which delimits the space B3 in the same manner are the same, the pressures exerted upon the control piston by the fuel which has flowed into the space B3 match, and moreover the biasing force due to the return mechanism 45 acts upon the control piston 44. Accordingly, even if the hydraulic pressure operated valve 20 operates first and the pressure in the supply conduit 5a rises, the biasing force which is generated by the return mechanism resists, so that first valve body 46 does not open (which would be undesirable), so that stabilized operation is implemented due to this matter as well. Moreover, since this construction is extremely simple, there are the beneficial points that it is possible to anticipate restraint of the manufacturing cost due to reduction of the size and the weight of the injection device, widening of its applicability, and improvement of its maintenance characteristics.

It should be understood that, with the fuel injection device of FIG. 4, by making the main valve 21 and the main valve 41 to be of the same size, and by providing the constriction 28 in the supply conduit 5a on the downstream side of the main valve 21, it is arranged for the capacity of the hydraulic pressure operated valve 20 to be less than that of the hydraulic pressure operated valve 40 (i.e. its fuel flow amount is smaller); but, other than providing this type of constriction, it would also be possible, by making the main valve 21 and the main valve 41 to be of the same size, and by making the lift amounts of the first valve bodies 26 and 36 to be different, to provide them with quantitative differences in their capacities. Furthermore, it would also be possible to provide them with quantitative differences in their capacities by making the sizes of the main valve 21 and the main valve 41 themselves different.

Yet further although, with the fuel injection device of FIG. 4, a biasing force of the desired strength was provided to the return mechanism 45 by suitably setting the magnitudes of the area of the one end face 44a of the control piston 44 and the area of the seat portion 46a, other than providing the biasing force only by an imbalance of pressure in this manner, it would also be possible to obtain biasing force by combining a return mechanism due to imbalance of pressure and a return spring. With this construction, the number of parts is increased so that it becomes more complicated, but since the biasing force of the return mechanism and the biasing force of the return spring are separated, it is possible to set the range of pressure over which operation is possible to be wider, and, even if the pressure in the pressure accumulator 3 changes, it is possible to implement stabilized operation in correspondence thereto.

Furthermore, it would also be possible to eliminate the return mechanism due to imbalance, and only to obtain biasing force from the return spring.

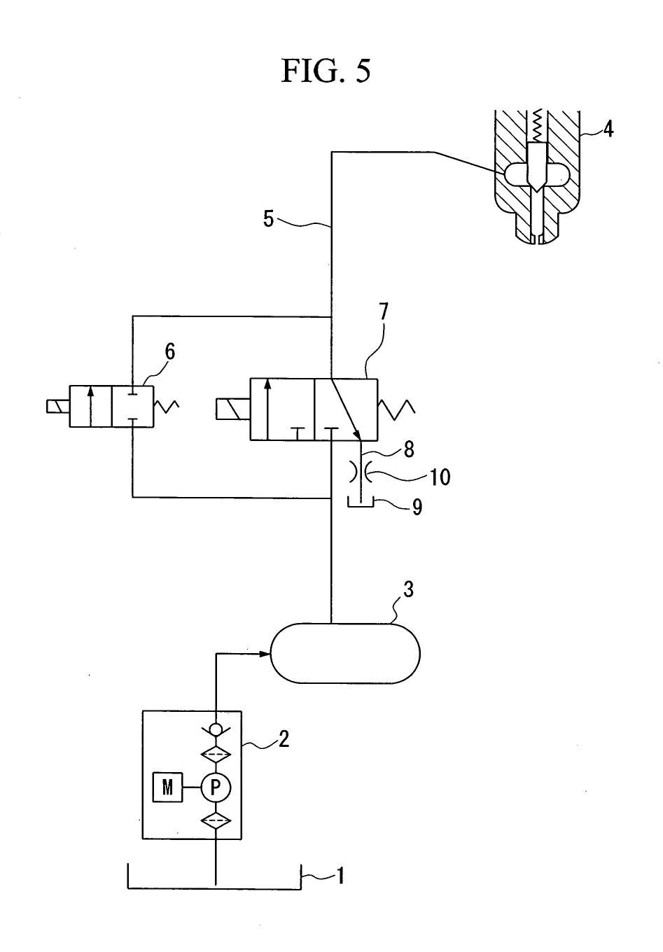

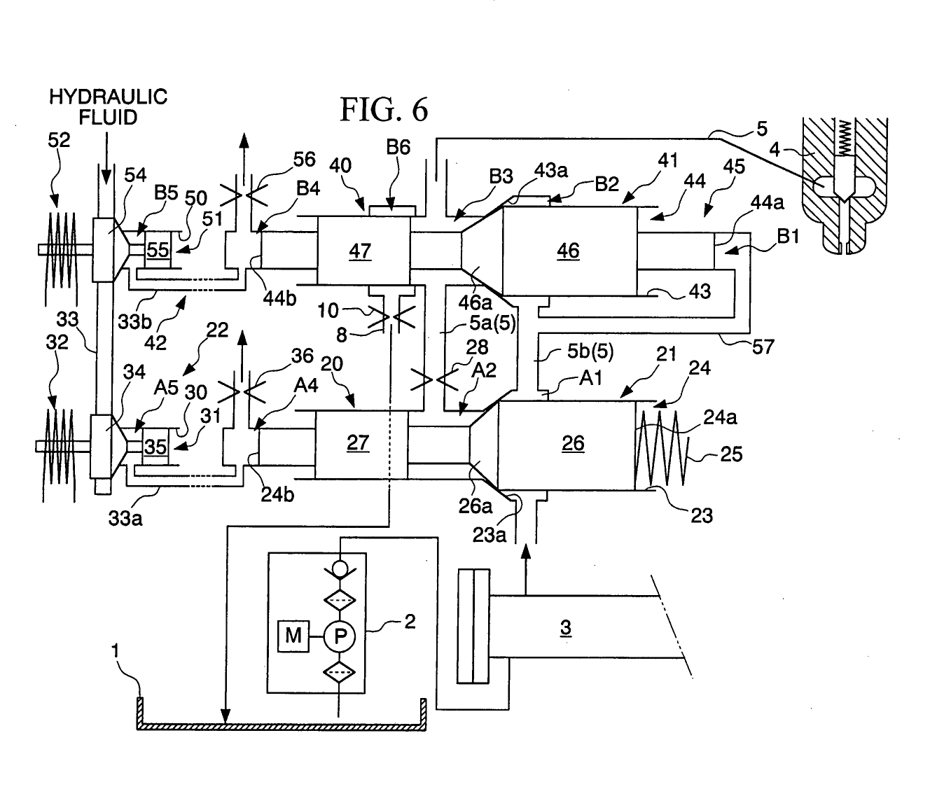

Next, the second embodiment of the fuel injection device according to the present invention and of the diesel engine equipped therewith shown in FIGS. 5 and 6 will be explained. It should be understood that, to structural elements which have already been explained with regard to the first embodiment described above, the same reference symbols are appended, and the explanation thereof will be curtailed.

In this embodiment, the fuel flow amount when the electromagnetic valves 6 and 7 are opened is set to be the same as in the first embodiment (smaller for the electromagnetic valve 6 and larger for the electromagnetic valve 7), but, as shown in FIG. 5, a two way valve is used for the electromagnetic valve 6, while a three way valve is used for the electromagnetic valve 7. And a drain conduit 8 is connected to the electromagnetic valve 7, and a drain pan 9 which receives the surplus fuel is provided at its end. A constriction 10 is provided in the drain conduit 8 and keeps the flow amount of the fuel in which leftover pressure has been engendered small.

The operational stroke of the fuel injection device structured as has been described above, when the diesel engine to which it is fitted is operated, will now be explained.

For the electromagnetic valves 6 and 7, the same fuel injection rate is implemented, in exactly the same manner as in the above described first preferred embodiment. Furthermore, the fuel which remains in the supply conduit 5 on the fuel injection valve 4 side in which leftover pressure has been engendered is vented through the drain conduit 8 which is provided to the electromagnetic valve 7, and is collected in the drain pan 9.

However although, in the state in which only the electromagnetic valve 6 is opened, it may be considered that the fuel whose pressure has been raised may flow in reverse to the electromagnetic valve 7 to be ejected outside the system from the drain conduit 8, since the constriction 10 is provided in the drain conduit 8, the flow amount of the fuel which is being vented through the drain conduit 8 is kept low, so that the amount of fuel supplied to the fuel injection valve 4 experiences almost no influence therefrom.

In this embodiment as well, in the period of fuel injection per one injection stroke, the fuel injection rate in the first half is kept low, while the file injection rate in the second half is increased (the change of the fuel injection rate per one injection stroke is the same as in FIG. 3).

Furthermore, in this embodiment as well, the same results can be obtained if the electromagnetic valves 6 and 7 are replaced by hydraulic pressure operated valves 20 and 40. FIG. 6 is a figure which shows the overall structure of a fuel injection device in which the electromagnetic valves of FIG. 5 have each been replaced by a hydraulic pressure operated valve. It should be understood that, in the following, only the structural elements which are different from the hydraulic pressure operated valves shown in FIG. 4 will be explained, while, for structural elements which have already been explained, the explanation will be curtailed.

No space A3 which communicates the drain conduit to the drain conduit 8 is provided to the cylinder portion 23 of the hydraulic pressure operated valve 20, but a space B6 interposed between the spaces B3 and B4 is provided to the cylinder portion 43 of the hydraulic pressure operated valve 40, and the drain conduit 8 is connected to this space B6. And the operation of opening and closing the drain conduit 8 which is disposed between the spaces B3 and B6 and communicates/intercepts both the spaces is provided to the second valve body 47 which is provided on the control piston 44.

The operational stroke of the fuel injection device structured as has been described above will now be explained.

When the diesel engine enters upon its fuel injection stroke, the hydraulic pressure operated valves 20 and 40 together start operation from their closed states, with the hydraulic pressure operated valve 20 starting its operation first. First, the electromagnetic drive section 32 operates and the control piston 31 shifts in the one direction (the leftwards direction as seen looking at the drawing paper), and the third valve body 34 opens and the hydraulic fluid flows into the space A5, and furthermore flows into the space A4 via the hydraulic fluid conduit 33a. When the hydraulic fluid flows into the space A4, the control piston 24 which experiences the pressure of the hydraulic fluid shifts in the other direction (the rightward direction as seen looking at the drawing paper), and the first valve body 26 opens, so that fuel is supplied from the pressure accumulator 3 via the spaces A1 and A2, the supply conduit 5a, and the space B3 to the fuel injection valve 4. It should be understood that the fuel injection rate at this time is kept low by the operation of the constriction 28.

Next, the hydraulic pressure operated valve 40 starts its operation. First, the electromagnetic drive section 52 operates and the control piston 51 shifts in the one direction, so that the third valve body 54 opens and the hydraulic fluid flows in to the space B5, and furthermore flows in to the space B4 via the hydraulic fluid supply conduit 33b. When the hydraulic fluid flows in to the space B4, the control piston 44 which experiences the pressure of the hydraulic fluid shifts in the other direction and the first valve body 46 opens, so that, along with the first valve body 46 opening, the second valve body 47 closes the drain conduit 8, and fuel is supplied from the pressure accumulator 3 via the space A1, the supply conduit 5b, the spaces B2 and B3, and the supply conduit 5 to the fuel injection valve 4. Since at this time the fuel injection rate does not suffer the operation of the constriction 28, it is higher than in the first half of the stroke.

When the fuel injection stroke is terminated, the hydraulic pressure operated valves 20 and 40 close at the same time. The operation of the electromagnetic drive sections 32 and 52 is cancelled at the same time, and, in the hydraulic pressure operated valve 20, the control piston 31 shifts in the other direction, so that the third valve body 34 closes and the supply of hydraulic fluid to the space A5 and also to the space A4 is cut off. When the supply of hydraulic fluid to the space A4 is cut off, the hydraulic fluid is vented from the space A4 via the constriction 36, and the biasing force upon the control piston 24 due to the hydraulic fluid is cancelled. When the biasing force due to the hydraulic fluid is cancelled, the control piston 24 receives the biasing force of the return spring 25 and shifts in the one direction, so that the first valve body 26 closes and the fuel supply via the supply conduit 5a is cut off.

At the same time, in the hydraulic pressure operated valve 40, the control piston 51 shifts in the other direction, so that the third valve body 54 closes and the supply of hydraulic fluid to the space B5 and also to the space B4 is cut off. When the supply of hydraulic fluid to the space B4 is cut off, the hydraulic fluid is vented from the space B4 via the constriction 56, and the biasing force upon the control piston 44 due to the hydraulic fluid is cancelled. When the biasing force due to the hydraulic fluid is cancelled, the control piston 44 receives the biasing force of the return mechanism 45 and shifts in the one direction, so that, along with the second valve body 47 opening the drain conduit 8, the first valve body 46 closes and the fuel supply to the fuel injection valve 4 is completely cut off.

When the hydraulic pressure operated valves 20 and 40 close, the fuel remaining in the supply conduit 5 on the fuel injection valve 4 side in which leftover pressure has been engendered is vented via the spaces B3 and B6 and the drain conduit 8, and is collected in the fuel tank 1.

In this manner, with the fuel injection device of FIG. 6 in which the hydraulic pressure operated valves 20 and 40 have been used instead of electromagnetic valves as well, in the period of fuel injection per one injection stroke, the fuel injection rate in the first half is kept low, while the fuel injection rate in the second half is increased.

Furthermore since, with the fuel injection device of FIG. 6, it is possible to manage by driving only the hydraulic pressure operated valve 40 when the load is small and it is acceptable to implement an almost constant injection rate over the entire period of fuel injection, accordingly the reliability of operation is enhanced when the operating state is changed over according to the load.

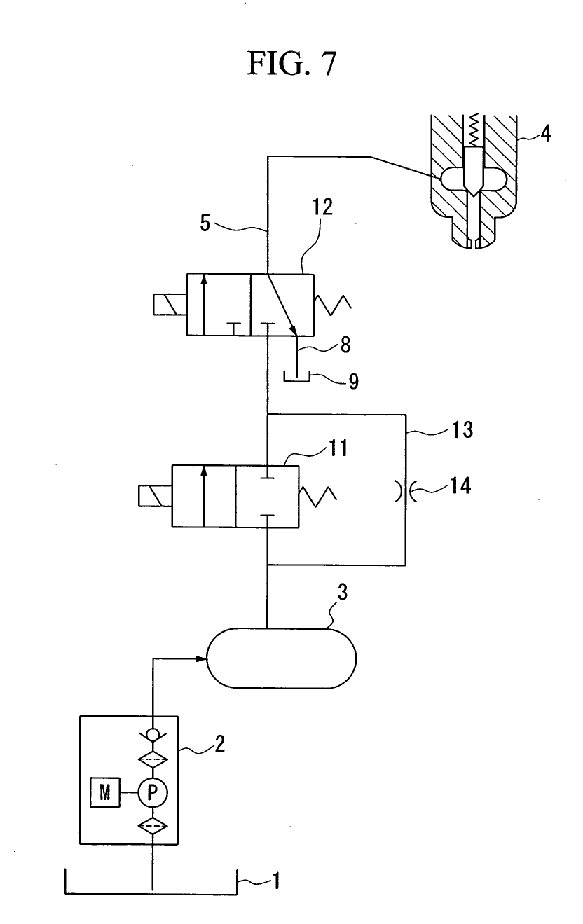

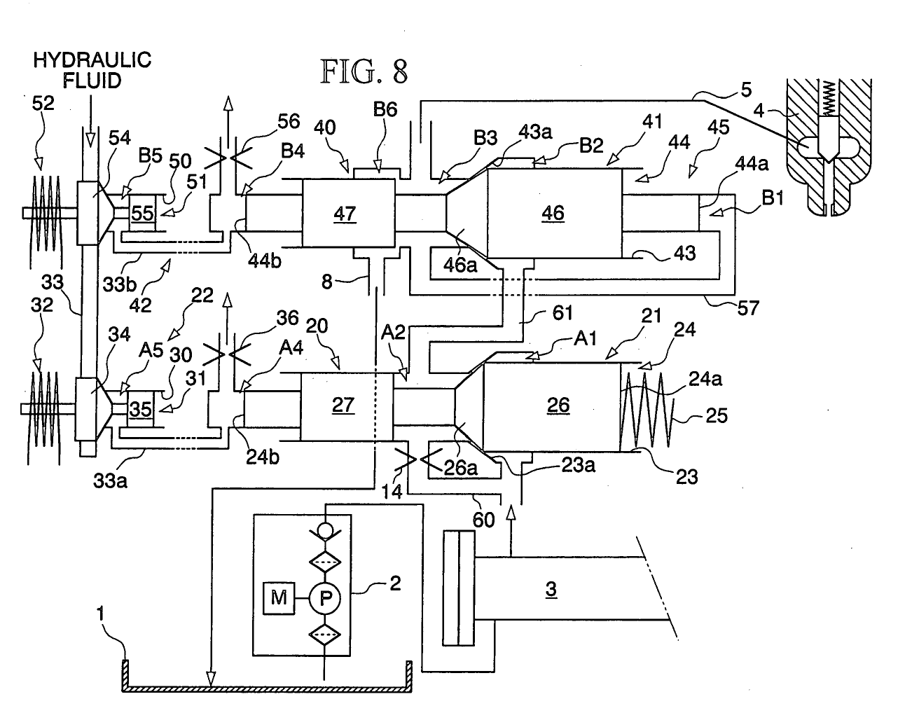

Next, the third embodiment of the fuel injection device according to the present invention and of the diesel engine equipped therewith shown in FIGS. 7 and 8 will be explained. It should be understood that, to structural elements which have already been explained with regard to the embodiments described above, the same reference symbols are appended, and the explanation thereof will be curtailed. In this embodiment, as shown in FIG. 7, two electromagnetic valves 11 and 12 are connected in series in the supply conduit 5 as a valve apparatus which interrupts the fuel supply to the fuel injection valve. For these two electromagnetic valves 11 and 12, components are used whose fuel flow amount when opened is the same.

Furthermore, a two way valve is used for the electromagnetic valve 11 which is provided towards the pressure accumulator 3, while a three way valve is used for the electromagnetic valve 12 which is provided towards the fuel injection valve 4. And a drain conduit 8 is connected to the electromagnetic valve 12, and a drain pan 9 which receives the surplus fuel is provided at its end.

Yet further, a bypass conduit 13 which conducts fuel to bypass the electromagnetic valve 11 is provided in the supply conduit, and partway along it there is provided a constriction 14.

The operational stroke of the fuel injection device structured as has been described above, when the diesel engine to which it is fitted is operated, will now be explained.

When the diesel engine enters upon its fuel injection stroke, from the state in which the electromagnetic valves 11 and 12 are both closed, the electromagnetic valve 12 opens first, and the fuel which has accumulated in the pressure accumulator 3 is supplied to the fuel injection valve 4 via the bypass conduit 13 and the electromagnetic valve 12. At this time, the amount of fuel which is initially supplied to the fuel injection valve is kept low, since the constriction 14 is provided in the bypass conduit 13.

Next, the electromagnetic valve 11 opens after a predetermined time period from the opening of the electromagnetic valve 12, and the fuel which has accumulated in the pressure accumulator 3 is supplied to the fuel injection valve 4 via the electromagnetic valves 11 and 12 without experiencing any operation of the constriction 14. When the fuel injection stroke is terminated, the electromagnetic valves 11 and 12 close at the same time. When the electromagnetic valves 11 and 12 close, the fuel which remains in the supply conduit 5 on the fuel injection valve 4 side and in which leftover pressure has been engendered is vented via the drain conduit 8 which is provided to the electromagnetic valve 12, and is collected in the drain pan 9.

In this embodiment as well, in the period of fuel injection per one injection stroke, the fuel injection rate in the first half is kept low, while the fuel injection rate in the second half is increased (the change of fuel injection rate per one injection stroke becomes the same as in FIG. 3).

Furthermore, in this embodiment as well, the same results can be obtained if the electromagnetic valves 11 and 12 are replaced by hydraulic pressure operated valves 20 and 40. In FIG. 8, there is shown the construction of a fuel injection device in which the electromagnetic valves 11 and 12 have respectively been replaced by hydraulic pressure operated valves 20 and 40. It should be understood that, in the following, only the structural elements which are different from the hydraulic pressure operated valves shown in FIG. 6 will be explained, while, for structural elements which have already been explained, the explanation will be curtailed.

A bypass 60 which directly leads the fuel in the pressure accumulator 3 to the space A2 without going via the main valve 21 is provided in the cylinder portion 23 of the hydraulic pressure operated valve 20, and a constriction 14 is provided in this bypass 60. Furthermore, no supply conduits 5a and 5b are provided, and a supply conduit 61 is provided which supplies fuel from the space A2 on the side of the hydraulic pressure operated valve 40 to the space B3 on the side of the hydraulic pressure operated valve 40 (the path which is made up from the bypass 60, the space A2, and the supply conduit 61 constitutes the bypass conduit 13 shown in FIG. 7). Yet further, a pressure introduction conduit 57 branches off from the space B3 and is connected to the space B1.

The operational stroke of the fuel injection device structured as has been described above will now be explained.

With the fuel injection device of FIG. 8, the duty of the hydraulic pressure operated valves 20 and 40 is interchanged, and the hydraulic pressure operated valve 40 whose fuel flow amount is set by the action of the constriction 28 to be the smaller operates first, and next it is arranged for the hydraulic pressure operated valve 20 to operate.

When the diesel engine enters upon its fuel injection stroke, from the state in which the hydraulic pressure operated valves 20 and 40 are both closed, the hydraulic pressure operated valve 20 starts its operation first. First, the electromagnetic drive section 52 operates and the control piston 51 shifts in the one direction (the leftwards direction as seen looking at the drawing paper), and the third valve body 54 opens and the hydraulic fluid flows into the space B5, and furthermore flows into the space B4 via the hydraulic fluid conduit 33b. When the hydraulic fluid flows into the space B4, the control piston 44 which experiences the pressure of the hydraulic fluid shifts in the other direction (the rightward direction as seen looking at the drawing paper), and, along with the first valve body 46 opening, the second valve body 47 closes the drain conduit 8, so that fuel is supplied from the pressure accumulator 3 via the bypass 60, the space A2, the supply conduit 61, and the spaces B1 and B2 to the fuel injection valve 4. It should be understood that the fuel injection rate at this time is kept low by the operation of the constriction 14.

Next, the hydraulic pressure operated valve 20 starts its operation. First, the electromagnetic drive section 32 operates and the control piston 31 shifts in the one direction, so that the third valve body 34 opens and the hydraulic fluid flows in to the space A5, and furthermore flows in to the space A4 via the hydraulic fluid supply conduit 33a. When the hydraulic fluid flows in to the space A4, the control piston 24 which experiences the pressure of the hydraulic fluid shifts in the other direction and the first valve body 26 opens, so that fuel is supplied from the pressure accumulator 3 to the fuel injection valve 4 via the spaces A1 and A2, the supply conduit 61, and the spaces B2 and B3. Since the fuel injection rate at this time does not experience the effect of the constriction 14, it is higher than in the first half of the stroke.

When the fuel injection stroke is terminated, the hydraulic pressure operated valves 20 and 40 close at the same time. The operation of the electromagnetic drive sections 32 and 52 is cancelled at the same time, and, in the hydraulic pressure operated valve 20, the control piston 31 shifts in the other direction, so that the third valve body 34 closes and the supply of hydraulic fluid to the space A5 and also to the space A4 is cut off. When the supply of hydraulic fluid to the space A4 is cut off, the hydraulic fluid is vented from the space A4 via the constriction 36, and the biasing force upon the control piston 24 due to the hydraulic fluid is cancelled. When the biasing force due to the hydraulic fluid is cancelled, the control piston 24 receives the biasing force of the return spring 25 and shifts in the one direction, so that the first valve body 26 closes and the fuel supply via the space A1 is cut off.

At the same time, in the hydraulic pressure operated valve 40, the control piston 51 shifts in the other direction, so that the third valve body 54 closes and the supply of hydraulic fluid to the space B5 and also to the space B4 is cut off. When the supply of hydraulic fluid to the space B4 is cut off, the hydraulic fluid is vented from the space B4 via the constriction 56, and the biasing force upon the control piston 44 due to the hydraulic fluid is cancelled. When the biasing force due to the hydraulic fluid is cancelled, the control piston 44 receives the biasing force of the return mechanism 45 and shifts in the one direction, so that, along with the first valve body 46 closing, the second valve body 47 opens the drain conduit 8, and the fuel supply to the fuel injection valve 4 is completely cut off.

When the hydraulic pressure operated valves 20 and 40 close, the fuel remaining in the supply conduit 5 on the fuel injection valve 4 side in which leftover pressure has been engendered is vented via the spaces B3 and B6 and the drain conduit 8, and is collected in the fuel tank 1.

In this manner, even with the fuel injection device of FIG. 8 in which the hydraulic pressure operated valves 20 and 40 have been used instead of electromagnetic valves, in the period of fuel injection per one injection stroke, the fuel injection rate in the first half is kept low, while the fuel injection rate in the second half is increased.

Furthermore since, with the fuel injection device of FIG. 8, the end of fuel injection is determined only by the closing operation of the hydraulic pressure operated valve 20, therefore it is not necessary to set the timing of the closing of the hydraulic pressure operated valve 40 very strictly, so that the control becomes simplified. Yet further, the design also becomes easy, since the end of fuel injection is determined by the contacting between the squeezed diameter portion 23a and the seat portion 26a.

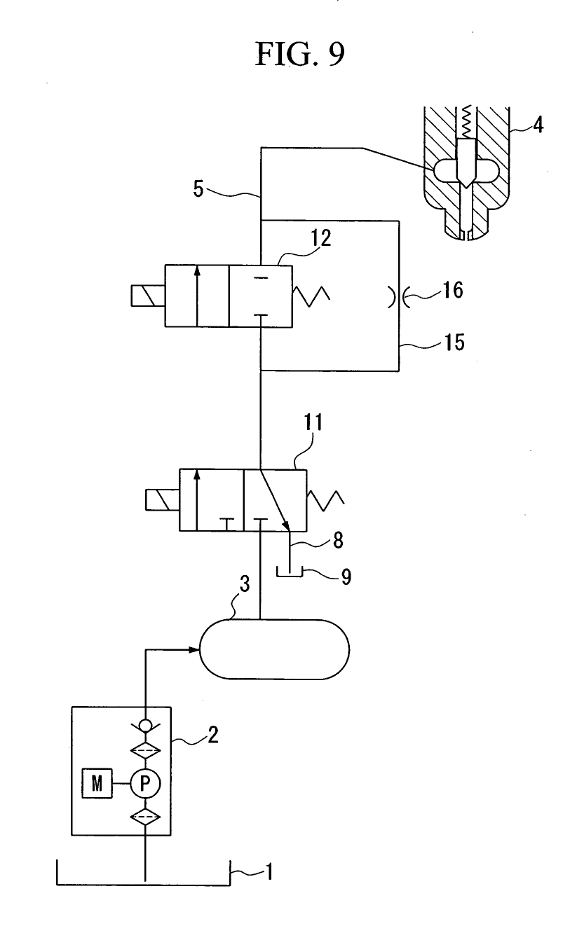

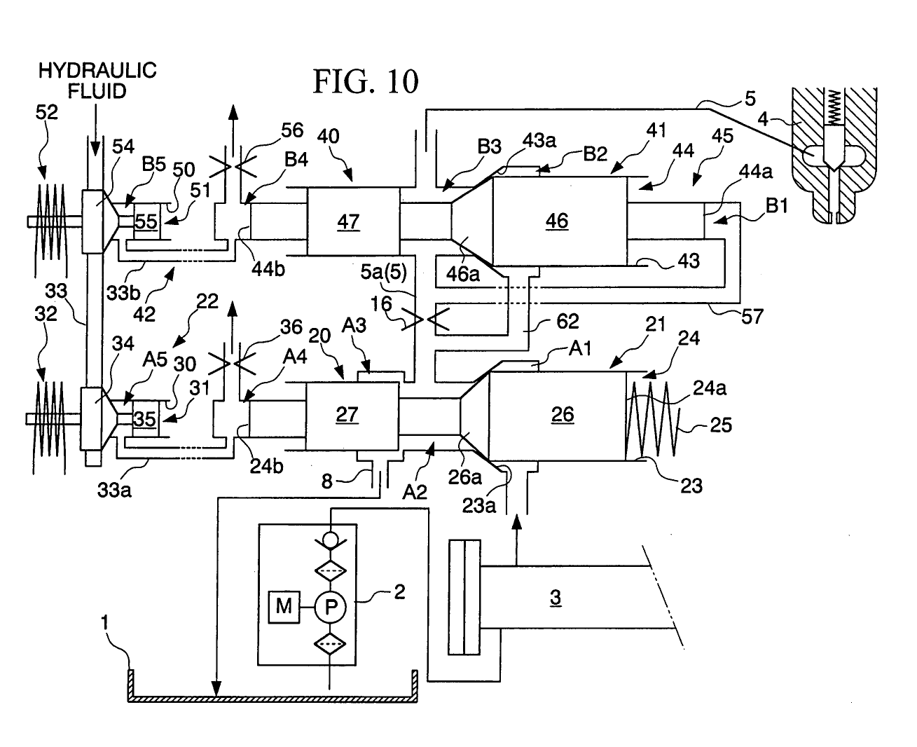

Next, the fourth embodiment of the fuel injection device according to the present invention and of the diesel engine equipped therewith shown in FIGS. 9 and 10 will be explained. It should be understood that, to structural elements which have already been explained with regard to the embodiments described above, the same reference symbols are appended, and the explanation thereof will be curtailed.

In this embodiment, the fuel flow amount when the electromagnetic valves 11 and 12 are opened is set to be the same as in the third embodiment, but, as shown in FIG. 9, a three way valve is used for the electromagnetic valve 11 which is provided on the side of the pressure accumulator 3, while a two way valve is used for the electromagnetic valve 12 which is provided on the side of the fuel injection valve 4. And a drain conduit 8 is connected to the electromagnetic valve 11, and a drain pan 9 which receives the surplus fuel is provided at its end.

Furthermore, a bypass conduit 15 which conducts fuel to bypass the electromagnetic valve 12 is provided to the supply conduit 5, and a constriction 16 is provided partway along it.

The operational stroke of the fuel injection device structured as has been described above, when the diesel engine to which it is fitted is operated, will now be explained.

When the diesel engine enters upon its fuel injection stroke, from the state in which the electromagnetic valves 11 and 12 are both closed, the electromagnetic valve 11 opens first, and the fuel which has been accumulated in the pressure accumulator 3 is supplied to the fuel injection valve 4 via the bypass conduit 15. At this time, since the constriction 16 is provided in the bypass conduit 15, the fuel which is supplied to the fuel injection valve 4 is kept to a low amount at first.

Next, the electromagnetic valve 11 opens after a predetermined time period from the opening of the electromagnetic valve 12, and the fuel which has accumulated in the pressure accumulator 3 is supplied to the fuel injection valve 4 via the electromagnetic valves 11 and 12 without experiencing any operation of the constriction 16. When the fuel injection stroke is terminated, the electromagnetic valves 11 and 12 close at the same time. When the electromagnetic valves 11 and 12 close, the fuel which remains in the supply conduit 5 on the fuel injection valve 4 side and in which leftover pressure has been engendered is vented via the drain conduit 8 which is provided to the electromagnetic valve 11, and is collected in the drain pan 9.

In this embodiment as well, in the period of fuel injection per one injection stroke, the fuel injection rate in the first half is kept low, while the fuel injection rate in the second half is increased (the change of fuel injection rate per one injection stroke becomes the same as in FIG. 3).

Furthermore, in this embodiment as well, the same results can be obtained if the electromagnetic valves 11 and 12 are replaced by hydraulic pressure operated valves 20 and 40. In FIG. 10, there is shown the construction of a fuel injection device in which the electromagnetic valves 11 and 12 have respectively been replaced by hydraulic pressure operated valves 20 and 40. It should be understood that, in the following, only the structural elements which are different from the hydraulic pressure operated valves shown in FIG. 4 will be explained, while, for structural elements which have already been explained, the explanation will be curtailed.

No supply conduit 5b which communicates from the pressure accumulator 3 to the spaces A1 and B2 is provided to the cylinder portion 23 of the hydraulic pressure operated valve 20; but there is provided a branch conduit 62 which branches off from the supply conduit 5a and communicates to the space B2 (the bypass conduit 15 which is shown in FIG. 9 is made up from the supply conduit 5a and the space B3). The constriction 16 is provided in the supply conduit 5a. Furthermore, a pressure introduction conduit 57 branches off from the supply conduit 5a and is connected to the space B1.

The operational stroke of the fuel injection device structured as has been described above will now be explained.

When the diesel engine enters upon its fuel injection stroke, from the state in which the hydraulic pressure operated valves 20 and 40 are both closed, the hydraulic pressure operated valve 20 starts its operation first. First, the electromagnetic drive section 32 operates and the control piston 31 shifts in the one direction (the leftwards direction as seen looking at the drawing paper), and the third valve body 34 opens and the hydraulic fluid flows into the space A5, and furthermore flows into the space A4 via the hydraulic fluid conduit 33a. When the hydraulic fluid flows into the space A4, the control piston 24 which experiences the pressure of the hydraulic fluid shifts in the other direction (the rightward direction as seen looking at the drawing paper), and, along with the first valve body 26 opening, the second valve body 27 closes the drain conduit 8, so that fuel is supplied from the pressure accumulator 3 via the spaces A1 and A2, the supply conduit 5a, and the space B3 to the fuel injection valve 4. It should be understood that the fuel injection rate at this time is kept low by the operation of the constriction 16.

Next, the hydraulic pressure operated valve 40 starts its operation. First, the electromagnetic drive section 52 operates and the control piston 51 shifts in the one direction, so that the third valve body 54 opens and the hydraulic fluid flows in to the space B5, and furthermore flows in to the space B4 via the hydraulic fluid supply conduit 33b. When the hydraulic fluid flows in to the space B4, the control piston 44 which experiences the pressure of the hydraulic fluid shifts in the other direction and the first valve body 46 opens, so that fuel is supplied from the pressure accumulator 3 to the fuel injection valve 4 via the branch conduit 62 and the spaces B2 and B3. Since the fuel injection rate at this time does not experience the effect of the constriction 16, it is higher than in the first half of the stroke.

When the fuel injection stroke is terminated, the hydraulic pressure operated valves 20 and 40 close at the same time. The operation of the electromagnetic drive sections 32 and 52 is cancelled at the same time, and, in the hydraulic pressure operated valve 20, the control piston 31 shifts in the other direction, so that the third valve body 34 closes and the supply of hydraulic fluid to the space A5 and also to the space A4 is cut off. When the supply of hydraulic fluid to the space A4 is cut off, the hydraulic fluid is vented from the space A4 via the constriction 36, and the biasing force upon the control piston 24 due to the hydraulic fluid is cancelled. When the biasing force due to the hydraulic fluid is cancelled, the control piston 24 receives the biasing force of the return spring 25 and shifts in the one direction, so that, along with the first valve body 26 closing, the second valve body 27 opens the drain conduit 8, and the fuel supply to the fuel injection valve 4 is completely cut off.

At the same time, in the hydraulic pressure operated valve 40, the control piston 51 shifts in the other direction, so that the third valve body 54 closes and the supply of hydraulic fluid to the space B5 and also to the space B4 is cut off. When the supply of hydraulic fluid to the space B4 is cut off, the hydraulic fluid is vented from the space B4 via the constriction 56, and the biasing force upon the control piston 44 due to the hydraulic fluid is cancelled. When the biasing force due to the hydraulic fluid is cancelled, the control piston 44 receives the biasing force of the return mechanism 45 and shifts in the one direction, so that the first valve body 46 closes.

When the hydraulic pressure operated valves 20 and 40 close, the fuel remaining in the supply conduit 5 on the fuel injection valve 4 side in which leftover pressure has been engendered is vented via the space B3, the supply conduit 5a, the spaces A2 and A3, and the drain conduit 8, and is collected in the fuel tank 1. In this manner, with the fuel injection device of FIG. 10 in which the hydraulic pressure operated valves 20 and 40 have been used instead of electromagnetic valves as well, in the period of fuel injection per one injection stroke, the fuel injection rate in the first half is kept low, while the fuel injection rate in the second half is increased. Furthermore since, with the fuel injection device of FIG. 10, the end of fuel injection is determined only by the closing operation of the hydraulic pressure operated valve 20, therefore it is not necessary to set the timing of the closing of the hydraulic pressure operated valve 40 very strictly, so that the control becomes simplified.

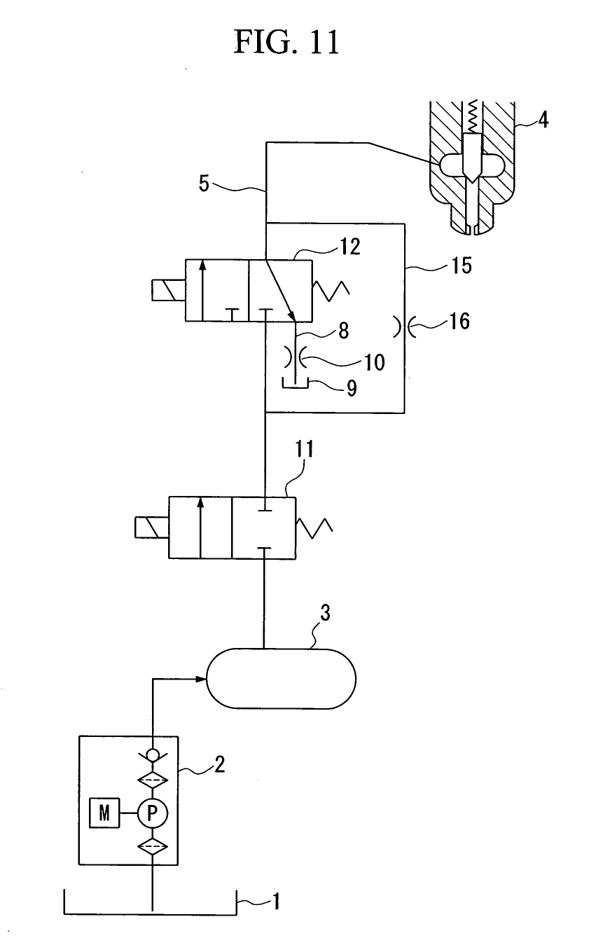

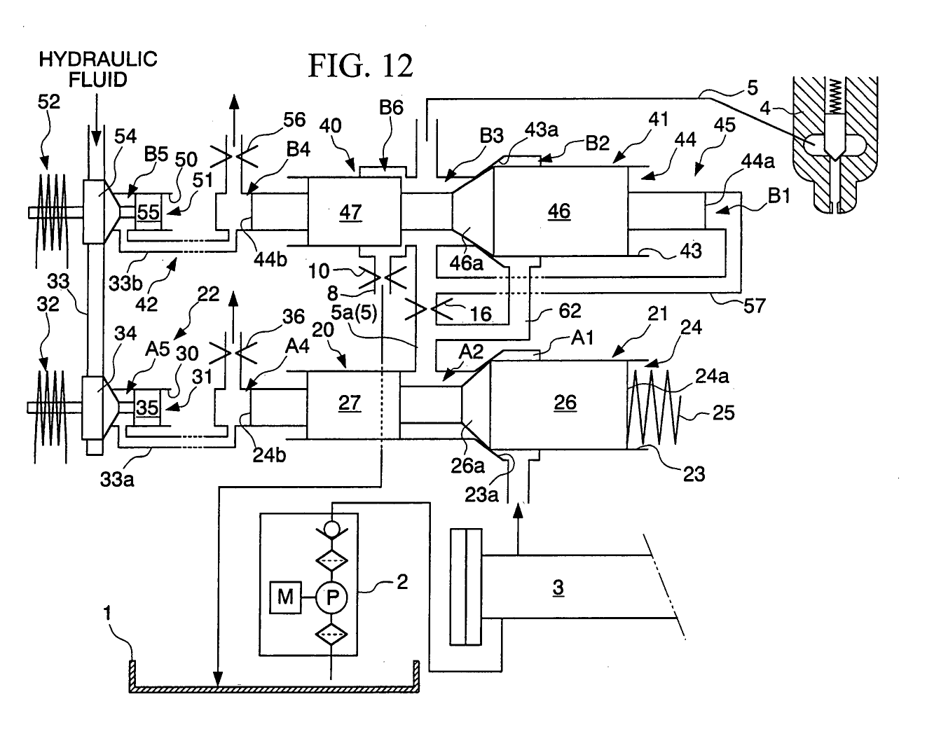

Next, the fifth embodiment of the fuel injection device according to the present invention and of the diesel engine equipped therewith shown in FIGS. 11 and 12 will be explained. It should be understood that, to structural elements which have already been explained with regard to the embodiments described above, the same reference symbols are appended, and the explanation thereof will be curtailed.

In this embodiment, the fuel flow amount when the electromagnetic valves 11 and 12 are opened is set to be the same as in the third and the fourth embodiments, but a two way valve is used for the electromagnetic valve 11 which is provided on the side of the pressure accumulator 3, while a three way valve is used for the electromagnetic valve 12 which is provided on the side of the fuel injection valve 4. And a drain conduit 8 is connected to the electromagnetic valve 12, and a drain pan 9 which receives the surplus fuel is provided at its end. A constriction 10 is provided in the drain conduit 8.

The operational stroke of the fuel injection device structured as has been described above, when the diesel engine to which it is fitted is operated, will now be explained.

With regard to the electromagnetic valves 11 and 12, exactly the same opening and closing operation as in the above described fourth embodiment is performed, and the same fuel injection rate is implemented thereby. And the fuel remaining in the supply conduit 5 on the fuel injection valve 4 side in which leftover pressure has been engendered is vented via the drain conduit 8 which is provided to the electromagnetic valve 12, and is collected in the drain pan 9.

However although, in the state in which only the electromagnetic valve 11 is opened, it may be considered that the fuel whose pressure has been raised may flow in reverse to the electromagnetic valve 12 to be ejected outside the system from the drain conduit 8, since the constriction 10 is provided in the drain conduit 8, the flow amount of the fuel which is being vented through the drain conduit 8 is kept low, so that the amount of fuel supplied to the fuel injection valve 4 experiences almost no influence therefrom.

In this embodiment as well, in the period of fuel injection per one injection stroke, the fuel injection rate in the first half is kept low, while the fuel injection rate in the second half is increased (the change of fuel injection rate per one injection stroke becomes the same as in FIG. 3).

Furthermore, in this embodiment as well, the same results can be obtained if the electromagnetic valves 11 and 12 are replaced by hydraulic pressure operated valves 20 and 40. In FIG. 12, there is shown the construction of a fuel injection device in which the electromagnetic valves 11 and 12 have respectively been replaced by hydraulic pressure operated valves 20 and 40. It should be understood that, in the following, only the structural elements which are different from the hydraulic pressure operated valves shown in FIG. 10 will be explained, while, for structural elements which have already been explained, the explanation will be curtailed.

No space A3 which communicates to the drain conduit 8 is provided to the cylinder portion 23 of the hydraulic pressure operated valve 20, but a space B6 which is interposed between the spaces B3 and B4 is provided to the cylinder portion 43 of the hydraulic pressure operated valve 40. And the second valve body 47 which is provided to the control piston 44 is disposed between the spaces B3 and B6 and is endowed with an action of communicating/intercepting both these spaces so as to open and close the drain conduit 8.

The operational stroke of the fuel injection device structured as has been described above will now be explained.

When the diesel engine enters upon its fuel injection stroke, from the state in which the hydraulic pressure operated valves 20 and 40 are both closed, the hydraulic pressure operated valve 20 starts its operation first. First, the electromagnetic drive section 32 operates and the control piston 31 shifts in the one direction (the leftwards direction as seen looking at the drawing paper), and the third valve body 34 opens and the hydraulic fluid flows into the space A5, and furthermore flows into the space A4 via the hydraulic fluid conduit 33a. When the hydraulic fluid flows into the space A4, the control piston 24 which experiences the pressure of the hydraulic fluid shifts in the other direction (the rightward direction as seen looking at the drawing paper), and the first valve body 26 opens, so that fuel is supplied from the pressure accumulator 3 via the spaces A1 and A2, the supply conduit 5a, and the space B3 to the fuel injection valve 4. It should be understood that the fuel injection rate at this time is kept low by the operation of the constriction 16.

Next, the hydraulic pressure operated valve 40 starts its operation. First, the electromagnetic drive section 52 operates and the control piston 51 shifts in the one direction, so that the third valve body 54 opens and the hydraulic fluid flows in to the space B5, and furthermore flows in to the space B4 via the hydraulic fluid supply conduit 33b. When the hydraulic fluid flows in to the space B4, the control piston 44 which experiences the pressure of the hydraulic fluid shifts in the other direction and, along with the first valve body 46 opening, the second valve body 47 closes the drain conduit 8, so that fuel is supplied from the pressure accumulator 3 to the fuel injection valve 4 via the spaces A1 and A2, the supply conduit 5a, the branch conduit 62, and the spaces B2 and B3. Since the fuel injection rate at this time does not experience the effect of the constriction 16, it is higher than in the first half of the stroke.

When the fuel injection stroke is terminated, the hydraulic pressure operated valves 20 and 40 close at the same time. The operation of the electromagnetic drive sections 32 and 52 is cancelled at the same time, and, in the hydraulic pressure operated valve 20, the control piston 31 shifts in the other direction, so that the third valve body 34 closes and the supply of hydraulic fluid to the space A5 and also to the space A4 is cut off. When the supply of hydraulic fluid to the space A4 is cut off, the hydraulic fluid is vented from the space A4 via the constriction 36, and the biasing force upon the control piston 24 due to the hydraulic fluid is cancelled. When the biasing force due to the hydraulic fluid is cancelled, the control piston 24 receives the biasing force of the return spring 25 and shifts in the one direction, so that the first valve body 26 closes.

At the same time, in the hydraulic pressure operated valve 40, the control piston 51 shifts in the other direction, so that the third valve body 54 closes and the supply of hydraulic fluid to the space B5 and also to the space B4 is cut off. When the supply of hydraulic fluid to the space B4 is cut off, the hydraulic fluid is vented from the space B4 via the constriction 56, and the biasing force upon the control piston 44 upon the control piston 44 due to the hydraulic fluid is cancelled. When the biasing force due to the hydraulic fluid is cancelled, the control piston 44 receives the biasing force of the return mechanism 45 and shifts in the one direction, so that, along with the second valve body 47 opening the drain conduit 8, the first valve body 46 closes and the fuel supply to the fuel injection valve 4 is completely cut off.

When the hydraulic pressure operated valves 20 and 40 close, the fuel remaining in the supply conduit 5 on the fuel injection valve 4 side in which leftover pressure has been engendered is vented from the space B6 via the drain conduit 8, and is collected in the fuel tank 1.

In this manner, even with the fuel injection device of FIG. 12 in which the hydraulic pressure operated valves 20 and 40 have been used instead of electromagnetic valves, in the period of fuel injection per one injection stroke, the fuel injection rate in the first half is kept low, while the fuel injection rate in the second half is increased.

Furthermore since, with the fuel injection device of FIG. 12, when the load is small and it is acceptable to implement an almost constant injection rate over the entire fuel injection period, the system makes do with only the hydraulic pressure operated valve 20 being driven, thereby the reliability of operation when changing over the operating state according to the load is enhanced.

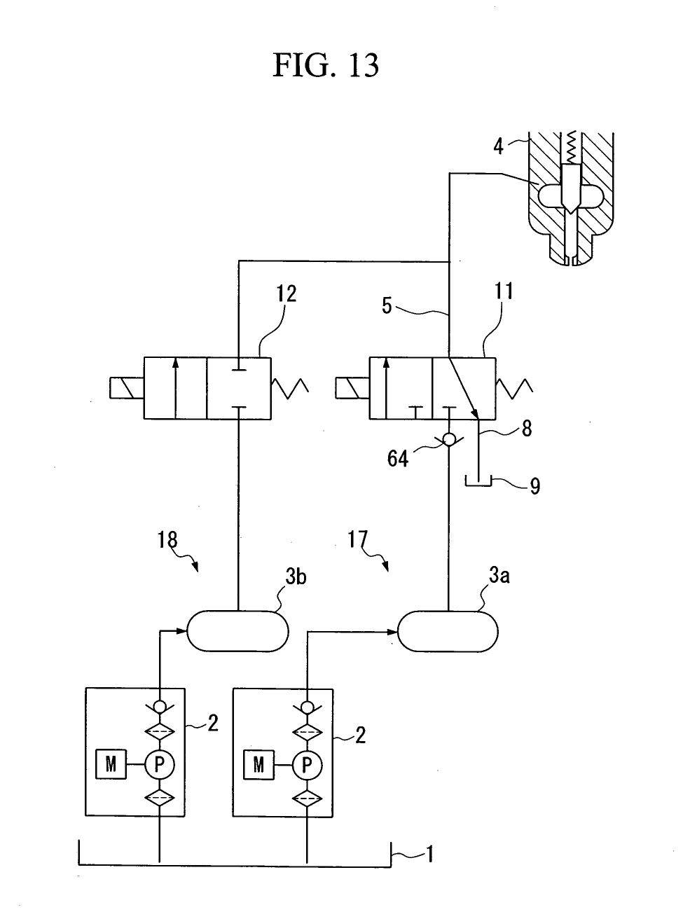

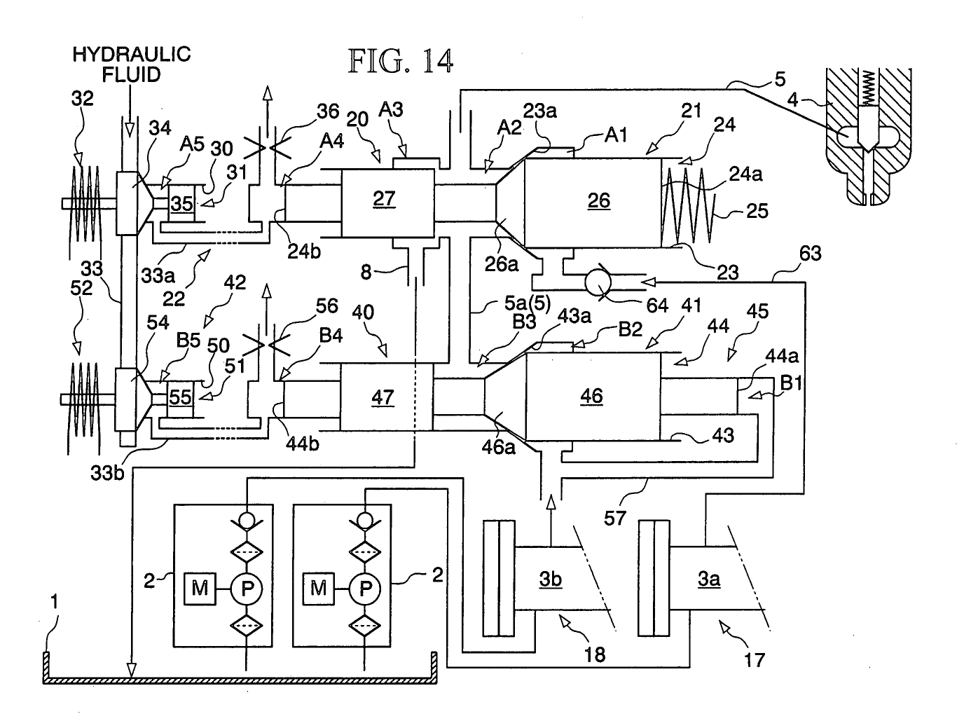

Next, the sixth embodiment of the fuel injection device according to the present invention and of the diesel engine equipped therewith shown in FIGS. 13 and 14 will be explained. It should be understood that, to structural elements which have already been explained with regard to the embodiments described above, the same reference symbols are appended, and the explanation thereof will be curtailed.

In this embodiment, the fuel flow amount when the electromagnetic valves 11 and 12 are opened is set to be the same as in the third, the fourth, and the fifth embodiments, but these two electromagnetic valves 11 and 12 are connected in parallel in the supply conduit 5. A three way valve is used for a one electromagnetic valve (a one valve apparatus) 11, while a two way valve is used for the other electromagnetic valve (the other valve apparatus) 12. And a drain vent tube 8 is connected to the electromagnetic valve 11, and a drain pan 9 which receives the surplus fuel is provided at its end.

Furthermore, to the electromagnetic valves 11 and 12 there are respectively provided independent fuel supply systems 17 and 18. The supply pressure of the fuel supply system 17 which supplies fuel to the electromagnetic valve 11 which operates first, in other words the set pressure of a one pressure accumulator 3a, is set to be lower than the supply pressure of the fuel supply system 18 which supplies fuel to the electromagnetic valve 12 which operates later, in other words the set pressure of an other pressure accumulator 3b; and the fuel flow amount which is supplied to the fuel injection valve 4 via the electromagnetic valve 11 is thus less than the fuel flow amount which is supplied to the fuel injection valve 4 via the electromagnetic valve 12. Furthermore, a reverse prevention valve 64 is provided in the supply conduit 5 between the pressure accumulator 3a and the electromagnetic valve 11, so as to prevent the reverse flow of fuel from the electromagnetic valve 11 to the pressure accumulator 3a.

The operational stroke of the fuel injection device structured as has been described above, when the diesel engine to which it is fitted is operated, will now be explained.

When the diesel engine enters upon its fuel injection stroke, from the state in which the electromagnetic valves 11 and 12 are both closed, the electromagnetic valve 11 starts its operation first, and the fuel which has been accumulated in the pressure accumulator 3a is supplied to the fuel injection valve 4 via the electromagnetic valve 11. At this time, since the set pressure of the pressure accumulator 3a is set to be low, the fuel which is supplied to the fuel injection valve 4 is kept to a low amount at first.

Next, the electromagnetic valve 12 opens after a predetermined time period from the opening of the electromagnetic valve 11, and the fuel which has accumulated in the pressure accumulator 3b is supplied to the fuel injection valve 4 via the electromagnetic valve 12. When the fuel supply starts from the fuel supply system 18, since the pressure of the fuel which is supplied via the electromagnetic valve 11 is set to be lower than the pressure of the fuel which is supplied via the electromagnetic valve 12, although fuel would flow in the reverse direction through the electromagnetic valve 11, since the reverse prevention valve 64 closes and prevents this flow, fuel supply from the fuel supply system 17 is cut off. The fuel injection rate at this time, being proportional to the supply pressure of the fuel supply system 18, is higher than in the first half of the stroke. When the fuel injection stroke is terminated, the electromagnetic valves 11 and 12 close at the same time. When the electromagnetic valves 11 and 12 close, the fuel which remains in the supply conduit 5 on the fuel injection valve 4 side and in which leftover pressure has been engendered is vented via the drain conduit 8 which is provided to the electromagnetic valve 11, and is collected in the drain pan 9.

In this embodiment as well, in the period of fuel injection per one injection stroke, the fuel injection rate in the first half is kept low, while the fuel injection rate in the second half is increased (the change of fuel injection rate per one injection stroke becomes the same as in FIG. 3).

Furthermore, in this embodiment as well, the same results can be obtained if the electromagnetic valves 11 and 12 are replaced by hydraulic pressure operated valves 20 and 40. In FIG. 14, there is shown the construction of a fuel injection device in which the electromagnetic valves 11 and 12 have respectively been replaced by hydraulic pressure operated valves 20 and 40.

In FIG. 14, the hydraulic pressure operated valve 20 is arranged in the upper portion, while the hydraulic pressure operated valve 40 is arranged in the lower portion; and a supply conduit 63 for receiving supply of fuel from the pressure accumulator 3a which constitutes the one fuel supply system 17 is provided to the space A1 of the hydraulic pressure operated valve 20 (the conduit which reaches the fuel injection valve 4 from the pressure accumulator 3a via the supply conduit 63 and the spaces A1 and A2 constitutes a one supply conduit, while the conduit which reaches the fuel injection valve 4 from the pressure accumulator 3b via the spaces B2 and B3, the supply conduit 5a, and the space A2 constitutes an other supply conduit).

The reverse prevention valve 64 which prevents reverse flow of fuel to the pressure accumulator 3a from the space A1 is provided in the supply conduit 63. Furthermore, no supply conduit 5b is provided, while a pressure introduction conduit 57 branches from the space B2 of the hydraulic pressure operated valve 40 and is connected to the space B1.

The operational stroke of the fuel injection device structured as has been described above will now be explained.

When the diesel engine enters upon its fuel injection stroke, from the state in which the hydraulic pressure operated valves 20 and 40 are both closed, the hydraulic pressure operated valve 20 starts its operation first. First, the electromagnetic drive section 32 operates and the control piston 31 shifts in the one direction (the leftwards direction as seen looking at the drawing paper), and the third valve body 34 opens and the hydraulic fluid flows into the space B5, and furthermore flows into the space A4 via the hydraulic fluid conduit 33a. When the hydraulic fluid flows into the space A4, the control piston 24 which experiences the pressure of the hydraulic fluid shifts in the other direction (the rightward direction as seen looking at the drawing paper), and, along with the first valve body 26 opening, the second valve body 27 closes the drain conduit 8, so that fuel is supplied from the pressure accumulator 3a via the supply conduit 63 and the spaces A1 and A2 to the fuel injection valve 4. It should be understood that the fuel injection rate at this time is kept low in proportion to the supply pressure of the fuel supply system 17.

Next, the hydraulic pressure operated valve 40 starts its operation. First, the electromagnetic drive section 52 operates and the control piston 51 shifts in the one direction, so that the third valve body 54 opens and the hydraulic fluid flows in to the space B5, and furthermore flows in to the space B4 via the hydraulic fluid supply conduit 33b. When the hydraulic fluid flows in to the space B4, the control piston 44 which experiences the pressure of the hydraulic fluid shifts in the other direction and the first valve body 46 opens, so that fuel is supplied from the pressure accumulator 3b to the fuel injection valve 4 via the spaces B2 and B3, the supply conduit 5a, and the space A2. Furthermore the reverse prevention valve 64 closes, since the pressure in the interiors of the spaces A1 and A2 is higher than the set pressure of the pressure accumulator 3a, and fuel supply from the fuel supply system 17 is cut off. The fuel injection rate at this time is higher than in the first half of the stroke, in proportion to the supply pressure of the fuel supply system 18.

When the fuel injection stroke is terminated, the hydraulic pressure operated valves 20 and 40 close at the same time. The operation of the electromagnetic drive sections 32 and 52 is cancelled at the same time, and, in the hydraulic pressure operated valve 20, the control piston 31 shifts in the other direction, so that the third valve body 34 closes and the supply of hydraulic fluid to the space A5 and also to the space A4 is cut off. When the supply of hydraulic fluid to the space A4 is cut off, the hydraulic fluid is vented from the space A4 via the constriction 36, and the biasing force upon the control piston 24 due to the hydraulic fluid is cancelled. When the biasing force due to the hydraulic fluid is cancelled, the control piston 24 receives the biasing force of the return spring 25 and shifts in the one direction, so that, along with the first valve body 26 closing, the second valve body 27 opens the drain conduit 8, and the fuel supply via the supply conduit 63 is completely cut off.

At the same time, in the hydraulic pressure operated valve 40, the control piston 51 shifts in the other direction, so that the third valve body 54 closes and the supply of hydraulic fluid to the space B5 and also to the space B4 is cut off. When the supply of hydraulic fluid to the space B4 is cut off, the hydraulic fluid is vented from the space B4 via the constriction 56, and the biasing force upon the control piston 44 due to the hydraulic fluid is cancelled. When the biasing force due to the hydraulic fluid is cancelled, the control piston 44 receives the biasing force of the return mechanism 45 and shifts in the one direction, so that the first valve body 46 closes, and the fuel supply to the fuel injection valve 4 is completely cut off.

When the hydraulic pressure operated valves 20 and 40 close, the fuel remaining in the supply conduit 5 on the fuel injection valve 4 side in which leftover pressure has been engendered is vented via the spaces A2 and A3 and the drain conduit 8, and is collected in the fuel tank 1.

In this manner, even with the fuel injection device of FIG. 14 in which the hydraulic pressure operated valves 20 and 40 have been used instead of electromagnetic valves, in the period of fuel injection per one injection stroke, the fuel injection rate in the first half is kept low, while the fuel injection rate in the second half is increased.

Furthermore since, with the fuel injection device of FIG. 14, the two fuel supply systems 17 and 18 are provided, and it is arranged for them to be respectively endowed with separate duties of fuel supply during the first half and the second half of the stroke, so that it is possible to adjust the fuel injection rate as desired by changing the fuel supply pressures, therefore it becomes possible accurately to set them in either the first half or the second half of the stroke.

It should be understood that although, in this embodiment, the fuel supply systems 17 and 18 are both constructed-identically, it would be possible to simplify the construction by providing a single fuel pump 2, if it were arranged to conduct fuel from the pressure accumulator 3b whose pressure is the higher to the pressure accumulator 3a whose pressure is the lower via a pressure reduction valve.

Furthermore although, in this embodiment, control was performed so that first the hydraulic pressure operated valve 20 opened, next the hydraulic pressure operated valve 40 opened, and finally a single fuel injection stroke terminated by the hydraulic pressure operated valves 20 and 40 closing at the same time, it would also be acceptable for control to be performed by the hydraulic pressure operated valve 20 opening first, next the hydraulic pressure operated valve 20 closing and at the same time the hydraulic pressure operated valve 40 opening, and finally a single fuel injection stroke being terminated by the hydraulic pressure operated valve 40 closing.

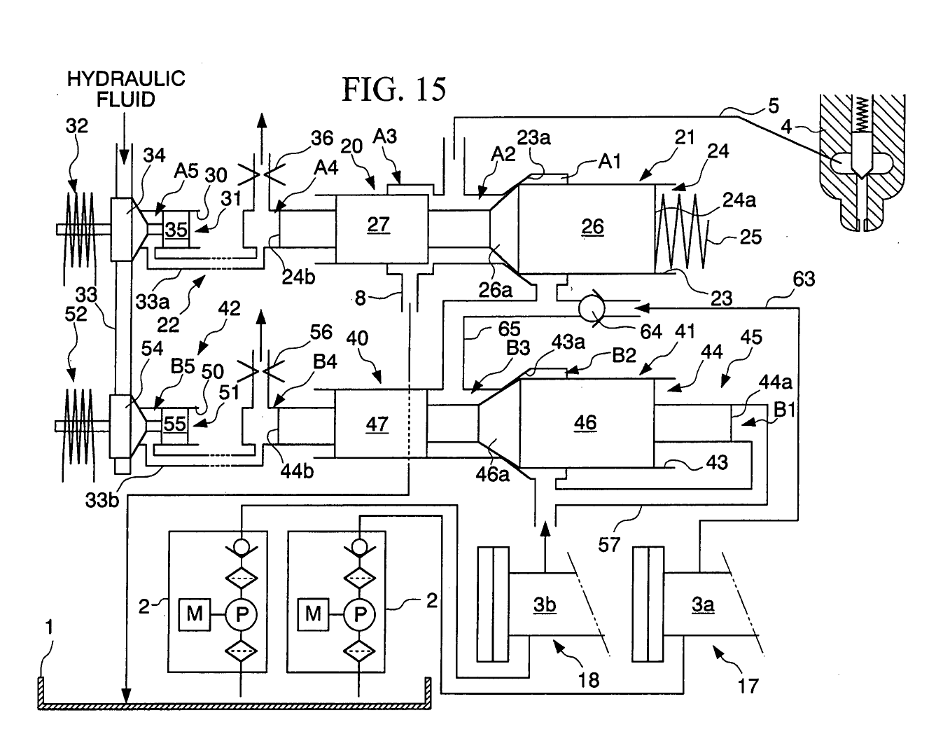

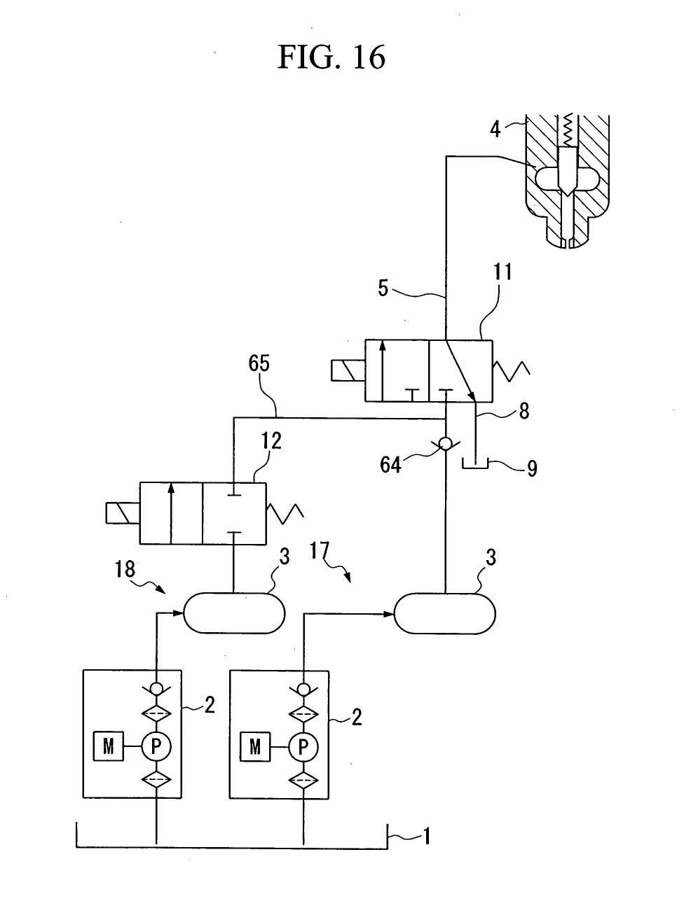

Next, the seventh embodiment of the fuel injection device according to the present invention and of the diesel engine equipped therewith shown in FIGS. 15 and 16 will be explained. It should be understood that, to structural elements which have already been explained with regard to the embodiments described above, the same reference symbols are appended, and the explanation thereof will be curtailed.

In this embodiment, a supply conduit 65 which supplies fuel from the fuel supply system 18 via the electromagnetic valve 12 is connected to the supply conduit 5 between the pressure accumulator 3a and the electromagnetic valve 11.

The operational stroke of the fuel injection device structured as has been described above, when the diesel engine to which the fuel injection device is equipped is operated, will now be explained.

When the diesel engine enters upon its fuel injection stroke, from the state in which the electromagnetic valves 11 and 12 are both closed, the electromagnetic valve 11 starts its operation first, and the fuel which has been accumulated in the pressure accumulator 3a is supplied to the fuel injection valve 4 via the electromagnetic valve 11. At this time, since the set pressure of the pressure accumulator 3a is set to be low, the fuel which is supplied to the fuel injection valve 4 is kept to a low amount at first.

Next, the electromagnetic valve 12 opens after a predetermined time period from the opening of the electromagnetic valve 11, and the fuel which has accumulated in the pressure accumulator 3b is supplied to the fuel injection valve 4 via the electromagnetic valve 12. When the fuel supply starts from the fuel supply system 18, since the pressure of the fuel which is supplied from the fuel supply system 17a is set to be lower than the pressure of the fuel which is supplied via the electromagnetic valve 12, although fuel would flow in the reverse direction to the pressure accumulator 3a, since the reverse prevention valve 64 closes and prevents this flow, fuel supply from the fuel supply system 17 is cut off. The fuel injection rate at this time, being proportional to the supply pressure of the fuel supply system 18, is higher than in the first half of the stroke. When the fuel injection stroke is terminated, the electromagnetic valves 11 and 12 close at the same time. When the electromagnetic valves 11 and 12 close, the fuel which remains in the supply conduit 5 on the fuel injection valve 4 side and in which leftover pressure has been engendered is vented via the drain conduit 8 which is provided to the electromagnetic valve 11, and is collected in the drain pan 9.

In this embodiment as well, in the period of fuel injection per one injection stroke, the fuel injection rate in the first half is kept low, while the fuel injection rate in the second half is increased (the change of fuel injection rate per one injection stroke becomes the same as in FIG. 3).

Furthermore, in this embodiment as well, the same results can be obtained if the electromagnetic valves 11 and 12 are replaced by hydraulic pressure operated valves 20 and 40. In FIG. 16, there is shown the construction of a fuel injection device in which the electromagnetic valves 11 and 12 have respectively been replaced by hydraulic pressure operated valves 20 and 40.

In the fuel injection device shown in FIG. 16, no supply conduit 5a is provided between the hydraulic pressure operated valves 20 and 40, while a supply conduit 65 is provided which supplies fuel from the space B3 on the hydraulic pressure operated valve 40 side to the space A1 on the hydraulic pressure operated valve 20 side (the conduit which reaches the fuel injection valve 4 from the pressure accumulator 3a via the supply conduit 63 and the spaces A1 and A2 constitutes a one supply conduit, while the conduit which reaches the hydraulic pressure operated valve 40 from the pressure accumulator 3b via the spaces B2 and B3 and the supply conduit 65 constitutes an other supply conduit).

The operational stroke of the fuel injection device structured as has been described above will now be explained.

When the diesel engine enters upon its fuel injection stroke, from the state in which the hydraulic pressure operated valves 20 and 40 are both closed, the hydraulic pressure operated valve 20 starts its operation first. First, the electromagnetic drive section 32 operates and the control piston 31 shifts in the one direction (the leftwards direction as seen looking at the drawing paper), and the third valve body 34 opens and the hydraulic fluid flows into the space B5, and furthermore flows into the space A4 via the hydraulic fluid conduit 33a. When the hydraulic fluid flows into the space A4, the control piston 24 which experiences the pressure of the hydraulic fluid shifts in the other direction (the rightward direction as seen looking at the drawing paper), and, along with the first valve body 26 opening, the second valve body 27 closes the drain conduit 8, so that fuel is supplied from the pressure accumulator 3a via the supply conduit 63 and the spaces A1 and A2 to the fuel injection valve 4. It should be understood that the fuel injection rate at this time is kept low in proportion to the supply pressure of the fuel supply system 17.

Next, the hydraulic pressure operated valve 40 starts its operation. First, the electromagnetic drive section 52 operates and the control piston 51 shifts in the one direction, so that the third valve body 54 opens and the hydraulic fluid flows in to the space B5, and furthermore flows in to the space B4 via the hydraulic fluid supply conduit 33b. When the hydraulic fluid flows in to the space B4, the control piston 44 which experiences the pressure of the hydraulic fluid shifts in the other direction and the first valve body 46 opens, so that fuel is supplied from the pressure accumulator 3b to the fuel injection valve 4 via the spaces B2 and B3, the supply conduit 65, and the spaces A1 and A2. Furthermore the reverse prevention valve 64 closes, since the pressure in the interiors of the spaces A1 and A2 is higher than the supply pressure from the pressure accumulator 3a, and fuel supply from the fuel supply system 17 is cut off. The fuel injection rate at this time is higher than in the first half of the stroke, in proportion to the supply pressure of the fuel supply system 18.

When the fuel injection stroke is terminated, the hydraulic pressure operated valves 20 and 40 close at the same time. The operation of the electromagnetic drive sections 32 and 52 is cancelled at the same time, and, in the hydraulic pressure operated valve 20, the control piston 31 shifts in the other direction, so that the third valve body 34 closes and the supply of hydraulic fluid to the space A5 and also to the space A4 is cut off. When the supply of hydraulic fluid to the space A4 is cut off, the hydraulic fluid is vented from the space A4 via the constriction 36, and the biasing force upon the control piston 24 due to the hydraulic fluid is cancelled. When the biasing force due to the hydraulic fluid is cancelled, the control piston 24 receives the biasing force of the return spring 25 and shifts in the one direction, so that, along with the first valve body 26 closing, the second valve body 27 opens the drain conduit 8, and the fuel supply to the fuel injection valve 4 is completely cut off.

At the same time, in the hydraulic pressure operated valve 40, the control piston 51 shifts in the other direction, so that the third valve body 54 closes and the supply of hydraulic fluid to the space B5 and also to the space B4 is cut off. When the supply of hydraulic fluid to the space B4 is cut off, the hydraulic fluid is vented from the space B4 via the constriction 56, and the biasing force upon the control piston 44 due to the hydraulic fluid is cancelled. When the biasing force due to the hydraulic fluid is cancelled, the control piston 44 receives the biasing force of the return mechanism 45 and shifts in the one direction, so that the first valve body 46 closes.

When the hydraulic pressure operated valves 20 and 40 close, the fuel remaining in the supply conduit 5 on the fuel injection valve 4 side in which leftover pressure has been engendered is vented via the spaces A2 and A3 and the drain conduit 8, and is collected in the fuel tank 1.

In this manner, even with the fuel injection device of FIG. 16 in which the hydraulic pressure operated valves 20 and 40 have been used instead of electromagnetic valves, in the period of fuel injection per one injection stroke, the fuel injection rate in the first half is kept low, while the fuel injection rate in the second half is increased.

It should be understood that, in this embodiment as well, it would be possible to simplify the construction by conducting fuel from the pressure accumulator 3b whose pressure is the higher to the pressure accumulator 3a whose pressure is the lower via a pressure reduction valve.

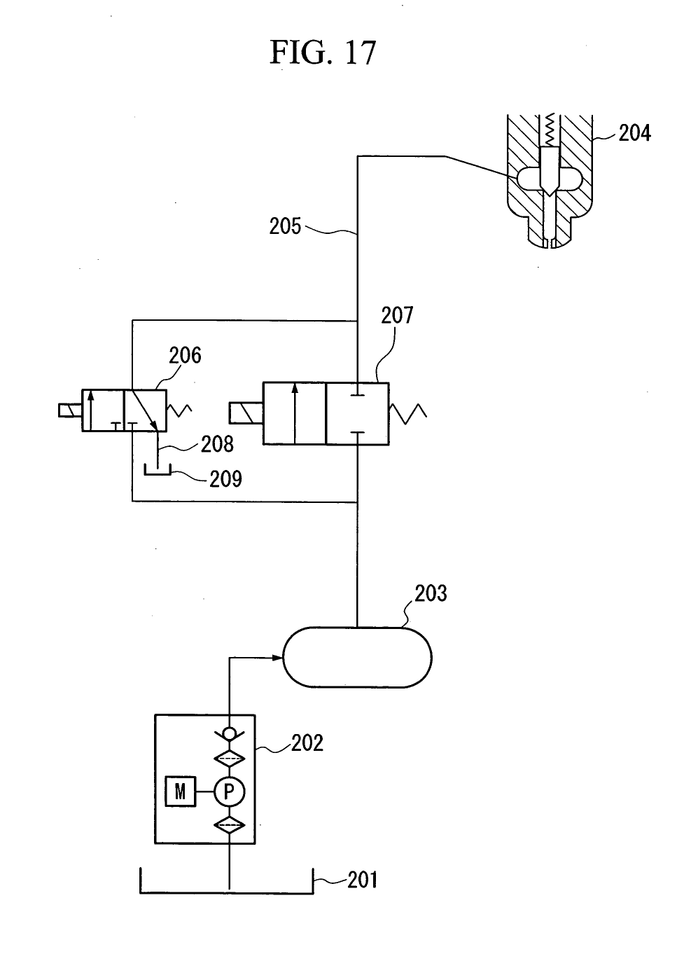

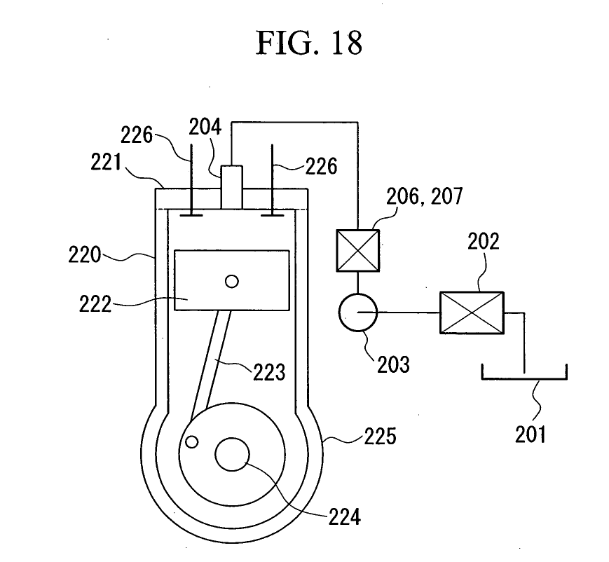

Next, the eighth embodiment of the fuel injection device according to the present invention and of the diesel engine equipped therewith shown in FIGS. 17 and 18 will be explained.

FIG. 17 is a figure which shows the overall structure of the fuel injection device. In the figure, the reference symbol 201 denotes a fuel tank, 202 denotes a fuel pump which pressurizes and supplies fuel, 203 denotes a pressure accumulator which accumulates fuel which has been pressurized and supplied from the fuel pump 202 at a predetermined pressure or at a pressure above it, 204 denotes a fuel injection valve which, by being supplied with pressurized fuel from the pressure accumulator 203, releases and injects this fuel, and 205 denotes a supply conduit which supplies fuel to the fuel injection valve 204 from the pressure accumulator 203.

Two electromagnetic valves 206 and 207 are connected in parallel in the supply conduit 205, as a valve construction which interrupts the fuel supply to the fuel injection valve 204. As the one 206 of the electromagnetic valves, there is used a component for which the fuel flow amount when open is less than that of the other electromagnetic valve 207.

For the electromagnetic valve 206, there is used a three way valve which can select a position which supplies fuel from the pressure accumulator 203 to the fuel injection valve 204, and a position which interrupts the fuel supply to the fuel injection valve 204 and relieves to the outside of the system the leftover pressure which remains at the fuel injection valve 204 side. For the electromagnetic valve 207, there is used a two way valve which can select a position which supplies fuel from the pressure accumulator 203 to the fuel injection valve 204, and a position which interrupts the fuel supply to the fuel injection valve 204.

Furthermore, a drain conduit 208 which vents fuel which remains in the supply conduit 205 on the fuel injection valve 204 side when the position which interrupts the fuel supply to the fuel injection valve 204 has been selected and in which leftover pressure has been engendered is connected to the electromagnetic valve 206, and a drain pan 209 which receives the surplus fuel is provided at its end.

FIG. 18 is a figure which shows the overall structure of a diesel engine of the reciprocating type which is equipped with this fuel injection device. In the figure, the reference symbol 220 denotes a cylinder, 221 denotes a cylinder head, 222 denotes a piston, 223 denotes a piston rod, 224 denotes a crankshaft, 225 denotes a crankcase, and 226 denotes valves. It should be understood that, in this embodiment, the combination of the cylinder 220 and the cylinder head 221 constitutes an engine cylinder.

With the fuel injection device, the fuel injection valve 204 is positioned almost in the middle of the cylinder head 221. Furthermore, the pressure accumulator 203 and the electromagnetic valves 206 and 207 are provided separately at the side of the cylinder 220, and both are connected by a conduit which constitutes the supply conduit 205.

The operational stroke of the fuel injection device constructed as described above, when the diesel engine equipped therewith is operated, will now be explained.

Fuel which has been pressurized by the operation of the fuel pump 202 is normally accumulated in the pressure accumulator 203. The fuel which has been accumulated in this pressure accumulator 203 is injected intermittently from the fuel injection valve 204 by the following type of opening and closing operation of the electromagnetic valves 206 and 207. It should be understood that the pattern of opening and closing operation of the electromagnetic valves 206 and 207 is different according to the magnitude of the load which is imposed upon the diesel engine, and in the following the opening and closing operation which is selected for each magnitude of the load will be explained.

[During High Load]

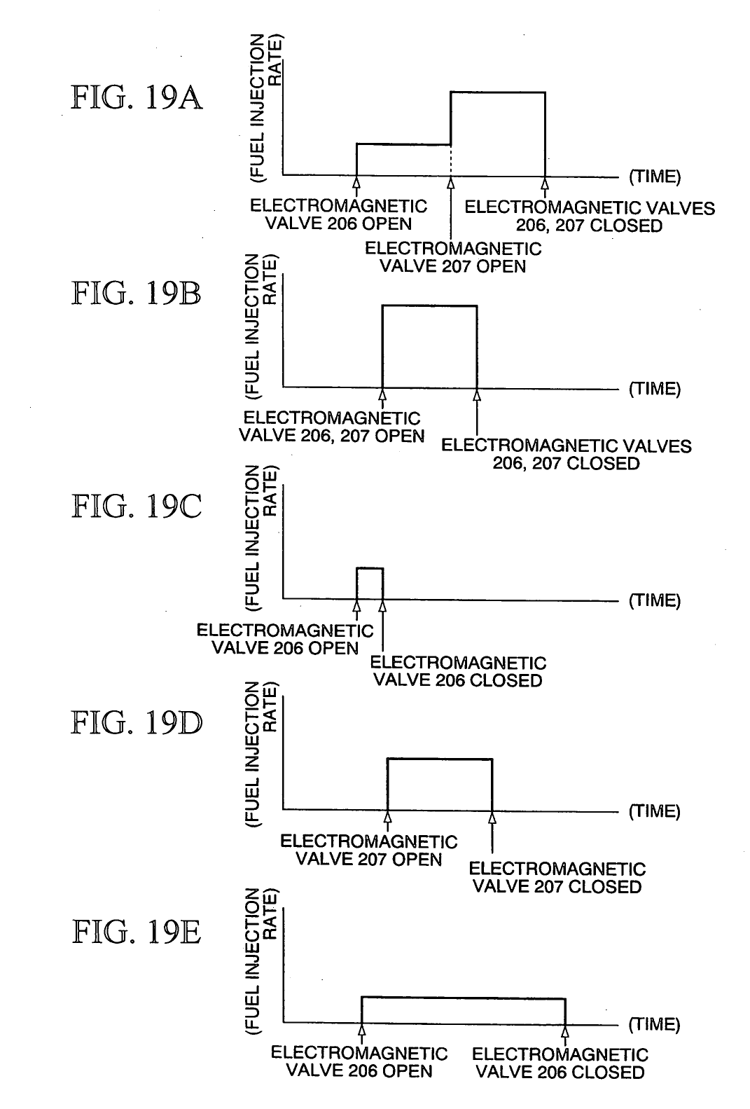

In the case that a high load is imposed upon the diesel engine, when the diesel engine enters its fuel injection stroke, from both the electromagnetic valves 206 and 207 being in the closed state, the electromagnetic valve 206 opens first, and the fuel which has been accumulated in the pressure accumulator 203 is supplied to the fuel injection valve 204 via the electromagnetic valve 206. Next, the electromagnetic valve 207 opens after a predetermined time period from the opening of the electromagnetic valve 206, and the fuel which has been accumulated in the pressure accumulator 203 is supplied to the fuel injection valve 204 via the electromagnetic valves 206 and 207 in parallel. When the fuel injection stroke terminates, the electromagnetic valves 206 and 207 close at the same time. When the electromagnetic valves 206 and 207 close, the fuel which remains in the supply conduit 205 on the fuel injection valve 204 side and in which leftover pressure has been engendered is vented through the drain conduit 208 which is provided to the electromagnetic valve 206, and is collected in the drain pan 209. During high load, the change of fuel injection rate per one injection stroke is as shown in FIG. 19A, and the fuel injection rate in the first half is kept to be low so as to suppress the generation of NOx in the combustion period, while the fuel injection rate is increased in the second half so as to obtain high output power.

[During Medium and Low Load]

In the case that the load which is imposed upon the diesel engine is medium or lower than that, when the diesel engine enters its fuel injection stroke, both the electromagnetic valves 206 and 207 are opened at the same time from the closed state, and the fuel which has been accumulated in the pressure accumulator 203 is supplied to the fuel injection valve 204 via the electromagnetic valves 206 and 207 in parallel. When the fuel injection stroke terminates, the electromagnetic valves 206 and 207 close at the same time. The period of fuel injection is short as compared to the case during high load. When the electromagnetic valves 206 and 207 close, the fuel which remains in the supply conduit 205 on the fuel injection valve 204 side in which leftover pressure has been engendered is vented via the drain conduit 208, and is collected in the drain pan 209. During medium and low load, the change of fuel injection rate per one injection stroke is as shown in FIG. 19B, and, although the fuel injection rate is kept constant and high, since the period of fuel injection is short as compared with the case during high load, a medium output power is obtained. By the electromagnetic valves 6 and 7 opening and closing together, as described above, during medium and low load in which the combustion temperature is lowered so as to reduce the amount of generation of NOx, desirable combustion with little exhaust smoke is implemented.

[During Extremely Low Load]

In the case that an extremely low load is imposed upon the diesel engine as during idling and the like, when the diesel engine enters its fuel injection stroke, from both the electromagnetic valves 206 and 207 being in the closed state, only the electromagnetic valve 206 opens, and the fuel which has been accumulated in the pressure accumulator 203 is supplied to the fuel injection valve 204 via the electromagnetic valve 206. The period of fuel injection is short as compared to the case during medium and low load. When the fuel injection stroke terminates, the electromagnetic valve 206 closes, and the fuel which remains in the supply conduit 205 on the fuel injection valve 204 side and in which leftover pressure has been engendered is vented through the drain conduit 208, and is collected in the drain pan 209. During extremely low load, the change of fuel injection rate per one injection stroke is as shown in FIG. 19C, and, since the fuel injection rate is kept constant and low, and the period of fuel injection is short, the output power which is obtained becomes extremely low. With a valve apparatus such as in the prior art with a large fuel flow amount setting, there is a limit to the responsiveness when implementing a low fuel injection rate, and stabilized fuel injection cannot be obtained, but, by opening and closing only the electromagnetic valve 206 whose fuel flow amount setting is small as described above, a low fuel injection rate is implemented and stabilized combustion is implemented.

With the fuel injection device structured as described above, even if one or the other of the electromagnetic valves 206 and 207 fails and ceases to operate, it is possible to continue without stopping the operation of the diesel engine.

[During Failure of the Electromagnetic Valve 206]

If the electromagnetic valve 206 has failed for some reason and stays in the closed state without operating, when the diesel engine enters its fuel injection stroke, the electromagnetic valve 207 opens, and the fuel which has been accumulated in the pressure accumulator 203 is supplied to the fuel injection valve 204 via the electromagnetic valve 207. The period of fuel injection is adjusted so that the fuel supply amount comes to be matched to the magnitude of the load. When the fuel injection stroke terminates, the electromagnetic valve 207 closes, and the fuel which remains in the supply conduit 205 on the fuel injection valve 204 side and in which leftover pressure has been engendered is vented through the drain conduit 208, and is collected in the drain pan 209. During failure of the electromagnetic valve 206, the change of fuel injection rate per one injection stroke is as shown in FIG. 19D.

[During Failure of the Electromagnetic Valve 207]

If the electromagnetic valve 207 has failed for some reason and stays in the closed state without operating, when the diesel engine enters its fuel injection stroke, the electromagnetic valve 206 opens, and the fuel which has been accumulated in the pressure accumulator 203 is supplied to the fuel injection valve 204 via the electromagnetic valve 206. The period of fuel injection is adjusted so that the fuel supply amount comes to be matched to the magnitude of the load. When the fuel injection stroke terminates, the electromagnetic valve 206 closes, and the fuel which remains in the supply conduit 205 on the fuel injection valve 204 side and in which leftover pressure has been engendered is vented through the drain conduit 208, and is collected in the drain pan 209. During failure of the electromagnetic valve 207, the change of fuel injection rate per one injection stroke is as shown in FIG. 19E.

According to the diesel engine equipped with a fuel injection device structured as described above, the pattern of opening and closing operation of the electromagnetic valves 206 and 207 is varied according to the load, and a fuel injection rate is implemented which is matched to the magnitude of the load. Accordingly, without being influenced by the magnitude of the load, and even while maintaining a desirable rate of fuel consumption, it is possible to reduce the NOx in the exhaust gas, and to implement stabilized operation.

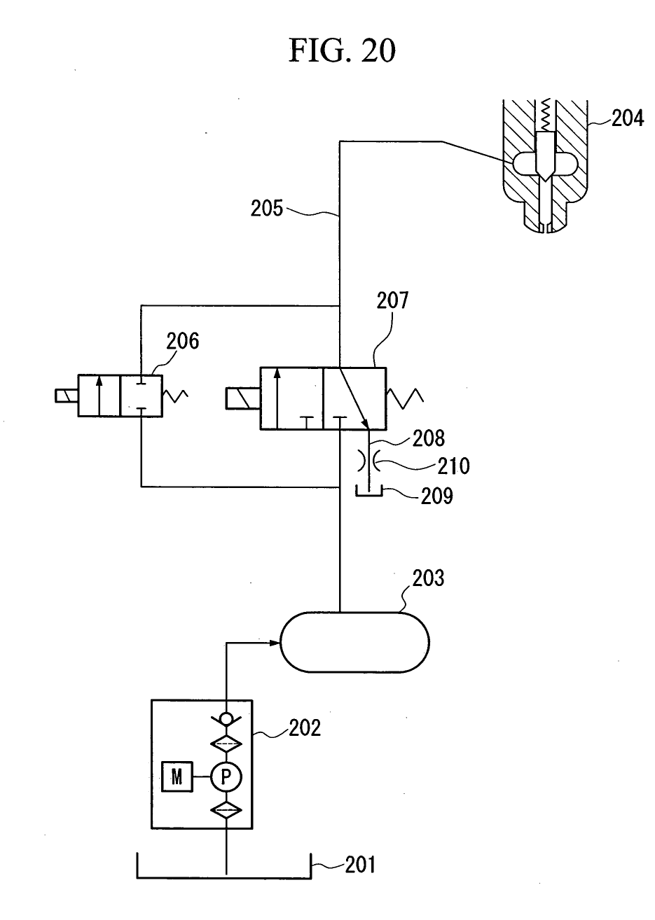

Next, the ninth embodiment of the fuel injection device according to the present invention and of the diesel engine equipped therewith shown in FIG. 20 will be explained. It should be understood that, to structural elements which have already been explained with regard to the eighth embodiment described above, the same reference symbols are appended, and the explanation thereof will be curtailed.

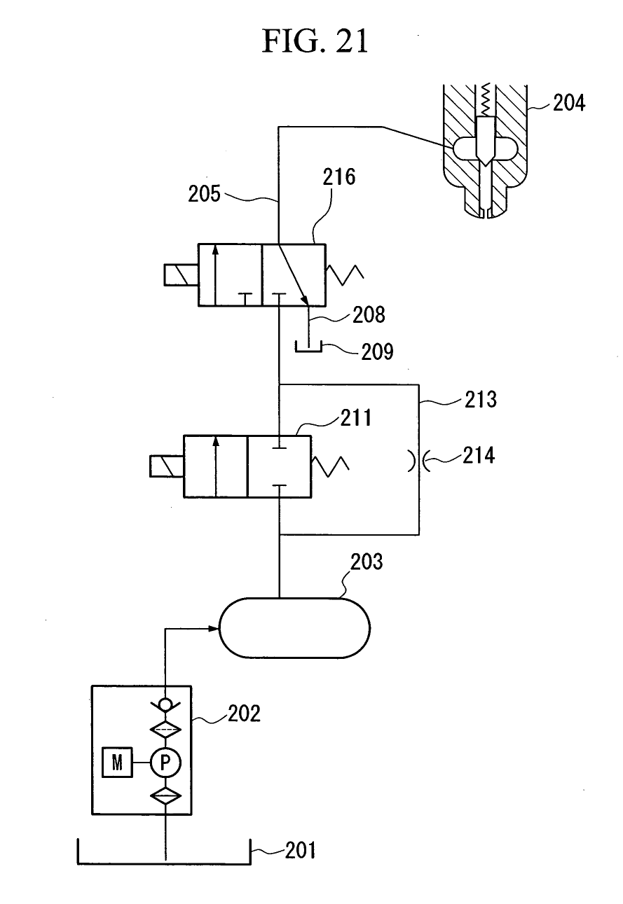

In this embodiment, the fuel flow amount when the electromagnetic valves 206 and 207 are opened is set to be the same as in the eighth embodiment (smaller for the electromagnetic valve 206 and larger for the electromagnetic valve 207), but, as shown in FIG. 21, a two way valve is used for the electromagnetic valve 206, while a three way valve is used for the electromagnetic valve 207. And a drain conduit 208 is connected to the electromagnetic valve 207, and a drain pan 209 which receives the surplus fuel is provided at its end. A constriction 210 is provided in the drain conduit 208 and keeps the flow amount of the fuel in which leftover pressure has been engendered small.

The operational stroke of the fuel injection device structured as has been described above, when the diesel engine to which it is fitted is operated, will now be explained.

[During High Load]

When the diesel engine enters its fuel injection stroke, from both the electromagnetic valves 206 and 207 being in the closed state, the electromagnetic valve 206 opens first, and the fuel which has been accumulated in the pressure accumulator 203 is supplied to the fuel injection valve 204 via the electromagnetic valve 206. Next, the electromagnetic valve 207 opens after a predetermined time period from the opening of the electromagnetic valve 206, and the fuel which has been accumulated in the pressure accumulator 203 is supplied to the fuel injection valve 204 via the electromagnetic valves 206 and 207 in parallel. When the fuel injection stroke terminates, the electromagnetic valves 206 and 207 close at the same time. When the electromagnetic valves 206 and 207 close, the fuel which remains in the supply conduit 205 on the fuel injection valve 204 side and in which leftover pressure has been engendered is vented through the drain conduit 208 which is provided to the electromagnetic valve 207, and is collected in the drain pan 209.

However although, in the state in which only the electromagnetic valve 206 is opened, it might be thought that the fuel whose pressure has been raised would flow in reverse to the electromagnetic valve 207 to be ejected outside the system from the drain conduit 208, since the constriction 210 is provided in the drain conduit 208, the fuel which is being vented via the drain conduit 208 is kept low, so that the amount of fuel supplied to the fuel injection valve 204 experiences almost no influence therefrom (the change of fuel injection rate per one injection stroke is the same as in FIG. 19A).

[During Medium and Low Load]

When the diesel engine enters its fuel injection stroke, both the electromagnetic valves 206 and 207 are opened at the same time from the closed state, and the fuel which has been accumulated in the pressure accumulator 203 is supplied to the fuel injection valve 204 via the electromagnetic valves 206 and 207 in parallel. When the fuel injection stroke terminates, the electromagnetic valves 206 and 207 close at the same time. The period of fuel injection is short as compared to the case during high load. When the electromagnetic valves 206 and 207 close, the fuel which remains in the supply conduit 205 on the fuel injection valve 204 side in which leftover pressure has been engendered is vented via the drain conduit 208, and is collected in the drain pan 209 (the change of fuel injection rate per one injection stroke is the same as in FIG. 19B).

[During Extremely Low Load]

When the diesel engine enters its fuel injection stroke, from both the electromagnetic valves 206 and 207 being in the closed state, only the electromagnetic valve 206 opens, and the fuel which has been accumulated in the pressure accumulator 203 is supplied to the fuel injection valve 204 via the electromagnetic valve 206. The period of fuel injection is even shorter as compared to the case during medium and low load. When the fuel injection stroke terminates, the electromagnetic valve 206 closes, and the fuel which remains in the supply conduit 205 on the fuel injection valve 204 side and in which leftover pressure has been engendered is vented through the drain conduit 208, and is collected in the drain pan 209 (the change of fuel injection rate per one injection stroke is the same as in FIG. 19C). With the fuel injection device structured as described above, even if one or the other of the electromagnetic valves 206 and 207 fails and ceases to operate, it is possible to continue without stopping the operation of the diesel engine.

[During Failure of the Electromagnetic Valve 206]

When the diesel engine enters its fuel injection stroke, the electromagnetic valve 207 opens, and the fuel which has been accumulated in the pressure accumulator 203 is supplied to the fuel injection valve 204 via the electromagnetic valve 207. The period of fuel injection is adjusted so that the fuel supply amount comes to be matched to the magnitude of the load. When the fuel injection stroke terminates, the electromagnetic valve 207 closes, and the fuel which remains in the supply conduit 205 on the fuel injection valve 204 side and in which leftover pressure has been engendered is vented through the drain conduit 208, and is collected in the drain pan 209 (the change of fuel injection rate per one injection stroke is the same as in FIG. 19D).

[During Failure of the Electromagnetic Valve 207]

When the diesel engine enters its fuel injection stroke, the electromagnetic valve 206 opens, and the fuel which has been accumulated in the pressure accumulator 203 is supplied to the fuel injection valve 204 via the electromagnetic valve 206. The period of fuel injection is adjusted so that the fuel supply amount comes to be matched to the magnitude of the load. When the fuel injection stroke terminates, the electromagnetic valve 206 closes, and the fuel which remains in the supply conduit 205 on the fuel injection valve 204 side and in which leftover pressure has been engendered is vented through the drain conduit 208, and is collected in the drain pan 209 (the change of fuel injection rate per one injection stroke is the same as in FIG. 19E).

Since, according to the diesel engine equipped with a fuel injection device structured as described above as well, the pattern of opening and closing operation of the electromagnetic valves 206 and 207 is varied according to the load, and a fuel injection rate is implemented which is matched to the magnitude of the load, accordingly, without being influenced by the magnitude of the load, and even while maintaining a desirable rate of fuel consumption, it is possible to reduce the NOx in the exhaust gas, and to implement stabilized operation.

Next, the tenth embodiment of the fuel injection device according to the present invention and of the diesel engine equipped therewith shown in FIG. 21 will be explained. It should be understood that, to structural elements which have already been explained with regard to the embodiments described above, the same reference symbols are appended, and the explanation thereof will be curtailed.

In this embodiment, as shown in FIG. 21, two electromagnetic valves 211 and 212 are connected in series in the supply conduit 205 as a valve apparatus which interrupts the fuel supply to the fuel injection valve 204. For these two electromagnetic valves 211 and 212, components are utilized whose fuel flow amounts when they are open are equal.

Furthermore, a two way valve is used for the electromagnetic valve 211 which is provided towards the pressure accumulator 203, while a three way valve is used for the electromagnetic valve 212 which is provided towards the fuel injection valve 204. And a drain conduit 208 is connected to the electromagnetic valve 212, and a drain pan 209 which receives the surplus fluid is connected to its end. Furthermore, a bypass conduit 213 which conducts fuel to bypass the electromagnetic valve 211 is provided to the supply conduit 205, and a constriction 214 is provided partway therealong.

The operational stroke of the fuel injection device structured as has been described above, when the diesel engine to which it is fitted is operated, will now be explained.

[During High Load]

When the diesel engine enters its fuel injection stroke, from both the electromagnetic valves 211 and 212 being in the closed state, the electromagnetic valve 212 opens first, and the fuel which has been accumulated in the pressure accumulator 203 is supplied to the fuel injection valve 204 via the bypass conduit 213 and the electromagnetic valve 212. At this time the amount of fuel which is initially supplied to the fuel injection valve 204 is kept low, since the constriction 214 is provided in the bypass conduit 213.

Next, the electromagnetic valve 211 opens after a predetermined time period from the opening of the electromagnetic valve 212, and the fuel which has been accumulated in the pressure accumulator 203 is supplied to the fuel injection valve 204 via the electromagnetic valves 211 and 212, without experiencing any action of the constriction 214. When the fuel injection stroke terminates, the electromagnetic valves 211 and 212 close at the same time. When the electromagnetic valves 211 and 212 close, the fuel which remains in the supply conduit 205 on the fuel injection valve 204 side and in which leftover pressure has been engendered is vented through the drain conduit 208 which is provided to the electromagnetic valve 212, and is collected in the drain pan 209 (the change of fuel injection rate per one injection stroke is the same as in FIG. 19A).

[During Medium and Low Load]

When the diesel engine enters its fuel injection stroke, both the electromagnetic valves 211 and 212 are opened at the same time from the closed state, and the fuel which has been accumulated in the pressure accumulator 203 is supplied to the fuel injection valve 204 via the electromagnetic valves 211 and 212. When the fuel injection stroke terminates, the electromagnetic valves 211 and 212 close at the same time. The period of fuel injection is short as compared to the case during high load. When the electromagnetic valves 211 and 212 close, the fuel which remains in the supply conduit 205 on the fuel injection valve 204 side in which leftover pressure has been engendered is vented via the drain conduit 208, and is collected in the drain pan 209 (the change of fuel injection rate per one injection stroke is the same as in FIG. 19B).

[During Extremely Low Load]

When the diesel engine enters its fuel injection stroke, from both the electromagnetic valves 211 and 212 being in the closed state, only the electromagnetic valve 212 opens, and the fuel which has been accumulated in the pressure accumulator 203 is supplied to the fuel injection valve 204 via the electromagnetic valve 212. The period of fuel injection is even shorter as compared to the case during medium and low load. When the fuel injection stroke terminates, the electromagnetic valve 212 closes, and the fuel which remains in the supply conduit 205 on the fuel injection valve 204 side and in which leftover pressure has been engendered is vented through the drain conduit 208, and is collected in the drain pan 209 (the change of fuel injection rate per one injection stroke is the same as in FIG. 19C).

With the fuel injection device structured as described above, even if one or the other of the electromagnetic valves 211 and 212 fails and ceases to operate, it is possible to continue without stopping the operation of the diesel engine.

[During Failure of the Electromagnetic Valve 211]

When the diesel engine enters its fuel injection stroke, the electromagnetic valve 212 opens, and the fuel which has been accumulated in the pressure accumulator 203 is supplied to the fuel injection valve 204 via the electromagnetic valve 212. The period of fuel injection is adjusted so that the fuel supply amount comes to be matched to the magnitude of the load. When the fuel injection stroke terminates, the electromagnetic valve 212 closes, and the fuel which remains in the supply conduit 205 on the fuel injection valve 204 side and in which leftover pressure has been engendered is vented through the drain conduit 208, and is collected in the drain pan 209 (the change of fuel injection rate per one injection stroke is the same as in FIG. 19D).

[During Failure of the Electromagnetic Valve 212]

When the diesel engine enters its fuel injection stroke, the electromagnetic valve 211 opens, and the fuel which has been accumulated in the pressure accumulator 203 is supplied to the fuel injection valve 204 via the electromagnetic valve 211. The period of fuel injection is adjusted so that the fuel supply amount comes to be matched to the magnitude of the load. When the fuel injection stroke terminates, the electromagnetic valve 211 closes, and the fuel which remains in the supply conduit 205 on the fuel injection valve 204 side and in which leftover pressure has been engendered is vented through the drain conduit 208, and is collected in the drain pan 209 (the change of fuel injection rate per one injection stroke is the same as in FIG. 19E).

Since, according to the diesel engine equipped with a fuel injection device structured as described above as well, the pattern of opening and closing operation of the electromagnetic valves 211 and 212 is varied according to the load, and a fuel injection rate is implemented which is matched to the magnitude of the load, accordingly, without being influenced by the magnitude of the load, and even while maintaining a desirable rate of fuel consumption, it is possible to reduce the NOx in the exhaust gas, and to implement stabilized operation.

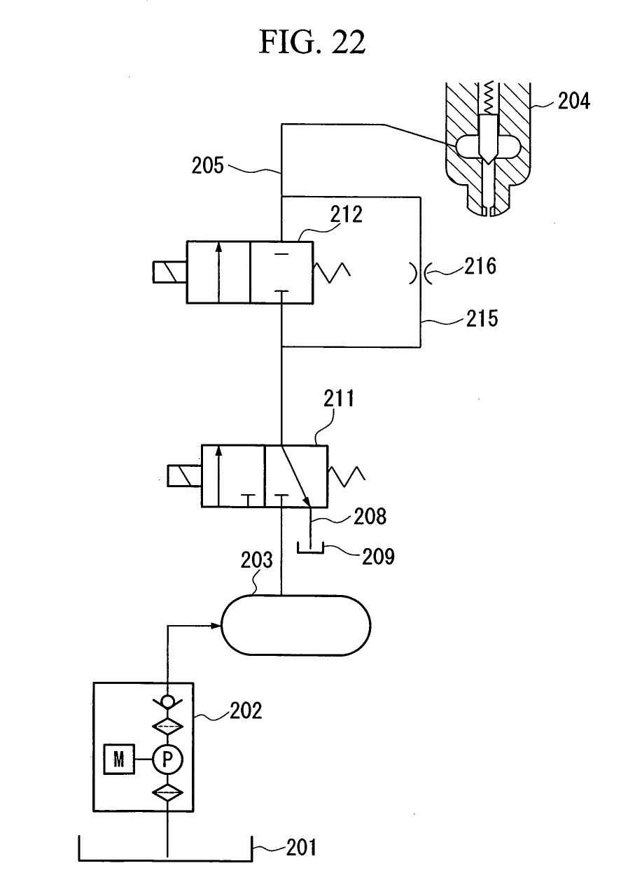

Next, the eleventh embodiment of the fuel injection device according to the present invention and of the diesel engine equipped therewith shown in FIG. 22 will be explained. It should be understood that, to structural elements which have already been explained with regard to the embodiments described above, the same reference symbols are appended, and the explanation thereof will be curtailed.

In this embodiment, although the fuel flow amounts of the electromagnetic valves 211 and 212 when they are open are set to be the same as in the tenth embodiment, as shown in FIG. 22, a three way valve is used for the electromagnetic valve 211 which is provided towards the pressure accumulator 203, while a two way valve is used for the electromagnetic valve 212 which is provided towards the fuel injection valve 204. And a drain conduit 208 is connected to the electromagnetic valve 211, and a drain pan 209 which receives the surplus fluid is connected to its end. Furthermore, a bypass conduit 215 which conducts fuel to bypass the electromagnetic valve 212 is provided to the supply conduit 205, and a constriction 216 is provided partway therealong.

The operational stroke of the fuel injection device structured as has been described above, when the diesel engine to which it is fitted is operated, will now be explained.

[During High Load]

When the diesel engine enters its fuel injection stroke, from both the electromagnetic valves 211 and 212 being in the closed state, the electromagnetic valve 211 opens first, and the fuel which has been accumulated in the pressure accumulator 203 is supplied to the fuel injection valve 204 via the electromagnetic valve 211 and the bypass conduit 215. At this time the amount of fuel which is initially supplied to the fuel injection valve 204 is kept low, since the constriction 216 is provided in the bypass conduit 215.

Next, the electromagnetic valve 212 opens after a predetermined time period from the opening of the electromagnetic valve 211, and the fuel which has been accumulated in the pressure accumulator 203 is supplied to the fuel injection valve 204 via the electromagnetic valves 211 and 212, without experiencing any action of the constriction 216. When the fuel injection stroke terminates, the electromagnetic valves 211 and 212 close at the same time. When the electromagnetic valves 211 and 212 close, the fuel which remains in the supply conduit 205 on the fuel injection valve 204 side and in which leftover pressure has been engendered is vented through the drain conduit 208 which is provided to the electromagnetic valve 211, and is collected in the drain pan 209 (the change of fuel injection rate per one injection stroke is the same as in FIG. 19A).

[During Medium and Low Load]

When the diesel engine enters its fuel injection stroke, both the electromagnetic valves 211 and 212 are opened at the same time from the closed state, and the fuel which has been accumulated in the pressure accumulator 203 is supplied to the fuel injection valve 204 via the electromagnetic valves 211 and 212. When the fuel injection stroke terminates, the electromagnetic valves 211 and 212 close at the same time. The period of fuel injection is short as compared to the case during high load. When the electromagnetic valves 211 and 212 close, the fuel which remains in the supply conduit 205 on the fuel injection valve 204 side in which leftover pressure has been engendered is vented via the drain conduit 208, and is collected in the drain pan 209 (the change of fuel injection rate per one injection stroke is the same as in FIG. 19B).

[During Extremely Low Load]

When the diesel engine enters its fuel injection stroke, from both the electromagnetic valves 211 and 212 being in the closed state, only the electromagnetic valve 211 opens, and the fuel which has been accumulated in the pressure accumulator 203 is supplied to the fuel injection valve 204 via the electromagnetic valve 211 and the bypass conduit 215. The period of fuel injection is even shorter as compared to the case during medium and low load. When the fuel injection stroke terminates, the electromagnetic valve 211 closes, and the fuel which remains in the supply conduit 205 on the fuel injection valve 204 side and in which leftover pressure has been engendered is vented through the drain conduit 208, and is collected in the drain pan 209 (the change of fuel injection rate per one injection stroke is the same as in FIG. 19C).

With the fuel injection device structured as described above, even if the electromagnetic valve 212 fails and ceases to operate, it is possible to continue without stopping the operation of the diesel engine.

When the diesel engine enters its fuel injection stroke, the electromagnetic valve 211 opens, and the fuel which has been accumulated in the pressure accumulator 203 is supplied to the fuel injection valve 204 via the electromagnetic valve 211 and the bypass conduit 215. The period of fuel injection is adjusted so that the fuel supply amount comes to be matched to the magnitude of the load. When the fuel injection stroke terminates, the electromagnetic valve 211 closes, and the fuel which remains in the supply conduit 205 on the fuel injection valve 204 side and in which leftover pressure has been engendered is vented through the drain conduit 208, and is collected in the drain pan 209.

Since, according to the diesel engine equipped with a fuel injection device structured as described above as well, the pattern of opening and closing operation of the electromagnetic valves 211 and 212 is varied according to the load, and a fuel injection rate is implemented which is matched to the magnitude of the load, accordingly, without being influenced by the magnitude of the load, and even while maintaining a desirable rate of fuel consumption, it is possible to reduce the NOx in the exhaust gas, and to implement stabilized operation.

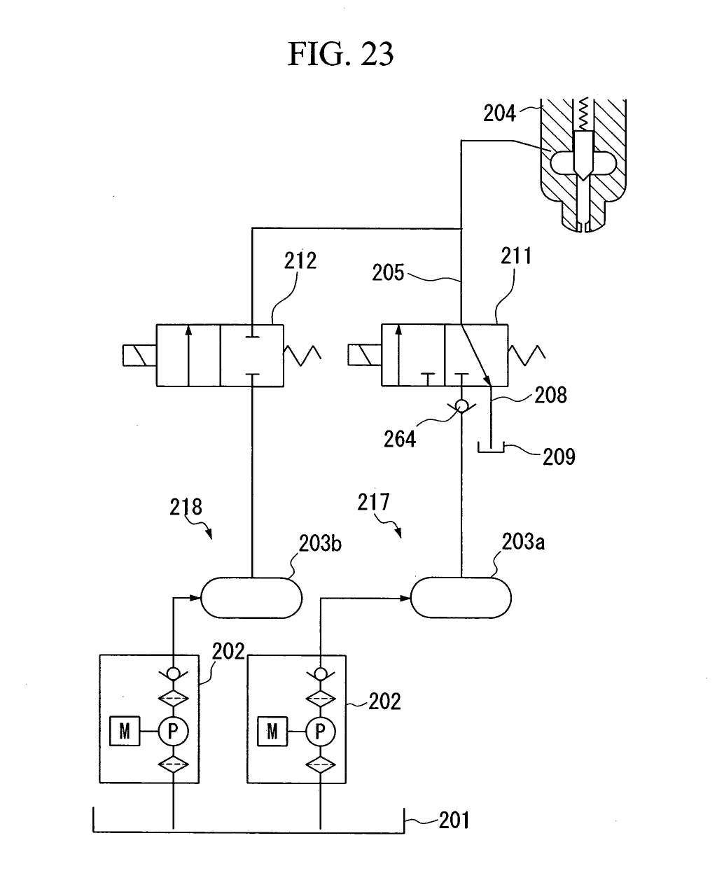

Next, the twelfth embodiment of the fuel injection device according to the present invention and of the diesel engine equipped therewith shown in FIG. 23 will be explained. It should be understood that, to structural elements which have already been explained with regard to the embodiments described above, the same reference symbols are appended, and the explanation thereof will be curtailed. In this embodiment, although the fuel flow amounts of the electromagnetic valves 211 and 212 when they are open are set to be the same as in the tenth and the eleventh embodiments, these two electromagnetic valves 211 and 212 are connected in parallel in the supply conduit 205. A three way valve is used for the one electromagnetic valve 211 (the one valve apparatus) which is provided towards the pressure accumulator 203, while a two way valve is used for the electromagnetic valve 212 (the other valve apparatus). And a drain vent tube 208 is connected to the electromagnetic valve 211, and a drain pan 209 which receives the surplus fluid is connected to its end.

Furthermore, to the electromagnetic valves 211 and 212 there are respectively provided independent fuel supply systems 217 and 218. The supply pressure of the fuel supply system 217 which supplies fuel to the electromagnetic valve 211 which operates first, in other words the set pressure of a one pressure accumulator 203a, is set to be lower than the supply pressure of the fuel supply system 218 which supplies fuel to the electromagnetic valve 212 which operates later, in other words the set pressure of an other pressure accumulator 203b; and the fuel flow amount which is supplied to the fuel injection valve 204 via the electromagnetic valve 211 is thus less than the fuel flow amount which is supplied to the fuel injection valve 204 via the electromagnetic valve 212. Furthermore, a reverse prevention valve 264 is provided in the supply conduit 205 between the pressure accumulator 203a and the electromagnetic valve 211, so as to prevent the reverse flow of fuel from the electromagnetic valve 211 to the pressure accumulator 203a.

The operational stroke of the fuel injection device structured as has been described above, when the diesel engine to which it is fitted is operated, will now be explained.

[During High Load]

When the diesel engine enters its fuel injection stroke, from both the electromagnetic valves 211 and 212 being in the closed state, the electromagnetic valve 211 opens first, and the fuel which has been accumulated in the pressure accumulator 203a is supplied to the fuel injection valve 204 via the electromagnetic valve 211. At this time the amount of fuel which is initially supplied to the fuel injection valve 204 is kept low, since the set pressure of the pressure accumulator 203a is set to be low.

Next, the electromagnetic valve 212 opens after a predetermined time period from the opening of the electromagnetic valve 211, and the fuel which has been accumulated in the pressure accumulator 203b is supplied to the fuel injection valve 204 via the electromagnetic valve 212. When the fuel supply from the fuel supply system 218 starts, since the pressure of the fuel which is being supplied via the electromagnetic valve 211 is set to be lower than the pressure of the fuel which is being supplied via the electromagnetic valve 212, it might be thought that the fuel might flow in the reverse direction in the electromagnetic valve 211, but, since the reverse protection valve 264 closes, fuel supply from the fuel supply system 217 is cut off. The fuel injection rate at this time is higher than in the first half stroke, in proportion to the supply pressure of the fuel supply system 218. When the fuel injection stroke terminates, the electromagnetic valves 211 and 212 close at the same time. When the electromagnetic valves 211 and 212 close, the fuel which remains in the supply conduit 205 on the fuel injection valve 204 side and in which leftover pressure has been engendered is vented through the drain conduit 208 which is provided to the electromagnetic valve 211, and is collected in the drain pan 209 (the change of fuel injection rate per one injection stroke is the same as in FIG. 19A).

[During Medium and Low Load]

When the diesel engine enters its fuel injection stroke, from both the electromagnetic valves 211 and 212 being in the closed state, only the electromagnetic valve 212 opens, and the fuel which has been accumulated in the pressure accumulator 203b is supplied to the fuel injection valve 204 via the electromagnetic valve 212. When the fuel injection stroke terminates, the electromagnetic valve 212 closes. The period of fuel injection is short as compared to the case during high load. When the electromagnetic valve 212 closes, the fuel which remains in the supply conduit 205 on the fuel injection valve 204 side in which leftover pressure has been engendered is vented via the drain conduit 208, and is collected in the drain pan 209 (the change of fuel injection rate per one injection stroke is the same as in FIG. 19B).

[During Extremely Low Load]

When the diesel engine enters its fuel injection stroke, from both the electromagnetic valves 211 and 212 being in the closed state, only the electromagnetic valve 211 opens, and the fuel which has been accumulated in the pressure accumulator 203b is supplied to the fuel injection valve 204 via the electromagnetic valve 211 and the bypass conduit 215. The period of fuel injection is even shorter as compared to the case during medium and low load. When the fuel injection stroke terminates, the electromagnetic valve 211 closes, and the fuel which remains in the supply conduit 205 on the fuel injection valve 204 side and in which leftover pressure has been engendered is vented through the drain conduit 208, and is collected in the drain pan 209 (the change of fuel injection rate per one injection stroke is the same as in FIG. 19C).

With the fuel injection device structured as described above, even if either one of the electromagnetic valves 211 and 212 fails and ceases to operate, it is possible to continue without stopping the operation of the diesel engine.

When the electromagnetic valve 211 fails and stays in the closed state without operating, opening and closing operation during medium and low load is performed according to the same pattern as described above; while, if the electromagnetic valve 212 fails and stays in the closed state without operating, opening and closing operation during extremely low load is performed according to the same pattern as described above. However, the period of fuel injection is adjusted so that the fuel supply amount comes to be matched to the magnitude of the load.

Since, according to the diesel engine equipped with a fuel injection device structured as described above as well, the pattern of opening and closing operation of the electromagnetic valves 211 and 212 is varied according to the load, and a fuel injection rate is implemented which is matched to the magnitude of the load, accordingly, without being influenced by the magnitude of the load, and even while maintaining a desirable rate of fuel consumption, it is possible to reduce the NOx in the exhaust gas, and to implement stabilized operation.

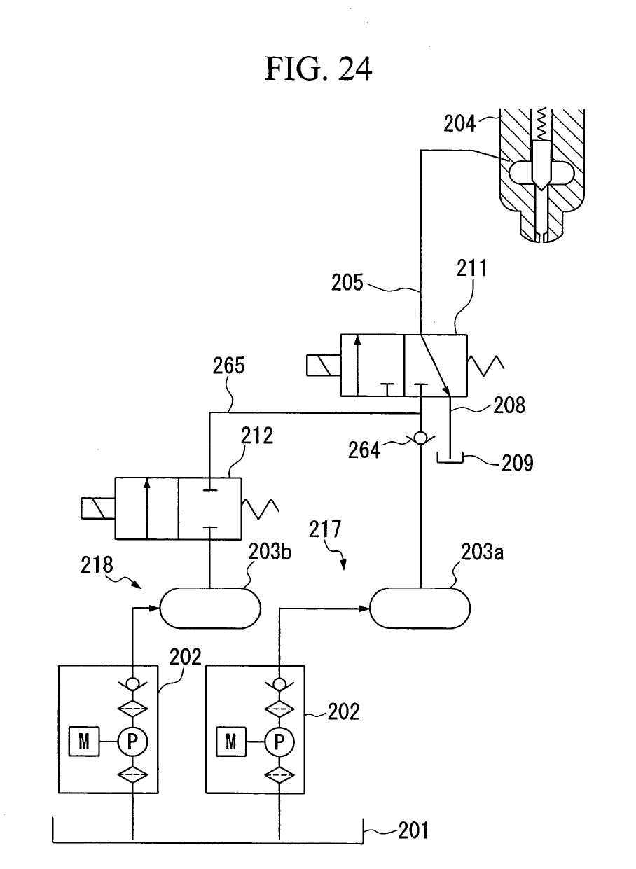

Next, the thirteenth embodiment of the fuel injection device according to the present invention and of the diesel engine equipped therewith shown in FIG. 24 will be explained. It should be understood that, to structural elements which have already been explained with regard to the twelfth embodiment described above, the same reference symbols are appended, and the explanation thereof will be curtailed.

In this embodiment, a supply conduit 265 which supplies fuel from the fuel supply system 218 via the electromagnetic valve 212 is connected to the supply conduit 205 between the pressure accumulator 203a and the electromagnetic valve 211.

The operational stroke of the fuel injection device structured as has been described above, when the diesel engine to which it is fitted is operated, is exactly the same as that for the above described twelfth embodiment, and therefore it will be curtailed.

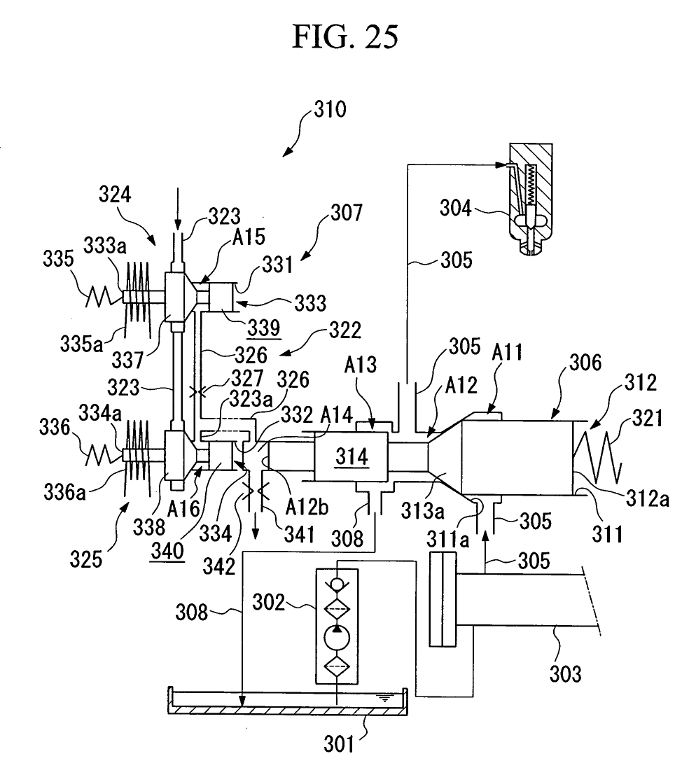

Next, the fourteenth embodiment of the fuel injection device according to the present invention and of the diesel engine equipped therewith will be explained based upon FIGS. 25 through 27.

FIG. 25 is a figure which shows the overall structure of a fuel injection device 310. In the figure, the reference symbol 301 denotes a fuel tank, 302 denotes a fuel pump which pressurizes and supplies fuel, 303 denotes a pressure accumulator which accumulates fuel (for example, heavy fuel oil C) which has been pressurized and supplied from the fuel pump 302 at a predetermined pressure or at a pressure above it, 304 denotes a fuel injection valve which, by being supplied with pressurized fuel from the pressure accumulator 303, releases and injects this fuel, 305 denotes a supply conduit which supplies fuel to the fuel injection valve 304 from the pressure accumulator 303, 306 denotes a main valve which is connected in this fuel supply conduit 305 and which interrupts the fuel supply to the fuel injection valve 304, and 307 denotes a main valve drive mechanism which drives this main valve 306.

The fuel injection valve 304 is one of the so called mechanical type, in which a needle valve (not shown in the figures) is biased by a spring in a direction to close it, and, when fuel from the pressure accumulator 303 via the fuel supply conduit 305 acts upon the lower side of the needle valve, this overcomes the biasing force of the spring and opens the needle valve.

For the main valve 306, there is used a three way valve which can select a position which supplies fuel from the pressure accumulator 303 to the fuel injection valve 304, and a position which interrupts the fuel supply to the fuel injection valve 304 and relieves to the outside of the system the leftover pressure which remains in the fuel supply conduit 305 at the fuel injection valve 304 side.

Furthermore, to this main valve 306 there is connected a drain conduit 308 which vents fuel which remains on the fuel injection valve 304 side when the position which interrupts the fuel supply to the fuel injection valve 304 has been selected and in which leftover pressure has been engendered, and the above described fuel tank 301 is arranged at its end.

The main valve 306 is made up from a cylinder portion 311 which is supplied with fuel from the pressure accumulator 303 via the fuel supply conduit 305, and a control piston 312 which is disposed so as to be capable of reciprocating action within the cylinder portion 311.

In the cylinder portion 311 there are provided in sequence a space A11 which communicates via the fuel supply conduit 305 to the pressure accumulator 303, a space A12 which communicates to the fuel injection valve 304, a space A13 which communicates to the drain conduit 308, and a space A14 which communicates to a pilot valve (valve apparatus) which will be described hereinafter and which is supplied with hydraulic fluid.

To the control piston 312 there are provided, as separated along the longitudinal direction of the control piston 312, a first valve body 313 which is disposed in the spaces A11 and A12 and which communicates/intercepts these spaces to interrupt the supply conduit 305, and a second valve body 314 which is disposed between the spaces A12 and A13 and which communicates/intercepts both spaces to open and close the drain conduit 308. The other end face 312b of the control piston 312 must receive the pressure of the hydraulic fluid which is supplied from the pilot valve (valve apparatus) to be described hereinafter, and is disposed in the space A14.

The cross section of the cylinder portion 311 perpendicular to its longitudinal direction is a circle at any portion thereof, and is formed to be larger diameter in the space A11 than in the space A12, and smaller diameter in the space A12 than in the space A13. In the inner wall surface of the cylinder portion 311 which is between the spaces A11 and A12, there is formed a squeezed diameter portion 311a whose diameter is squeezed down in a funnel shape. Furthermore, in the first valve body 313, there is formed a seat portion 313a of a taper shape which divides the spaces A11 and A12 by contacting the squeezed diameter portion 311a. In the state in which the seat portion 313a comes to contact, with respect to the squeezed diameter portion 311a, against the edge portion of its outermost peripheral portion (the above described “outer contact”) so that the first valve body 313 is in the state of having closed between the spaces A11 and A12, the pressure of the fuel which has been supplied to the space A11 does not to act upon the seat portion 313a.

The main drive mechanism 307 is made up from a return spring (biasing member) 321 which acts upon the one end face 312a of the control piston 312 and biases the control piston 312 to the closed position, and a drive section 322 which applies pressure of hydraulic fluid (fluid mass) to the other end face 312b of the control piston 312 and thus shifts the control piston 312 in the direction opposite to the direction in which it is biased by the return spring 321.

This drive section 322 is made up from an hydraulic fluid supply conduit (a fluid mass supply conduit) 323 which supplies hydraulic fluid to the space A14 from a hydraulic fluid supply source not shown in the drawings, two pilot valves (valve apparatuses) 324 and 325 which are connected in series in this hydraulic fluid conduit 323 and which interrupt the supply of hydraulic fluid to the control piston 312, in other words to the space A14, a bypass conduit 326 which is positioned at the side of one of these two pilot valves 324 and 325, in other words at the control piston 312, and bypasses the pilot valve 325 to supply hydraulic fluid to the space A14, and a constriction 327 which is provided partway along this bypass conduit 326.

The pilot valves 324 and 325 are made up from, respectively, cylinder portions 331 and 332 which are supplied with hydraulic fluid from the hydraulic fluid supply source, control pistons 333 and 334 which are disposed within these cylinder portions 331 and 332 and are capable of reciprocating action therein, return springs 335 and 336 which act upon the one end faces 333a and 334a of these control pistons 333 and 334 and bias the control pistons 333 and 334 respectively towards their closed positions (in the rightward direction as seen looking at the drawing paper), and electromagnetic drive sections 335a and 336a which are controlled by a control section not shown in the drawings and which shift the control pistons 333 and 334 respectively to their open positions (in the leftward direction as seen looking at the drawing paper).

A space A15 within the cylinder portion 331 is communicated on the one hand to the hydraulic fluid supply conduit 323, and on the other hand is communicated to the space A14 via the bypass conduit 326 which is extended from the space A15. Furthermore, a space A16 within the cylinder portion 332 is communicated on the one hand to the hydraulic fluid supply conduit 323, and on the other hand is communicated to the space A14 via an hydraulic fluid supply conduit 323a which is extended from the space A16 and via the above described bypass conduit 326.

Third valve bodies 337 and 338 which are disposed between the supply conduit 323 and the spaces A15 and A16 and which intercept between these spaces to interrupt the hydraulic fluid supply conduit 323, and fourth valve bodies 339 and 340 which delimit the space A15, are provided to the control pistons 333 and 334 respectively, as separated along the longitudinal direction of the control pistons 333 and 334.

A constriction 342 is provided in the hydraulic fluid vent passage (return conduit) 341 on the downstream side from the space A14, and constricts the flow amount of hydraulic fluid therein.

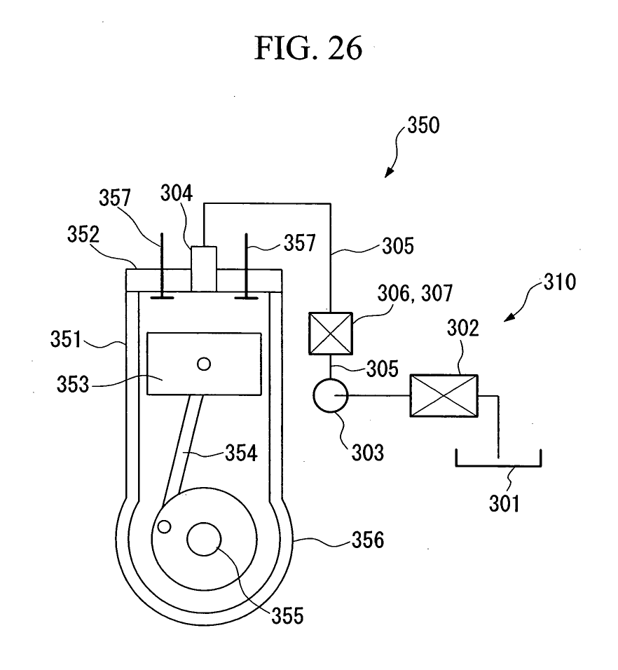

FIG. 26 is an overall structural view of a reciprocating type diesel engine 350 to which this fuel injection device 310 is fitted. In the figure, the reference symbol 351 denotes a cylinder, 352 denotes a cylinder head, 353 denotes a piston, 354 denotes a connecting piston rod, 355 denotes a crankshaft, 356 denotes a crankcase, and 357 denotes valves.

In the fuel injection device 310, the fuel injection valve 304 is provided roughly at the center of the cylinder head 352, but the pressure accumulator 303, the main valve 306, and the main valve drive device 307 are provided as separated on the side of the cylinder head 352, and these two are connected together by a conduit constituted by the fuel supply conduit 305.

The operational stroke of the fuel injection device 310 structured as has been described above, when the diesel engine to which this fuel injection device 310 is fitted is operated, will now be explained.

When the diesel engine 350 enters upon its fuel injection stroke, from the state in which the pilot valves 324 and 325 are both closed, the pilot valve 324 operates first. First, the electromagnetic drive section 335a operates and the control piston 333 shifts in the one direction (the leftwards direction as seen looking at the drawing paper), and the third valve body 337 opens and the hydraulic fluid flows into the space A15, and furthermore flows into the space A14 via the bypass conduit 326. When the hydraulic fluid flows into the space A14, the control piston 312 which experiences the pressure of the hydraulic fluid shifts in the other direction (the rightward direction as seen looking at the drawing paper), and, along with the first valve body 313 opening, the second valve body 314 closes the drain conduit 308, so that fuel is supplied from the pressure accumulator 303 via the spaces A11 and A12 and the fuel supply conduit 305 to the fuel injection valve 304. At this time the shift amount of the control piston 312 is kept low due to the pressure of the hydraulic fluid which flows in to the space A14 being kept low by the action of the constriction 327, so that the opening amount of the valve body 313 is kept low and the fuel injection rate is kept low.

Next, the pilot valve 325 starts its operation. First, the electromagnetic drive section 336a operates and the control piston 334 shifts in the one direction, so that the third valve body 338 opens and the hydraulic fluid flows in to the space A16, and furthermore flows in to the space A14 via the hydraulic fluid supply conduit 323a and the bypass conduit 326. When the hydraulic fluid flows in to the space A14, the control piston 312 which experiences the pressure of the hydraulic fluid shifts in the other direction and the first valve body 313 opens, so that fuel is supplied from the pressure accumulator 303 to the fuel injection valve 304 via the spaces A11 and A12 and the fuel supply conduit 305. At this time, since the hydraulic fluid flows into the space A14 via the hydraulic fluid supply conduits 323 and 323a and the bypass conduit 326 without experiencing the effect of the constriction 327, the control piston 312 is shifted in the other direction to the maximum limit, and the valve body 313 opens fully, so that the fuel injection rate is greater than in the first half stroke.

When the fuel injection stroke is terminated, the pilot valves 324 and 325 close at the same time. In other words, the operation of the electromagnetic drive sections 335 and 336 is cancelled at the same time, and, in the pilot valve 324, the control piston 333 shifts in the other direction due to the return spring 335, so that the third valve body 337 closes and, along with cutting off the supply of hydraulic fluid to the space A15 and also to the space A14, in the pilot valve 325, the control piston 334 shifts in the other direction due to the return spring 336, so that the third valve body 338 closes and the supply of hydraulic fluid to the space A16 and also to the space A14 is cut off. When the supply of hydraulic fluid to the space A14 is cut off, the hydraulic fluid is vented from the space A14 via the constriction 342, and the biasing force upon the control piston 312 due to the hydraulic fluid is cancelled. When the biasing force due to the hydraulic fluid is cancelled, the control piston 312 receives the biasing force of the return spring 321 and shifts in the one direction, so that, along with the first valve body 313 closing, the second valve body 314 opens the drain conduit 308, and the fuel supply via the fuel supply conduit 305 is cut off.

When the main valve 306 closes, the fuel remaining in the supply conduit 305 on the fuel injection valve 304 side in which leftover pressure has been engendered is vented via the spaces A12 and A13 and the drain conduit 308, and is collected in the fuel tank 301.

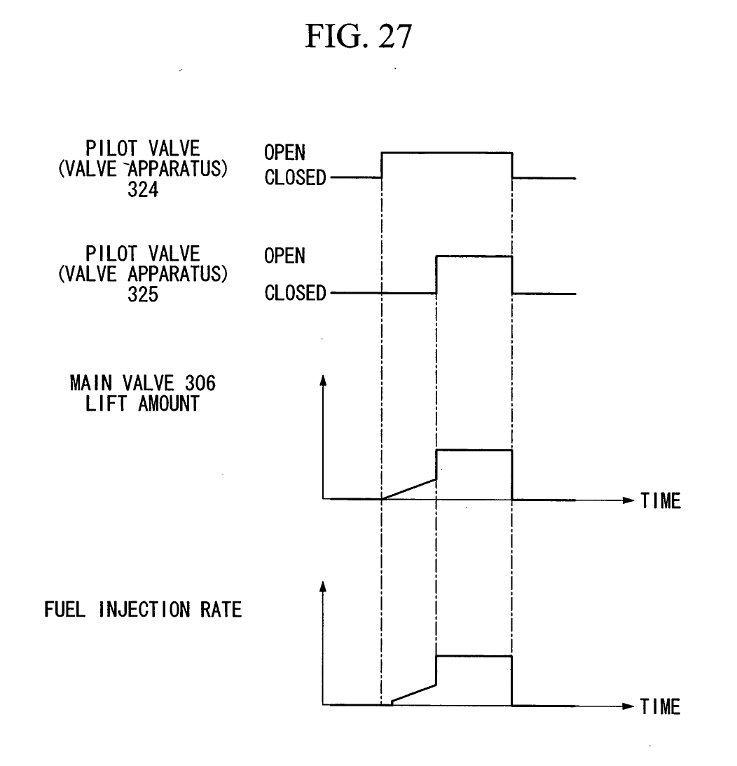

In this manner, by the pilot valve 324 opening first and next the pilot valve 325 opening, in the period of fuel injection per one injection stroke, the fuel injection rate in the first half is kept low, while the fuel injection rate in the second half is increased (the change of fuel injection rate per one admission stroke and the opening and closing states of the various valves are as shown in FIG. 27).

It should be understood that although, in the fuel injection device of FIG. 25, the pilot valve 324 and the pilot valve 325 were made to be of the same size, and it was ensured that the pressure of the hydraulic fluid which acted in the space A14 was small (the flow amount was made small) by providing the constriction 327 in the bypass conduit 326 on the downstream side of the pilot valve 324, apart from providing this type of constriction 327, it would also be possible to provide differences of greater or lesser capacity by making the sizes themselves of the pilot valve 324 and the pilot valve 325 to be different.

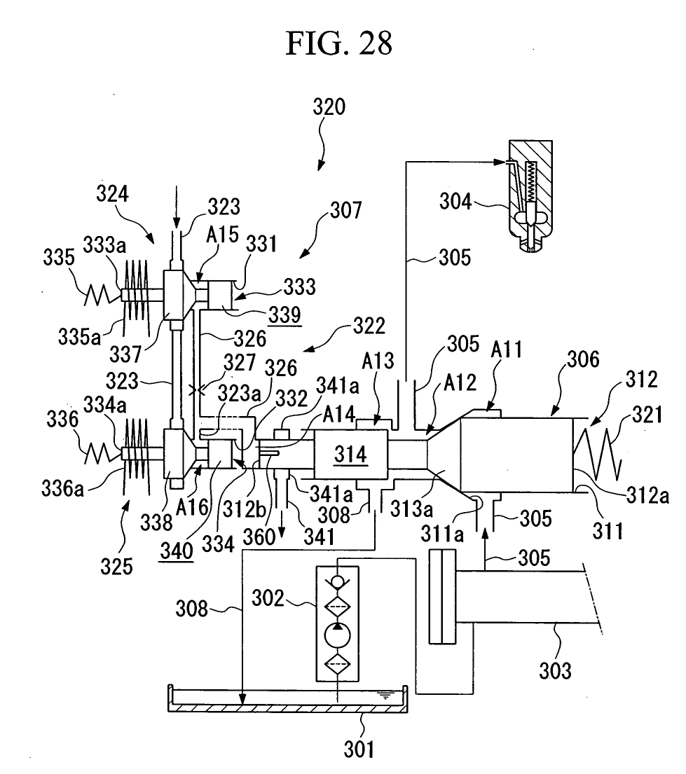

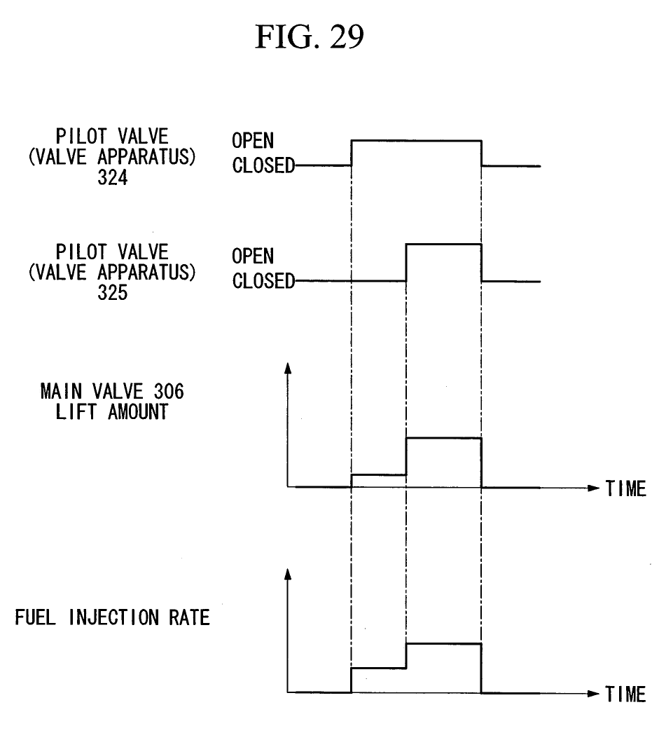

Next, the fifteenth embodiment of the fuel injection device according to the present invention and of the diesel engine equipped therewith will be explained based upon FIGS. 28 and 29. It should be understood that, to structural elements which have already been explained with regard to the fourteenth embodiment described above, the same reference symbols are appended, and the explanation thereof will be curtailed.

In this embodiment, it is arranged for the hydraulic fluid within the space A14 to be returned to the hydraulic fluid supply source via a slit (connecting conduit) 360 which is provided in the other end portion of the control piston 312, and via an hydraulic fluid vent passage 341 which has no constriction 342 (shown in FIG. 25).

The slit 360 is a flow conduit in the other end portion (the end portion which is positioned on the opposite side from the first valve body 313) of the control piston 312 which communicates together the other end face 312b and the hydraulic fluid vent passage 341, and is a single groove which is formed in the other end portion outer surface of the control piston 312.

On the other hand, in the hydraulic fluid vent passage 341, a ring shaped portion 341a is provided, and is arranged in a ring shape following along the other end portion outer surface of the control piston 312.

Accordingly, even in the state in which the pilot valves 324 and 325 are closed, the space A14 and the hydraulic fluid vent passage 341 come to be communicated together via the slit 360 and the ring shaped portion 341a.

Furthermore, when the pilot valve 324 or the pilot valves 324 and 325 are opened, and the pressure of the hydraulic fluid acts upon the other end face 312b of the control piston 312, the control piston 312 comes to be shifted in the other direction (the rightward direction as seen looking at the drawing paper). At this time, the greater is the shift amount of the control piston 312 in the other direction, the greater does the overlap (superposition) between the slit 360 and the ring shaped portion 341a become, and the greater does the area for passage of the hydraulic fluid become.

To explain the operational stroke of the fuel injection device 320 when the diesel engine to which the fuel injection device 320 which is constituted as described above is operated, with regard to the pilot valves 324 and 325, they perform exactly the same opening and closing operation as in the fourteenth embodiment described above, and implement the same fuel injection rate.

However, the hydraulic fluid in the space A14 is vented to the hydraulic fluid vent passage 341 via the slit 360 and the ring shaped portion 341a as described above, and comes to be returned to the hydraulic fluid supply source.

Furthermore, when the control piston 312 shifts in the rightward direction, the flow through area of the slit becomes greater, and, since the pressure in the space A14 diminishes, the pressing force in the rightwards direction upon the control piston 312 becomes weaker. Accordingly, the control piston 312 comes to stop at a position in which the force is in equilibrium.

In this embodiment as well, the fuel injection rate per one admission stroke in the first half of the fuel injection period is kept low, while the fuel injection rate in the second half is increased (the change of fuel injection rate per one admission stroke and the opening and closing states of the various valves are as shown in FIG. 29).

As shown in FIG. 29, with the fuel injection device 320 constituted as described above, the lift amount of the main valve 306 and the fuel injection rate are able to be varied in a stepwise manner.

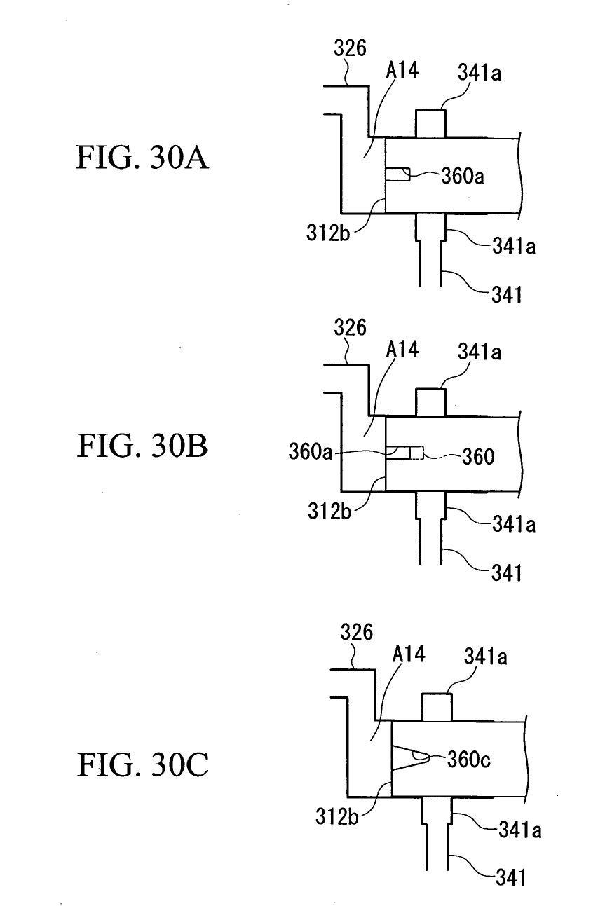

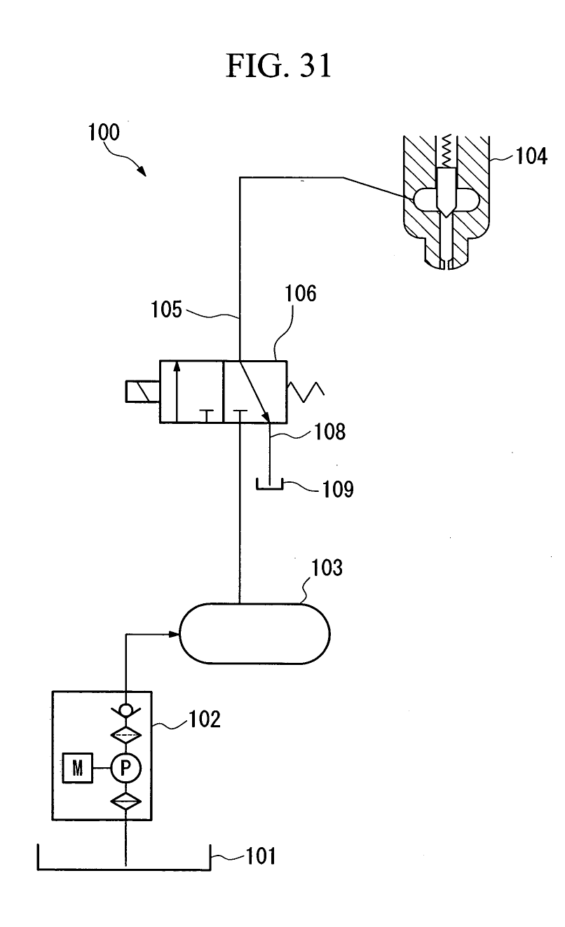

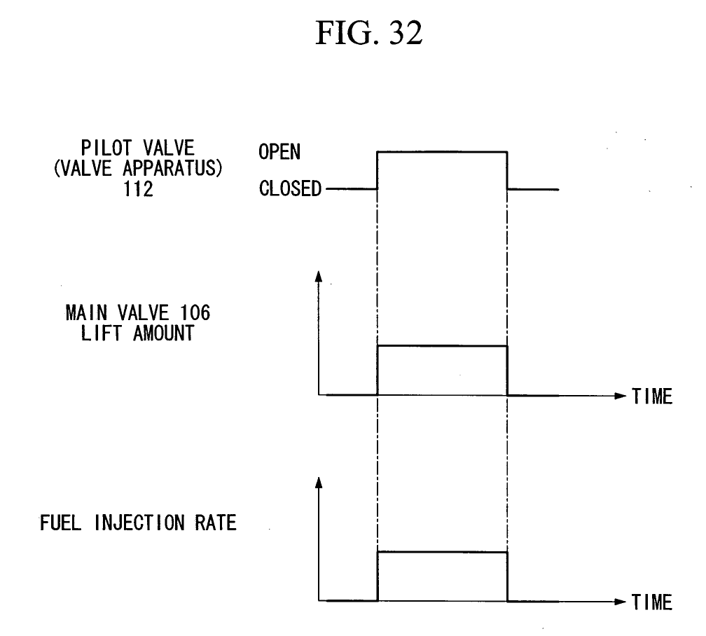

It should be understood that in this embodiment the slit 360 is formed as a single groove which communicates together the space A14 and the ring shaped portion 341a even in the state in which the pilot valves 324 and 325 are closed. However, the present invention is not limited to this; for example, it is also possible to make a structure as shown in FIGS. 30A through 30C.

The slit 360a shown in FIG. 30A is a flow path which communicates together the space A14 and the ring shaped portion 341a when the hydraulic fluid acts upon the other end face 312b at the other end portion of the control piston 312, and, when the hydraulic fluid does not act upon the other end face 312b, cuts off communication between the space A14 and the ring shaped portion 341a, and which is a single groove which is formed in the other end portion outer surface of the control piston 312.

In other words, in the state in which the pilot valves 324 and 325 are closed, the communication between the space A14 and the ring shaped portion 341a is intercepted, while, when the pilot valve 324 or the pilot valves 324 and 325 open, the pressure of the hydraulic fluid acts upon the other end face 312b of the control piston 312, and the space A14 and the ring shaped portion 341a are put into a state of communication by the control piston 312 shifting in the other direction.

To put it in another way, the slit 360a shown in FIG. 30A is one whose length has been shortened from the length of the slit 360 shown in FIG. 28.

Furthermore, the connecting conduit shown in FIG. 30B is made up from the slit 360 shown in FIG. 28 and the slit 360a shown in FIG. 30A, and these slits 360 and 360a are together provided at the opposite side to the other end portion outer circumferential surface. Accordingly, in the state in which the pilot valves 32 and 325 are closed, the space A14 and the hydraulic fluid vent passage 341 are communicated together via the slit 360 and the ring shaped portion 341a, and, in the state in which the pilot valve 324 or the pilot valves 324 and 325 are opened, the space A14 and the hydraulic fluid vent passage 341 come to be communicated together via the slits 360 and 360a and the ring shaped portion 341a. In other words, according to the amount of shifting of the control piston 312 in the other direction, the overlap (superposition) between the slits 360 and 360a and the ring shaped portion 341a becomes greater, and the passage area of the hydraulic fluid becomes greater.

Furthermore, the connecting conduit shown in FIG. 30C is one in which the shape as seen in plan view of the slit 360 shown in FIG. 28 is varied. In other words, the slit 360c shown in FIG. 30C is a groove of wedge shape as seen in plan view, having a maximum flow conduit cross section at the other end face 312b of the control piston 312. Accordingly, even in the state in which the pilot valves 324 and 325 are closed, the space A14 and the hydraulic fluid vent passage 341 come to be communicated together via the slit 360c and the ring shaped portion 341a. Furthermore, when the pilot valve 324 or the pilot valves 324 and 325 open, and the pressure of the hydraulic fluid acts upon the other end face 312b of the control piston 312, the control piston 312 comes to be shifted in the other direction (the rightward direction as seen looking at the drawing paper). At this time, the greater is the amount of shifting of the control piston 312 in the other direction, the greater does the overlap (the superposition) between the slit 360 and the ring shaped portion 341a become, and the greater does the flow passage area for the hydraulic fluid become.

It should be understood that, in the embodiment described above, along with connecting the pilot valves 324 and 325 by the hydraulic fluid supply conduit 323, the pilot valve 324 is arranged so as to be positioned on the upstream side of the pilot valve 325.

However, the present invention is not limited by this; for example, it is also possible to arrange for the hydraulic fluid from the hydraulic fluid supply source to flow in the hydraulic fluid supply conduit 323 which communicates together the pilot valve 324 and the pilot valve 325. In this case, in FIG. 25 and FIG. 28, the hydraulic fluid from the right side of the hydraulic fluid supply conduit 323 which communicates together the pilot valve 324 and the pilot valve 325 comes to be supplied to the hydraulic fluid supply conduit 323.

1. A fuel injection device comprising a pressure accumulator which accumulates fuel whose pressure has been elevated, a fuel injection valve which opens by the supply of said fuel from said pressure accumulator and injects said fuel, a supply conduit which supplies fuel from said pressure accumulator to said fuel injection valve, and two valve apparatuses which are connected in said supply conduit in parallel and each of which interrupts fuel supply to said fuel injection valve;
wherein, in fuel supply to said fuel injection valve, among said two valve apparatuses, a one valve apparatus opens first, and next the other of said valve apparatuses opens.

2. A fuel injection device as described in claim 1, wherein, for said one valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve.

3. A fuel injection device as described in claim 1, wherein, for said other valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve; and in which a constriction is provided in the path which releases said fuel in which said leftover pressure has been engendered, which keeps the flow amount of said fuel small.

4. A fuel injection device comprising a pressure accumulator which accumulates fuel whose pressure has been elevated, a fuel injection valve which opens by the supply of said fuel from said pressure accumulator and injects said fuel, a supply conduit which supplies fuel from said pressure accumulator to said fuel injection valve, and two valve apparatuses which are connected in said supply conduit in series and each of which interrupts fuel supply to said fuel injection valve; in which:
to said supply conduit there is provided a bypass conduit which conducts fuel to bypass the one of the valve apparatuses among said two valve apparatuses which is disposed towards said pressure accumulator;
a constriction is provided in said bypass conduit which keeps the flow amount of said fuel low; and
in fuel supply to said fuel injection valve, the other one of the valve apparatuses among said two valve apparatuses which is disposed towards said fuel injection valve opens first, and next said one valve apparatus opens.

5. A fuel injection device as described in claim 4, wherein, for said other valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve.

6. A fuel injection device comprising a pressure accumulator which accumulates fuel whose pressure has been elevated, a fuel injection valve which opens by the supply of said fuel from said pressure accumulator and injects said fuel, a supply conduit which supplies fuel from said pressure accumulator to said fuel injection valve, and two valve apparatuses which are connected in said supply conduit in series and each of which interrupts fuel supply to said fuel injection valve; and wherein:
to said supply conduit there is provided a bypass conduit which conducts fuel to bypass the one of the valve apparatuses among said two valve apparatuses which is disposed towards said fuel injection valve;
a constriction is provided in said bypass conduit which keeps the flow amount of said fuel low; and
in fuel supply to said fuel injection valve, the other one of the valve apparatuses among said two valve apparatuses which is disposed towards said pressure accumulator opens first, and next said one valve apparatus opens.

7. A fuel injection device as described in claim 6, wherein, for said other valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve.

8. A fuel injection device as described in claim 6, wherein, for said one valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve; and a second constriction is provided in the conduit which relieves said fuel in which leftover pressure has been engendered, which keeps the flow amount of said fuel low.

9. A fuel injection device comprising a one pressure accumulator which accumulates fuel whose pressure has been elevated, an other pressure accumulator which accumulates fuel at a higher pressure than said one pressure accumulator, a fuel injection valve which opens by the supply of said fuel from at least one of said one pressure accumulator and said other pressure accumulator and injects said fuel, a one supply conduit which supplies fuel from said one pressure accumulator to said fuel injection valve, a one valve apparatus which is connected in said one supply conduit and which interrupts fuel supply to said fuel injection valve, an other supply conduit which supplies fuel from said other pressure accumulator to said fuel injection valve, and an other valve apparatus which is connected in said other supply conduit and which interrupts fuel supply to said fuel injection valve; and wherein:
by the difference in said fuel supply pressures, the fuel flow amount of said one valve apparatus is set to be smaller than the fuel flow amount of said other valve apparatus; and
in fuel supply to said fuel injection valve, said one valve apparatus opens first, and next said other valve apparatus opens.

10. A fuel injection device as described in claim 9, wherein, for said one valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve.

11. A fuel injection device comprising a one pressure accumulator which accumulates fuel whose pressure has been elevated, an other pressure accumulator which accumulates fuel at a higher pressure than said one pressure accumulator, a fuel injection valve which opens by the supply of said fuel from at least one of said one pressure accumulator and said other pressure accumulator and injects said fuel, a one supply conduit which supplies fuel from said one pressure accumulator to said fuel injection valve, a one valve apparatus which is connected in said one supply conduit and which interrupts fuel supply to said fuel injection valve, an other supply conduit which is connected to said one supply conduit towards the side of said one pressure accumulator from said one valve apparatus and which supplies fuel from said other pressure accumulator to said fuel injection valve, and an other valve apparatus which is connected in said other supply conduit and which interrupts fuel supply to said fuel injection valve; and wherein:
by the difference in said fuel supply pressures, the fuel flow amount of said one valve apparatus is set to be smaller than the fuel flow amount of said other valve apparatus; and
in fuel supply to said fuel injection valve, said one valve apparatus opens first, and next said other valve apparatus opens.

12. A fuel injection device as described in claim 11, wherein, for said one valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve.

13. A diesel engine which comprises a fuel injection device as described in claim 1.

14. A diesel engine as described in claim 13, wherein said pressure accumulator and said two valve apparatuses are provided separately from an engine cylinder to which said fuel injection valve is provided.

15. A control method for a fuel injection device which comprises two valve apparatuses, which interrupt fuel supply to a fuel injection valve, and with which the fuel injection amount per unit time which is injected from said fuel injection valve when a one valve apparatus among said two valve apparatuses is opened is set to be smaller than the fuel injection amount per unit time which is injected from said fuel injection valve when the other valve apparatus is opened, in which:
in fuel supply to said fuel combustion [sic] injection valve, said one valve apparatus among said two valve apparatuses opens first, and next said other valve apparatus opens.

16. A control method for a fuel injection device which comprises two valve apparatuses, which interrupt fuel supply to a fuel injection valve, and with which the fuel injection amount per unit time which is injected from said fuel injection valve when a one valve apparatus among said two valve apparatuses is opened is set to be smaller than the fuel injection amount per unit time which is injected from said fuel injection valve when the other valve apparatus is opened, in which:
in fuel supply to said fuel injection valve, said two valve apparatuses open and close at the same times.

17. A control method for a fuel injection device which comprises two valve apparatuses, which interrupt fuel supply to a fuel injection valve, and with which the fuel injection amount per unit time which is injected from said fuel injection valve when a one valve apparatus among said two valve apparatuses is opened is set to be smaller than the fuel injection amount per unit time which is injected from said fuel injection valve when the other valve apparatus is opened, in which:
in fuel supply to said fuel injection valve, only one or the other among said two valve apparatuses opens and closes.

18. A fuel injection device comprising a pressure accumulator which accumulates fuel whose pressure has been elevated, a fuel injection valve which opens by the supply of said fuel from said pressure accumulator and injects said fuel, a supply conduit which supplies fuel from said pressure accumulator to said fuel injection valve, and two valve apparatuses which are connected in said supply conduit in parallel and each of which interrupts fuel supply to said fuel injection valve, in which the fuel flow amount when a one valve apparatus among said two valve apparatuses is opened is set to be smaller than the fuel flow amount when the other valve apparatus is opened; and wherein:
in fuel supply to said fuel injection valve, said two valve apparatuses open and close at the same times.

19. A fuel injection device comprising a pressure accumulator which accumulates fuel whose pressure has been elevated, a fuel injection valve which opens by the supply of said fuel from said pressure accumulator and injects said fuel, a supply conduit which supplies fuel from said pressure accumulator to said fuel injection valve, and two valve apparatuses which are connected in said supply conduit in parallel and each of which interrupts fuel supply to said fuel injection valve, in which the fuel flow amount when a one valve apparatus among said two valve apparatuses is opened is set to be smaller than the fuel flow amount when the other valve apparatus is opened; and wherein:
in fuel supply to said fuel injection valve, only one or the other among said two valve apparatuses opens and closes.

20. A fuel injection device as described in claim 18, wherein, for said one valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve.

21. A fuel injection device as described in claim 19, wherein, for said one valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve.

22. A fuel injection device as described in claim 18, wherein, for said other valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve; and in which a constriction is provided in the path which releases said fuel in which said leftover pressure has been engendered, which keeps the flow amount of said fuel small.

23. A fuel injection device as described in claim 19, wherein, for said other valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve; and in which a constriction is provided in the path which releases said fuel in which said leftover pressure has been engendered, which keeps the flow amount of said fuel small.

24. A fuel injection device comprising a pressure accumulator which accumulates fuel whose pressure has been elevated, a fuel injection valve which opens by the supply of said fuel from said pressure accumulator and injects said fuel, a supply conduit which supplies fuel from said pressure accumulator to said fuel injection valve, and two valve apparatuses which are connected in said supply conduit in series and each of which interrupts fuel supply to said fuel injection valve; and wherein:
to said supply conduit there is provided a bypass conduit which conducts fuel to bypass the one of the valve apparatuses among said two valve apparatuses which is disposed towards said pressure accumulator; and
in fuel supply to said fuel injection valve, said two valve apparatuses open and close at the same times.

25. A fuel injection device comprising a pressure accumulator which accumulates fuel whose pressure has been elevated, a fuel injection valve which opens by the supply of said fuel from said pressure accumulator and injects said fuel, a supply conduit which supplies fuel from said pressure accumulator to said fuel injection valve, and two valve apparatuses which are connected in said supply conduit in series and each of which interrupts fuel supply to said fuel injection valve; and wherein:
to said supply conduit there is provided a bypass conduit which conducts fuel to bypass the one of the valve apparatuses among said two valve apparatuses which is disposed towards said pressure accumulator; a constriction is provided in said bypass conduit which keeps the flow amount of said fuel low; and
in fuel supply to said fuel injection valve, only one or the other among said two valve apparatuses opens and closes.

26. A fuel injection device as described in claim 24, wherein, for said other valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve.

27. A fuel injection device as described in claim 25, wherein, for said other valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve.

28. A fuel injection device comprising a pressure accumulator which accumulates fuel whose pressure has been elevated, a fuel injection valve which opens by the supply of said fuel from said pressure accumulator and injects said fuel, a supply conduit which supplies fuel from said pressure accumulator to said fuel injection valve, and two valve apparatuses which are connected in said supply conduit in series and each of which interrupts fuel supply to said fuel injection valve; and wherein:
to said supply conduit there is provided a bypass conduit which conducts fuel to bypass the one of the valve apparatuses among said two valve apparatuses which is disposed towards said fuel injection valve; a constriction is provided in said bypass conduit which keeps the flow amount of said fuel low; and
in fuel supply to said fuel injection valve, said two valve apparatuses open and close at the same times.

29. A fuel injection device comprising a pressure accumulator which accumulates fuel whose pressure has been elevated, a fuel injection valve which opens by the supply of said fuel from said pressure accumulator and injects said fuel, a supply conduit which supplies fuel from said pressure accumulator to said fuel injection valve, and two valve apparatuses which are connected in said supply conduit in series and each of which interrupts fuel supply to said fuel injection valve; and wherein:
to said supply conduit there is provided a bypass conduit which conducts fuel to bypass the one of the valve apparatuses among said two valve apparatuses which is disposed towards said fuel injection valve; a constriction is provided in said bypass conduit which keeps the flow amount of said fuel low; and
in fuel supply to said fuel injection valve, only one or the other among said two valve apparatuses opens and closes.

30. A fuel injection device as described in claim 28, wherein, for said other valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve.

31. A fuel injection device as described in claim 29, wherein, for said other valve apparatus, there is used a three way valve which can select a position in which it supplies fuel from said pressure accumulator to said fuel injection valve, and a position in which it interrupts the supply of fuel to said fuel injection valve and relieves the leftover pressure which remains on the side of said fuel injection valve.

32. A fuel injection device comprising a one pressure accumulator which accumulates fuel whose pressure has been elevated, an other pressure accumulator which accumulates fuel at a higher pressure than said one pressure accumulator, a fuel injection valve which opens by the supply of said fuel from at least one of said one pressure accumulator and said other pressure accumulator and injects said fuel, a one supply conduit which supplies fuel from said one pressure accumulator to said fuel injection valve, a one valve apparatus which is connected in said one supply conduit and which interrupts fuel supply to said fuel injection valve, an other supply conduit which supplies fuel from said other pressure accumulator to said fuel injection valve, and an other valve apparatus which is connected in said other supply conduit and which interrupts fuel supply to said fuel injection valve; and wherein:
by the difference in said fuel supply pressures, the fuel flow amount of said one valve apparatus is set to be smaller than the fuel flow amount of said other valve apparatus; and
in fuel supply to said fuel injection valve, said two valve apparatuses open and close at the same times.

33. A fuel injection device comprising a one pressure accumulator which accumulates fuel whose pressure has been elevated, an other pressure accumulator which accumulates fuel at a higher pressure than said one pressure accumulator, a fuel injection valve which opens by the supply of said fuel from at least one of said one pressure accumulator and said other pressure accumulator and injects said fuel, a one supply conduit which supplies fuel from said one pressure accumulator to said fuel injection valve, a one valve apparatus which is connected in said one supply conduit and which interrupts fuel supply to said fuel injection valve, an other supply conduit which supplies fuel from said other pressure accumulator to said fuel injection valve, and an other valve apparatus which is connected in said other supply conduit and which interrupts fuel supply to said fuel injection valve; and wherein:
by the difference in said fuel supply pressures, the fuel flow amount of said one valve apparatus is set to be smaller than the fuel flow amount of said other valve apparatus; and
in fuel supply to said fuel injection valve, only one or the other among said two valve apparatuses opens and closes.

34. A fuel injection device as described in claim 32, wherein, for said one valve apparatus, there is used a three way valve which can select a position in which it supplies fuel from said one pressure accumulator to said fuel injection valve, and a position in which it interrupts the supply of fuel to said fuel injection valve and relieves the leftover pressure which remains on the side of said fuel injection valve.

35. A fuel injection device as described in claim 33, wherein, for said one valve apparatus, there is used a three way valve which can select a position in which it supplies fuel from said one pressure accumulator to said fuel injection valve, and a position in which it interrupts the supply of fuel to said fuel injection valve and relieves the leftover pressure which remains on the side of said fuel injection valve.

36. A fuel injection device comprising a one pressure accumulator which accumulates fuel whose pressure has been elevated, an other pressure accumulator which accumulates fuel at a higher pressure than said one pressure accumulator, a fuel injection valve which opens by the supply of said fuel from at least one of said one pressure accumulator and said other pressure accumulator and injects said fuel, a one supply conduit which supplies fuel from said one pressure accumulator to said fuel injection valve, a one valve apparatus which is connected in said one supply conduit and which interrupts fuel supply to said fuel injection valve, an other supply conduit which is connected to said one supply conduit towards the side of said one pressure accumulator from said one valve apparatus and which supplies fuel from said other pressure accumulator to said fuel injection valve, and an other valve apparatus which is connected in said other supply conduit and which interrupts fuel supply to said fuel injection valve; and wherein:
by the difference in said fuel supply pressures, the fuel flow amount of said one valve apparatus is set to be smaller than the fuel flow amount of said other valve apparatus; and
in fuel supply to said fuel injection valve, said two valve apparatuses open and close at the same times.

37. A fuel injection device comprising a one pressure accumulator which accumulates fuel whose pressure has been elevated, an other pressure accumulator which accumulates fuel at a higher pressure than said one pressure accumulator, a fuel injection valve which opens by the supply of said fuel from at least one of said one pressure accumulator and said other pressure accumulator and injects said fuel, a one supply conduit which supplies fuel from said one pressure accumulator to said fuel injection valve, a one valve apparatus which is connected in said one supply conduit and which interrupts fuel supply to said fuel injection valve, an other supply conduit which is connected to said one supply conduit towards the side of said one pressure accumulator from said one valve apparatus and which supplies fuel from said other pressure accumulator to said fuel injection valve, and an other valve apparatus which is connected in said other supply conduit and which interrupts fuel supply to said fuel injection valve; and wherein:
by the difference in said fuel supply pressures, the fuel flow amount of said one valve apparatus is set to be smaller than the fuel flow amount of said other valve apparatus; and
in fuel supply to said fuel injection valve, only one or the other among said two valve apparatuses opens and closes.

38. A fuel injection device as described in claim 36, wherein, for said one valve apparatus, there is used a three way valve which can select a position in which it supplies fuel from said one pressure accumulator to said fuel injection valve, and a position in which it interrupts the supply of fuel to said fuel injection valve and relieves the leftover pressure which remains on the side of said fuel injection valve.

39. A fuel injection device as described in claim 37, wherein, for said one valve apparatus, there is used a three way valve which can select a position in which it supplies fuel from said one pressure accumulator to said fuel injection valve, and a position in which it interrupts the supply of fuel to said fuel injection valve and relieves the leftover pressure which remains on the side of said fuel injection valve.

40. A diesel engine which comprises a fuel injection device as described in claim 18.

41. A fuel injection device comprising a pressure accumulator which accumulates fuel whose pressure has been elevated, a fuel injection valve which opens by the supply of said fuel from said pressure accumulator and injects said fuel, a fuel supply conduit which supplies fuel from said pressure accumulator to said fuel injection valve, a main valve which is connected in said fuel supply conduit and which interrupts fuel supply to said fuel injection valve, and a main valve drive mechanism which drives said main valve; and wherein:
said main valve drive mechanism is one which has a construction which shifts said main valve to at least two positions whose opening amounts are different.

42. A fuel injection device as described in claim 41, wherein said main valve drive mechanism is provided at one end of said main valve, and comprises a biasing member which biases said main valve to the closed position, and a drive section which applies fluid to the other end portion of said main valve to open said main valve;
said drive section comprises a fluid supply conduit which supplies fluid from a fluid supply source to said other end portion, two valve apparatuses which are connected in said fluid supply conduit and which interrupt fluid supply to said other end portion, a bypass conduit which supplies said fluid to said other end portion by bypassing a valve apparatus among these two valve apparatuses which is positioned in a one direction, and a constriction which is provided in said bypass conduit; and wherein:
in fluid supply to said other end portion, the valve apparatus among said two valve apparatuses which is positioned in the other direction opens first, and next the valve apparatus which is positioned in the one direction opens.

43. A fuel injection device as described in claim 42, wherein, at said other end portion, there is provided at least one connecting conduit which communicates together a return conduit which returns fluid which acts upon said other end portion to said fluid supply source, and said other end portion upon which said fluid acts; and moreover said at least one connecting conduit is made so that its fluid conduit resistance diminishes according as the fluid pressure which acts upon said other end portion increases.

44. A fuel injection device as described in claim 43, wherein said at least one connecting conduit is a slit which is formed in the outer surface of said other end portion.

45. A diesel engine comprising a fuel injection device as described in claim 41, and a cylinder head to which said fuel injection valve is fitted.

46. A diesel engine as described in claim 45, wherein said pressure accumulator, said main valve, and said main valve drive mechanism are provided as separated from said cylinder head.

47. A diesel engine which comprises a fuel injection device as described in claim 4.

48. A diesel engine which comprises a fuel injection device as described in claim 6.

49. A diesel engine which comprises a fuel injection device as described in claim 9.

50. A diesel engine which comprises a fuel injection device as described in claim 11.

51. A diesel engine as described in claim 47, wherein said pressure accumulator and said two valve apparatuses are provided separately from an engine cylinder to which said fuel injection valve is provided.

52. A diesel engine as described in claim 48, wherein said pressure accumulator and said two valve apparatuses are provided separately from an engine cylinder to which said fuel injection valve is provided.

53. A diesel engine as described in claim 49, wherein said pressure accumulator and said two valve apparatuses are provided separately from an engine cylinder to which said fuel injection valve is provided.

54. A diesel engine as described in claim 50, wherein said pressure accumulator and said two valve apparatuses are provided separately from an engine cylinder to which said fuel injection valve is provided.

55. A diesel engine which comprises a fuel injection device as described in claim 19.

56. A diesel engine which comprises a fuel injection device as described in claim 24.

57. A diesel engine which comprises a fuel injection device as described in claim 25.

58. A diesel engine which comprises a fuel injection device as described in claim 28.

59. A diesel engine which comprises a fuel injection device as described in claim 29.

60. A diesel engine which comprises a fuel injection device as described in claim 32.

61. A diesel engine which comprises a fuel injection device as described in claim 33.

62. A diesel engine which comprises a fuel injection device as described in claim 36.

63. A diesel engine which comprises a fuel injection device as described in claim 37.
